(19) United States
(12) Patent Application Publication
(10) Pub. No.: US 2010/0020964 A1
(43) Pub. Date: Jan. 28, 2010

(54) KEY GENERATION METHOD USING QUADRATIC-HYPERBOLIC CURVE GROUP

(75) Inventor: Kimito HORIE, Tokyo (JP)

Correspondence Address: Studebaker & Brackett PC, One Fountain Square, 11911 Freedom Drive, Suite 750, Reston, VA, 20190, US

(73) Assignee: OKI ELECTRIC INDUSTRY CO., LTD., Tokyo (JP)

(21) Appl. No.: 11/962,640

(22) Filed: Dec. 21, 2007

(30) Foreign Application Priority Data
Feb. 20, 2007 (JP) 2006-039780

(51) Int. Cl. H04L 9/30; H04L 9/00

(52) U.S. Cl. 380/44; 380/30

(57) ABSTRACT

Disclosed is a key generation apparatus which uses a finite commutative group defined by a number-theoretical (or arithmetical) function that can be substituted for the elliptic curve, thereby enabling the computational difficulty equivalent to that of breaking the elliptic curve cryptography. The key generation apparatus comprises a key setting part and a key generator. The key setting part sets a secret key α, and selects an element of the finite commutative group as a public key G. The key generator performs an addition operation defined for the finite commutative group on the public key G, thereby to multiply the public key G by the secret key α representing a scalar coefficient to generate a public key Y. The finite commutative group is a set of pairs (x,y) of a dependent variable y of a quadratic-hyperbolic function defined on a finite ring and an independent variable x of the quadratic-hyperbolic function.

### BACKGROUND OF THE INVENTION

1. Field of the Invention

The present invention relates to cryptographic technologies of a discrete logarithm type using a group that is a set of points consisting of pairs of a dependent variable and an independent variable of a number-theoretical (or arithmetical) function.

2. Description of the Related Art

Cryptographic technologies are indispensable for ensuring the security of electronic commerce services or electronic application procedures on a digital communication network such as the internet. As a cryptographic technology of this kind, a public key cryptographic system (or public key cryptosystem) using a set of two keys consisting of a public key and a secret key has widely spread. One of the typical public key cryptosystems is an RSA encryption scheme which uses as a public key the product N (=pq) of two different odd prime numbers p and q. The security of the RSA encryption scheme relies on the supposition that the prime factorization of the composite number N (=pq) is extremely difficult to be found if the odd prime numbers p and q are suitably selected. At the present time, the General Number Field Sieve (GNFS) is well known as the fastest algorithm for finding the prime factorization. By using the General Number Field Sieve, a secret key for the RSA encryption can be found in subexponential running time. Since, in recent years, machines have the improved computing time and thus the cryptanalysis time is shortened, a large key length such as 1024 or 2048 bits are required for ensuring the security of the RSA encryption scheme.

As a next generation public key cryptosystem, elliptic curve cryptography has been studied. The security of the elliptic curve cryptography is based on the Discrete Logarithm Problem (DLP). Since the finding of a secret key for the elliptic curve cryptography takes exponential running time, it is considered that the computational difficulty of breaking the elliptic curve cryptography is higher than that of breaking the RSA encryption. A set of rational points on an algebraic curve over a finite ring can define a group (algebraic curve group) by using an appropriate operation. Let the symbol “+” denote the appropriate operation. The discrete logarithm problem is to find a unique integer α such that S=αK=K+ . . . +K (i.e., additions of the α points K) for two points K and S on the algebraic curve, where the points K and S are elements of the algebraic curve group, αε[0,n−1] and n is the order of the algebraic curve group. It is extremely difficult to find the integer α for the Elliptic Curve Discrete Logarithm Problem (ECDLP), because a considerable amount of computational effort is needed except for special cases. The security of the RSA encryption using a key length of 1024 bits is widely believed to be achieved by the elliptic curve cryptography using a short key length of about 163 bits. Prior arts related to the elliptic curve cryptography are disclosed, for example, in Japanese Patent Application Publication Nos. 2005-283674 and 2000-224157, and the non-patent document: Neal Koblitz, “A Course in Number Theory and Cryptography”, 2^{nd} edition, Springer-Verlag, 1994.

If it is computationally difficult to solve the discrete logarithm problem, the elliptic curve cryptography provides a secure system. Generally, in order to configure a secure elliptic curve cryptography, it is important that parameters of the elliptic curve are appropriately selected and that the order of the group constructed from the elliptic curve contains a large prime factor. However, there is a problem that it takes a very long time to decide the curve parameters for giving the order that is a prime number, and to compute the order. One of the causes preventing high speed computation of the order is that the order may be varied as the parameters of the elliptic curve are changed. As methods of deciding the curve parameters, Schoof method and Complex Multiplication method (CM method) are widely known. The Schoof method comprises the steps of selecting curve parameters at random to construct a group from the elliptic curve, computing the order of the group, and checking whether or not the security of the resulting elliptic curve cryptography is sufficient. However, there is a problem with the Schoof method that it takes a very long time to compute the order. On the other hand, the Complex Multiplication method is capable of computing the curve parameters in a relatively short time by limiting the form of the order of the group to a specific form. However, there is a problem with the Complex Multiplication method that methods of attack against the resulting elliptic curve cryptography can be possibly found based on the specific form of the order.

Since an amount of the computational effort for block encryption such as RSA encryption or elliptic curve encryption is generally large, it takes a long time to perform the encryption process. Thus, there is a problem that it is difficult to encrypt in real time plain text data to be transmitted at high speed. A stream encryption is well known as an encryption scheme having high real-time property. The stream encryption is one of common key cryptographic technologies for obtaining a data series of a cipher text by perform a logical exclusive-OR operation between a data series of a plain text and a series of pseudo-random numbers for every bit or byte. The stream encryption is widely employed in a compact telecommunication device such as a mobile phone or in techniques of short distance wireless communications such as wireless LAN, for enabling small-scale implementation onto hardware.

As a prior art of the stream encryption, “PANAMA” proposed in 1998 is well known (non-patent document 2: J. Daemen, C. Clapp, “Fast Hashing and Stream Encryption with PANAMA”, Fast Software Encryption, 5^{th} International Workshop, FSE′ 98, Proceedings, LNCS Vol. 1372, Springer-Verlag, 1998).

The “PANAMA” is a cipher module capable of generating a key stream composed of a series of pseudo-random numbers for stream cipher. As algorithms for generating a key stream, “SNOW2.0” (Patrik Ekdahl and Thomas Johansson, Lund University) and “MUGI” (Hitachi, Ltd.) based on the PANAMA are well known. The “SNOW2.0” and “MUGI” are defined in an ISO/IEC 18033-4 that is an international standard for encryption. The details of the “MUGI” are disclosed in Japanese Patent Application Publication No. 2003-37482, U.S. Patent Application Publication No. 2002/097868 and U.S. Patent Application Publication No. 2002/118830. However, there is a problem that the computational difficulty of breaking such stream encryptions is lower than that of breaking the block encryptions whose security is based on the difficulty of prime factorization and on the Discrete Logarithm Problem.

The public key cryptosystem is the technique whose security is based on the computational difficulty of decoding cipher text data. This basis of the security may be possibly threatened by greatly improving the operation speed of computers in the future. Thus, quantum communication and cryptography, which is secured by Heisenberg's uncertainty principle according to quantum mechanics, have been studied recently. The quantum communication and cryptography of this kind is disclosed, for example, in Japanese Patent Application Publication No. 2004-112278 and U.S. Patent Application Publication No. 2006/059403. In a cryptographic key delivery protocol used for the quantum communication and cryptography, a One-Time-Pad cipher such as Vernam cipher can be employed. This Vernam cipher is the technique for generating a cipher bit stream by performing a bitwise logical exclusive-OR operation between a plain text bit stream and an intrinsic random number bit sequence. The length of a secret key (i.e., a cryptographic key) is equal to that of the plain text. The Vernam cipher is a technique for ensuring absolute security as far as the transmitting and receiving sides secretly have the secret key in common, because the secret key having the same length as the plain text is used only at one time. However, this causes procedural complexity to keep distributing the secret key shared between the transmitting side and the receiving side. Further, although the quantum communication and cryptography is a technique capable of detecting wiretapping attack occurred on a communication path, there is no method of simply distributing, as a “one-time secret key”, a quantum key to fully ensure security.

### SUMMARY OF THE INVENTION

In view of the foregoing, it is an object of the present invention to provide a key generation method, a key generation apparatus, a decoding method, a decoding apparatus, a signature verification method and a signature verification apparatus which use a finite commutative group defined by a number-theoretical (or arithmetical) function that can be substituted for the elliptic curve, thereby enabling the computational difficulty equivalent to that of breaking the elliptic curve cryptography.

It is another object of the present invention to provide a key generation method, a key generation apparatus, a decoding method, a decoding apparatus, a signature verification method and a signature verification apparatus which are capable of computing the order of a group at sufficiently high speed, as well as constructing a cryptosystem based on a number-theoretical function in a short time.

It is still another object of the present invention to provide a key stream generation method and a key stream generation apparatus which enable the high computational difficulty of breaking a cipher, and particularly to provide a key stream generation method and a key stream generation apparatus which enable both high real-time performance and the high computational difficulty of breaking a cipher.

According to a first aspect of the present invention, there is provided a key generation method for generating a key for cryptographic process. The key generation method comprises the steps of: (a) setting a secret key representing a scalar coefficient, and selecting, as a first public key, an element of a finite commutative group that is a set of pairs (x, y) of a dependent variable y of a number-theoretical function defined over a finite ring and an independent variable x of said number-theoretical function, the number-theoretical function being a quadratic-hyperbolic function having both a denominator of a quadratic polynomial defined over the finite ring and a numerator of a linear polynomial defined over the finite ring; and (b) performing an addition operation defined for the finite commutative group on the first public key one or more times thereby to multiply the first public key by the secret key representing a scalar coefficient to generate a second public key. The addition operation is performed to add first and second elements of the finite commutative group by, when a third element other than the first and second elements is determined as one of solutions of a set of two simultaneous equations represented by the quadratic-hyperbolic function and a first linear function which has the first and second elements as solutions of an equation of the first linear function, calculating, as the addition result other than the third element and a predetermined fixed element of the finite commutative group, a fourth element which is one of solutions of a set of two simultaneous equations represented by the quadratic-hyperbolic function and a second linear function which has the third element and the predetermined fixed element as solutions of an equation of the second linear function.

According to a second aspect of the present invention, there is provided a key generation method for encrypting plain text data. The key generation method comprises the steps of: (a) reading, from a memory, first and second public keys which are elements of a finite commutative group being a set of pairs (x, y) of a dependent variable y of a number-theoretical function defined over a finite ring and an independent variable x of the number-theoretical function, the number-theoretical function being a quadratic-hyperbolic function having both a denominator of a quadratic polynomial defined over the finite ring and a numerator of a linear polynomial defined over the finite ring, and the second public key being generated by performing an addition operation defined for the finite commutative group on the first public key one or more times thereby to multiply the first public key by a secret key representing a scalar coefficient; and (b) performing an addition operation defined for the finite commutative group on the plain text data by use of the read first and second public keys thereby to encrypt the plain text data. The addition operation is performed to add first and second elements of the finite commutative group by, when a third element other than the first and second elements is determined as one of solutions of a set of two simultaneous equations represented by the quadratic-hyperbolic function and a first linear function which has the first and second elements as solutions of an equation of the first linear function, calculating, as the addition result other than the third element and a predetermined fixed element of the finite commutative group, a fourth element which is one of solutions of a set of two simultaneous equations represented by the quadratic-hyperbolic function and a second linear function which has the third element and the predetermined fixed element as solutions of an equation of the second linear function.

In the key generation method according to the second aspect of the present invention, said step (b) may include the steps of:

setting a scalar coefficient of a positive integer;

performing said addition operation on said first public key thereby to multiply said first public key by said scalar coefficient to generate a first session key;

performing said addition operation on said second public key thereby to multiply said second public key by said scalar coefficient to generate a second session key; and

performing said addition operation on said plain text data by use of said first and second session keys thereby to encrypt said plain text data.

In the key generation method according to the second aspect of the present invention, said predetermined fixed element may be a unit element with respect to said addition operation.

In the key generation method according to the second aspect of the present invention, an element of said finite commutative group may satisfy a condition that the quadratic polynomial of said number-theoretical function is a quadratic non-residue modulo an order p of said finite ring.

In the key generation method according to the above-described aspect of the present invention, an order of said finite commutative group may be an odd prime number.

The order of said finite commutative group may be a composite number containing an odd prime number as a factor.

In the key generation method according to the second aspect of the present invention, said finite ring may be a residue class ring Z/pZ made by all of residue classes for integers modulo an odd prime number of p.

In the key generation method according to the second aspect of the present invention, said quadratic-hyperbolic function may be given by the following expression:

y=(x−b)/(x²+cx−a),

for integers a, b and c that are elements of said finite ring.

In the key generation method according to the second aspect of the present invention, said quadratic-hyperbolic function may be given by the following expression:

y=(dx+e)/(ax²+bx+ca),

for integers a, b, c, d and e that are elements of said finite ring.

According to a third aspect of the present invention, there is provided a key generation method for generating a digital signature from plain text data. The key generation method comprises the steps of: (a) reading, from a memory, a secret key of a scalar coefficient and a public key which is an element of a finite commutative group being a set of pairs (x, y) of a dependent variable y of a number-theoretical function defined on a finite ring and an independent variable x of the number-theoretical function, the number-theoretical function being a quadratic-hyperbolic function having both a denominator of a quadratic polynomial defined over the finite ring and a numerator of a linear polynomial defined over the finite ring; (b) generating digest data based on the plain text data; and (c) performing an addition operation defined for the finite commutative group one or more times on the digest data by use of the secret key and public key read from the memory in the step (a), thereby to encrypt the digest data to generate digital signature data. The addition operation is performed to add first and second elements of the finite commutative group by, when a third element other than the first and second elements is determined as one of solutions of a set of two simultaneous equations represented by the quadratic-hyperbolic function and a first linear function which has the first and second elements as solutions of an equation of the first linear function, calculating, as the addition result other than the third element and a predetermined fixed element of the finite commutative group, a fourth element which is one of solutions of a set of two simultaneous equations represented by the quadratic-hyperbolic function and a second linear function which has the third element and the predetermined fixed element as solutions of an equation of the second linear function.

In the key generation method according to the third aspect of the present invention, said step (c) may include the steps of:

setting a scalar coefficient of a positive integer;

performing said addition operation on said public key thereby to multiply said public key by said scalar coefficient to generate a session key; and

performing said addition operation on said digest data by use of said session key, said public key and said secret key thereby to encrypt said digest data.

In the key generation method according to the third aspect of the present invention, said predetermined fixed element may be a unit element with respect to said addition operation.

In the key generation method according to the third aspect of the present invention, an element of said finite commutative group may satisfy a condition that the quadratic polynomial of said number-theoretical function is a quadratic non-residue modulo an order p of said finite ring.

In the key generation method according to the above described aspect of the present invention, an order of said finite commutative group is an odd prime number.

The order of said finite commutative group may a composite number containing an odd prime number as a factor.

In the key generation method according to the third aspect of the present invention, said finite ring may be a residue class ring Z/pZ made by all of residue classes for integers modulo an odd prime number of p.

In the key generation method according to the third aspect of the present invention, said quadratic-hyperbolic function may be given by the following expression:

y=(x−b)/(x²+cx−a),

for integers a, b and c that are elements of said finite ring.

In the key generation method according to the third aspect of the present invention, said quadratic-hyperbolic function may be given by the following expression:

y=(dx+e)/(ax²+bx+ca),

for integers a, b, c, d and e that are elements of said finite ring.

According to a fourth aspect of the present invention, there is provided a key generation apparatus for generating a key for cryptographic process. The key generation apparatus comprises: a key setting part for setting a secret key representing a scalar coefficient, and selecting, as a first public key, an element of a finite commutative group that is a set of pairs (x, y) of a dependent variable y of a number-theoretical function defined over a finite ring and an independent variable x of the number-theoretical function, the number-theoretical function being a quadratic-hyperbolic function having both a denominator of a quadratic polynomial defined over the finite ring and a numerator of a linear polynomial defined over the finite ring; and a key generator for performing an addition operation defined for the finite commutative group on the first public key one or more times thereby to multiply the first public key by the secret key representing a scalar coefficient to generate a second public key. The key generator performs the addition operation to add first and second elements of the finite commutative group by, when a third element other than the first and second elements is determined as one of solutions of a set of two simultaneous equations represented by the quadratic-hyperbolic function and a first linear function which has the first and second elements as solutions of an equation of the first linear function, calculating, as the addition result other than the third element and a predetermined fixed element of the finite commutative group, a fourth element which is one of solutions of a set of two simultaneous equations represented by the quadratic-hyperbolic function and a second linear function which has the third element and the predetermined fixed element as solutions of an equation of the second linear function.

According to a fifth aspect of the present invention, there is provided a key generation apparatus for encrypting plain text data. The key generation apparatus comprises: a memory for storing first and second public keys which are elements of a finite commutative group being a set of pairs (x, y) of a dependent variable y of a number-theoretical function defined on a finite ring and an independent variable x of the number-theoretical function, the number-theoretical function being a quadratic-hyperbolic function having both a denominator of a quadratic polynomial defined over the finite ring and a numerator of a linear polynomial defined over the finite ring, and the second public key being generated by performing an addition operation defined for the finite commutative group on the first public key one or more times thereby to multiply the first public key by a secret key representing a scalar coefficient; and an encryption processing part for performing an addition operation defined for the finite commutative group on the plain text data by use of the first and second public keys read from the memory, thereby to encrypt the plain text data. The encryption processing part performs the addition operation to add first and second elements of the finite commutative group by, when a third element other than the first and second elements is determined as one of solutions of a set of two simultaneous equations represented by the quadratic-hyperbolic function and a first linear function which has the first and second elements as solutions of an equation of the first linear function, calculating, as the addition result other than the third element and a predetermined fixed element of the finite commutative group, a fourth element which is one of solutions of a set of two simultaneous equations represented by the quadratic-hyperbolic function and a second linear function which has the third element and the predetermined fixed element as solutions of an equation of the second linear function.

According to a sixth aspect of the present invention, there is provided a key generation apparatus for generating a digital signature from plain text data. The key generation apparatus comprises: a memory for storing a secret key of a scalar coefficient and a public key which is an element of a finite commutative group being a set of pairs (x, y) of a dependent variable y of a number-theoretical function defined on a finite ring and an independent variable x of the number-theoretical function, the number-theoretical function being a quadratic-hyperbolic function having both a denominator of a quadratic polynomial defined over the finite ring and a numerator of a linear polynomial defined over the finite ring; a digest generator for generating digest data based on the plain text data; and an encryption processing part for performing an addition operation defined for the finite commutative group one or more times on the digest data by use of the secret key and public key read from the memory, thereby to encrypt the digest data to generate digital signature data. The encryption processing part performs the addition operation to add first and second elements of the finite commutative group by, when a third element other than the first and second elements is determined as one of solutions of a set of two simultaneous equations represented by the quadratic-hyperbolic function and a first linear function which has the first and second elements as solutions of an equation of the first linear function, calculating, as the addition result other than the third element and a predetermined fixed element of the finite commutative group, a fourth element which is one of solutions of a set of two simultaneous equations represented by the quadratic-hyperbolic function and a second linear function which has the third element and the predetermined fixed element as solutions of an equation of the second linear function.

According to a seventh aspect of the present invention, there is provided a decoding method for decoding cipher text data. The decoding method comprises the steps of: (a) receiving the cipher text data which is encrypted using elements of a finite commutative group being a set of pairs (x, y) of a dependent variable y of a number-theoretical function defined over a finite ring and an independent variable x of the number-theoretical function, the number-theoretical function being a quadratic-hyperbolic function having both a denominator of a quadratic polynomial defined over the finite ring and a numerator of a linear polynomial defined over the finite ring; (b) reading a secret key from a memory; and (c) performing an addition operation defined for a finite commutative group one or more times on the cipher text data by use of the read secret key thereby to convert the cipher text data into plain text data. The addition operation is performed to add first and second elements of the finite commutative group by, when a third element other than the first and second elements is determined as one of solutions of a set of two simultaneous equations represented by the quadratic-hyperbolic function and a first linear function which has the first and second elements as solutions of an equation of the first linear function, calculating, as the addition result other than the third element and a predetermined fixed element of the finite commutative group, a fourth element which is one of solutions of a set of two simultaneous equations represented by the quadratic-hyperbolic function and a second linear function which has the third element and the predetermined fixed element as solutions of an equation of the second linear function.

According to an eighth aspect of the present invention, there is provided a decoding apparatus for decoding cipher text data. The decoding apparatus comprises: a memory for storing a secret key; and a decoder for receiving the cipher text data which is encrypted using elements of a finite commutative group being a set of pairs (x, y) of a dependent variable y of a number-theoretical function defined over a finite ring and an independent variable x of the number-theoretical function, the number-theoretical function being a quadratic-hyperbolic function having both a denominator of a quadratic polynomial defined over the finite ring and a numerator of a linear polynomial defined over the finite ring, and for performing an addition operation defined for the finite commutative group one or more times on the received cipher text data by use of a secret key, thereby to convert the cipher text data into plain text data. The addition operation is performed to add first and second elements of the finite commutative group by, when a third element other than the first and second elements is determined as one of solutions of a set of two simultaneous equations represented by the quadratic-hyperbolic function and a first linear function which has the first and second elements as solutions of an equation of the first linear function, calculating, as the addition result other than the third element and a predetermined fixed element of the finite commutative group, a fourth element which is one of solutions of a set of two simultaneous equations represented by the quadratic-hyperbolic function and a second linear function which has the third element and the predetermined fixed element as solutions of an equation of the second linear function.

According to a ninth aspect of the present invention, there is provided a signature verification method for verifying validity of digital signature data using plain text data supplied from an outside source. The signature verification method comprises the steps of: (a) reading, from a memory, a public key that is an element of a finite commutative group being a set of pairs (x, y) of a dependent variable y of a number-theoretical function defined over a finite ring and an independent variable x of the number-theoretical function, the number-theoretical function being a quadratic-hyperbolic function having both a denominator of a quadratic polynomial defined over the finite ring and a numerator of a linear polynomial defined over the finite ring; (b) performing an addition operation defined for the finite commutative group one or more times on the digital signature data by use of the read public key to generate verification data; (c) generating digest data based on the plain text data; and (d) determining whether or not the digest data is matched with the verification data. The addition operation is performed to add first and second elements of the finite commutative group by, when a third element other than the first and second elements is determined as one of solutions of a set of two simultaneous equations represented by the quadratic-hyperbolic function and a first linear function which has the first and second elements as solutions of an equation of the first linear function, calculating, as the addition result other than the third element and a predetermined fixed element of the finite commutative group, a fourth element which is one of solutions of a set of two simultaneous equations represented by the quadratic-hyperbolic function and a second linear function which has the third element and the predetermined fixed element as solutions of an equation of the second linear function.

According to a tenth aspect of the present invention, there is provided a signature verification apparatus for verifying validity of digital signature data using plain text data supplied from an outside source. The signature verification apparatus comprises: a memory for storing a public key that is an element of a finite commutative group being a set of pairs (x, y) of a dependent variable y of a number-theoretical function defined on a finite ring and an independent variable x of the number-theoretical function, the number-theoretical function being a quadratic-hyperbolic function having both a denominator of a quadratic polynomial defined over the finite ring and a numerator of a linear polynomial defined over the finite ring; a digest generator for generating digest data based on the plain text data; and a signature verification part for performing an addition operation defined for the finite commutative group one or more times on the digital signature data by use of the public key read from the memory to generate verification data, and for determining whether or not the digest data is matched with the verification data. The signature verification part performs the addition operation to add first and second elements of the finite commutative group by, when a third element other than the first and second elements is determined as one of solutions of a set of two simultaneous equations represented by the quadratic-hyperbolic function and a first linear function which has the first and second elements as solutions of an equation of the first linear function, calculating, as the addition result other than the third element and a predetermined fixed element of the finite commutative group, a fourth element which is one of solutions of a set of two simultaneous equations represented by the quadratic-hyperbolic function and a second linear function which has the third element and the predetermined fixed element as solutions of an equation of the second linear function.

According to an eleventh aspect of the present invention, there is provided a key stream generation apparatus for generating a key stream comprised of a series of pseudo-random numbers. The key stream generation apparatus comprises: a group controller for setting curve parameters specifying a form of a number-theoretical function defined over a finite ring, and for setting a base point which is an element of a finite commutative group being a set of pairs (x, y) of a dependent variable y of the number-theoretical function and an independent variable x of the number-theoretical function; a key setting part for setting a secret key representing a scalar coefficient; a session key generator for performing an addition operation defined for the finite commutative group one or more times on the base point set by the group controller, by use of the secret key set by the key setting part, thereby to multiply the set base point by the set secret key representing a scalar coefficient to generate a session key; a stream generator for generating the key stream comprised of a series of pseudo-random numbers based on the session key; and a group parameter generator for newly generating at least one of the curve parameters, the base point and the secret key at every specified time. The group controller replaces the base point currently set therein with the base point newly generated by the group parameter generator, and replaces the one or more curve parameters currently set therein with the respective one or more curve parameters newly generated by the group parameter generator. The key setting part replaces the secret key currently set therein with the secret key newly generated by the group parameter generator.

The key stream generation apparatus according to the eleventh aspect of the present invention, may further comprise a data randomizing part for randomizing an input data series using said key stream to generate an output data series.

In the key stream generation apparatus according to the eleventh aspect of the present invention, said stream generator may generate said key stream based on at least one of said curve parameters, said base point and said secret key, in addition to said session key.

In the key stream generation apparatus according to the eleventh aspect of the present invention, said group parameter generator may include a point generator for newly generating said base point based on at least one of said session key and said key stream.

In the key stream generation apparatus according to the above described aspect of the preset invention, said point generator may have:

a substitute table memory for storing a plurality of elements of said finite commutative group;

an address controller for addressing a storage area in said substitute table memory based on at least one of said session key and said key stream; and

a read controller for outputting an element read from said addressed storage area as the newly generated base point.

In the key stream generation apparatus according to the above described aspect of the invention,

said substitute table memory may store a plurality of scalar values;

said address controller may address a storage area in said substitute table memory based on at least one of said session key and said key stream; and

said read controller may output the scalar values read from the addressed storage area as the newly generated curve parameters.

The key stream generation apparatus according to the eleventh aspect of the present invention having the substitute table memory, the address controller, and the read controller, may further comprise a data updating part for generating an element of said finite commutative group based on at least one of said session key and said key stream to update data sets stored in said substitute table memory with the generated element.

In the key stream generation apparatus according to the above described aspect of the present invention, said data updating part may replace a most recently read data set of the stored data sets in said substitute table memory prior to replacing other ones of the stored data sets, thereby to update the stored data sets in said substitute table memory.

The key stream generation apparatus according to the eleventh aspect of the present invention having the substitute table memory, the address controller, and the read controller, may further comprise a data updating part for updating data sets stored in said substitute table memory with data occurring in the process of generating said session key.

In the key stream generation apparatus according to the above described aspect of the present invention, said data updating part may replace a most recently read data set of the stored data sets in said substitute table memory prior to replacing other ones of the stored data sets, thereby to update the stored data sets in said substitute table memory.

In the key stream generation apparatus according to the eleventh aspect of the present invention and in which said group parameter generator includes the point generator, said group parameter generator may further include a point checking part for checking whether or not said base point newly generated by said point generator is identical to a unit element of said finite commutative group for said addition operation, and for providing the check result to said group controller, and said group controller may not replace the base point currently set therein when the newly generated base point is identical to said unit element.

In the key stream generation apparatus according to the eleventh aspect of the present invention, said group parameter generator may further include a secret key generator for newly generating said secret key based on at least one of said session key and said key stream.

In the key stream generation apparatus according to the above described aspect of the present invention, said group parameter generator may further include a key checking part for, when an effective bit length of the secret key newly generated by said secret key generator is less than a threshold, replacing all or part of bits of said secret key with predetermined bits thereby to increment the effective bit length of the newly generated secret key.

In the key stream generation apparatus according to the eleventh aspect of the present invention, said number-theoretical function may be a quadratic-hyperbolic function having both a denominator of a quadratic polynomial defined over said finite ring and a numerator of a linear polynomial defined over said finite ring; and said session key generator may perform said addition operation to add first and second elements of said finite commutative group by:

when a third element other than said first and second elements is determined as one of solutions of a set of two simultaneous equations represented by said quadratic-hyperbolic function and a first linear function which has said first and second elements as solutions of an equation of said first linear function,

calculating, as the addition result other than said third element and a predetermined fixed element of said finite commutative group, a fourth element which is one of solutions of a set of two simultaneous equations represented by said quadratic-hyperbolic function and a second linear function which has said third element and said predetermined fixed element as solutions of an equation of said second linear function.

According to a twelfth aspect of the present invention, there is provided a key stream generation method for generating a key stream comprised of a series of pseudo-random numbers. The key stream generation method comprises the steps of: (a) setting curve parameters specifying a form of a number-theoretical function defined over a finite ring, and for setting a base point which is an element of a finite commutative group being a set of pairs (x, y) of a dependent variable y of the number-theoretical function and an independent variable x of the number-theoretical function; (b) setting a secret key representing a scalar coefficient; (c) performing an addition operation defined for the finite commutative group one or more times on the base point set in the step (a), by use of the secret key set in the step (b), thereby to multiply the set base point by the set secret key representing a scalar coefficient to generate a session key; (d) generating the key stream comprised of a series of pseudo-random numbers based on the session key; (e) newly generating at least one of the curve parameters, the base point and the secret key at every specified time; (f) when the base point is newly generated in the step (e), replacing the base point being currently set with the newly generated base point; (g) when the curve parameters is newly generated in the step (e), replacing the curve parameters being currently set with the newly generated curve parameters; and (h) when the secret key is newly generated in the step (e), replacing the secret key being currently set with the newly generated secret key.

According to the first to tenth aspects, the key generation method, the key generation apparatus, the decoding method, the decoding apparatus, the signature verification method and the signature verification apparatus perform cryptographic key generation, encryption, digital signature generation, decoding and signature verification, respectively, by use of elements of the finite commutative group constructed based on the quadratic-hyperbolic function that includes the denominator of a quadratic polynomial as defined over the finite ring and the numerator of a linear polynomial as defined on the finite ring, thereby enabling the computational difficulty equivalent to that of breaking the elliptic curve cryptography.

Further, according to the first to tenth aspects, the key generation method, the key generation apparatus, the decoding method, the decoding apparatus, the signature verification method and the signature verification apparatus enable the order of the finite commutative group (i.e., a quadratic-hyperbolic curve group) to be calculated in a short time to ensure security even if parameters of the quadratic-hyperbolic function are changed, resulting in the construction of the quadratic-hyperbolic curve group having reliable security in a short period of time. Accordingly, a cryptosystem ensuring resistance against attacks can be provided.

According to the eleventh and twelfth aspects, the key stream generation apparatus and the key stream generation method generates a key stream comprised of the pseudo-random number sequence, by use of elements of the finite commutative group constructed by the quadratic-hyperbolic function that includes the denominator of a quadratic polynomial as defined over the finite ring and the numerator of a linear polynomial as defined on the finite ring. The key stream generation apparatus and the key stream generation method according to the invention newly generates, at every specified time, at least one of: the parameters (e.g., curve parameters and curve coefficients) specifying the function shape of the quadratic-hyperbolic function; the base point; and the secret key. The key stream generation apparatus and the key stream generation method further replace the base point being currently set with the newly generated base point, replace the curve parameter being currently set with the newly generated curve parameter, and replace the secret key being currently set with the newly generated secret key, thereby varying the group structure in real-time to generate the key stream. Accordingly, a stream cryptosystem having the high computational difficulty of breaking a cipher can be provided.

Additionally, the order of the finite commutative group (i.e., a quadratic-hyperbolic curve group) can be calculated in a short time to ensure security, even if parameters of the quadratic-hyperbolic function are changed. Thus, the group structure ensuring security can be obtained in real-time even if the base point or the parameters of the quadratic-hyperbolic function is changed with the order of the finite ring kept constant. Therefore, cryptographic operation can be performed by using all elements of the quadratic-hyperbolic curve group efficiently. The stream cryptosystem having the high computational difficulty of breaking a cipher can be implemented even if using a relatively short key length. The stream cryptosystem having a relatively simple configuration can be provided.

48. A key stream generation method for generating a key stream comprised of a series of pseudo-random numbers, comprising the steps of:

(a) setting curve parameters specifying a form of a number-theoretical function defined over a finite ring, and for setting a base point which is an element of a finite commutative group being a set of pairs (x, y) of a dependent variable y of said number-theoretical function and an independent variable x of said number-theoretical function;

(b) setting a secret key representing a scalar coefficient;

(c) performing an addition operation defined for said finite commutative group one or more times on said base point set in said step (a), by use of said secret key set in said step (b), thereby to multiply the set base point by the set secret key representing a scalar coefficient to generate a session key;

(d) generating the key stream comprised of a series of pseudo-random numbers based on said session key;

(e) newly generating at least one of said curve parameters, said base point and said secret key at every specified time;

(f) when the base point is newly generated in said step (e), replacing the base point being currently set with the newly generated base point; (g) when the curve parameters is newly generated in said step (e), replacing the curve parameters being currently set with the newly generated curve parameters; and

(h) when the secret key is newly generated in said step (e), replacing the secret key being currently set with the newly generated secret key.

Further features of the invention, its nature and various advantages will be more apparent from the accompanying drawings and the following detailed description of the preferred embodiments.

### BRIEF DESCRIPTION OF THE DRAWINGS

FIG. 1 is a functional block diagram showing a schematic configuration of a key generation apparatus according to a first embodiment of the present invention;

FIG. 2 is a graph schematically showing an example of a quadratic-hyperbolic curve;

FIG. 3 exemplarily illustrates elements of a quadratic-hyperbolic curve group Hc(Z/23Z);

FIG. 4 illustrates computation results of the order k of a quadratic-hyperbolic curve group Hc(Z/pZ) satisfying a condition of a quadratic non-residue;

FIG. 5 exemplarily illustrates a generated group Q[x];

FIG. 6 is a representation of an inclusion relation of the generated group Q[x] shown in FIG. 5;

FIG. 7 is a functional block diagram showing a schematic configuration of a cryptographic system according to a first embodiment;

FIG. 8 is a diagram showing a schematic configuration of a digital signature system according to the first embodiment;

FIG. 9 illustrates proof results of Theorem T8;

FIGS. 10A and 10B illustrate exemplary simple computation results regarding Theorem T8;

FIGS. 11A and 11B illustrate another example of simple computation results regarding Theorem T8;

FIG. 12 is a functional block diagram showing a schematic configuration of a key stream generation apparatus according to a second embodiment of the present invention;

FIG. 13 is a block diagram showing a schematic configuration of a point generator according to the second embodiment;

FIG. 14 illustrates exemplary outputs of a rubber function;

FIG. 15 is a circuit diagram schematically showing one example of a configuration of a point checking part according to the second embodiment;

FIG. 16 is a flowchart showing an exemplary procedure of generating a secret key;

FIG. 17 is a block diagram schematically showing an exemplary configuration of a key checking part according to the second embodiment;

FIG. 18 illustrates an exemplary configuration comprised of various kinds of functions;

FIGS. 19A and 19B illustrate exemplary simple numerical values stored in a substitute table;

FIG. 20 illustrates another example of a configuration comprised of various kinds of functions;

FIGS. 21A and 21B illustrate a numerical example calculated by using functions shown in FIG. 20;

FIG. 22 illustrates still another example of a configuration comprised of various kinds of functions;

FIG. 23 is a block diagram schematically showing another example of a configuration of a point generator;

FIG. 24 is a flowchart showing an exemplary procedure of generating data;

FIG. 25 is a block diagram schematically showing an exemplary configuration of a data updating part using an LUE method;

FIGS. 26A and 26B illustrate a situation when the contents of a substitute table are updated;

FIG. 27 illustrates exemplary numerical values;

FIGS. 28A and 28B illustrate a situation when the contents of a substitute table are updated;

FIG. 29 illustrates exemplary numerical values; and

FIG. 30 illustrates a situation when a substitute table is accessed.

### DETAILED DESCRIPTION OF THE INVENTION

This application is based on Japanese patent application No. 2007-039780, and claims the benefit thereof. The Japanese patent application is hereby incorporated by reference.

Several preferred embodiments of the present invention will now be described.

### 1. First Embodiment

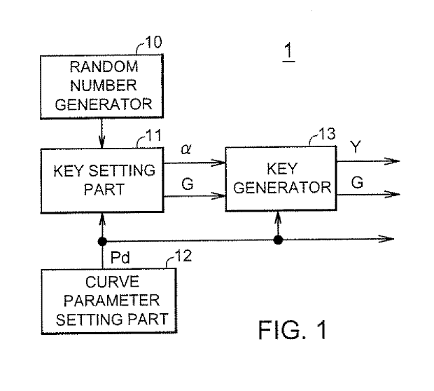

FIG. 1 is a functional block diagram showing a schematic configuration of a key generation apparatus 1 according to a first embodiment of the present invention. The key generation apparatus 1 comprises a random number generator 10, a key setting part 11, a curve parameter setting part 12 and a key generator 13. All or part of the functional blocks 10 to 13 can be implemented by a circuit configuration of hardware, or a program or program code stored on a recording medium such as a non-volatile memory or optical disk. Such program or program code enables a processor such as a CPU to perform processing of all or part of the functional blocks 10 to 13.

The key generation apparatus 1 is capable of generating a key used for cryptographic process, by use of elements of a finite commutative group Hc(Rp) that is a set of points consisting of pairs (x,y) of a dependent variable y=f(x) of a number-theoretical function defined over a finite ring Rp and an independent variable x (where x is an integer) of the number-theoretical function. The number-theoretical function y=f(x) has a denominator of a quadratic polynomial defined over the finite ring Rp and a numerator of a linear polynomial defined over the finite ring Rp. This number-theoretical function y can be represented by a quadratic-hyperbolic function Hc (hereinafter simply referred to as a “quadratic-hyperbolic curve Hc”) given by the following expression (1a):

$$Hc \text{:} y = \frac{x - b}{{x}^{2} + cx - a} = \frac{1}{{x}^{2} + cx - a} \cdot ( x - b ) , \qquad ( 1 a )$$

where x²+cx−a≠0. Herein, x and y are elements of the finite ring Rp (i.e., Rp×Rp [symbol] (x,y)), and the curve parameters a, b and c are also the elements of the finite ring Rp (i.e., Rp [symbol] a, b, c). Hereinafter, when an inverse element for an element r of the finite ring Rp with respect to multiplication exists, the inverse element is referred to as r⁻¹ or 1/r. Let now “1” be the unit element of the finite ring Rp. Then, r·r⁻¹=r·(1/r)=1. The right side of the above expression (1a) contains a factor of 1/(x²+cx−a) that is represented by the reciprocal of the quadratic polynomial. This factor nonetheless means an inverse element for the value of the quadratic polynomial x²+cx−a that is an element of the finite ring Rp.

When the set {a, b, c} representing the curve parameters of the quadratic-hyperbolic curve Hc is converted into {−(c/a),−(e/d),b/a}, and the dependent variable y is converted into (a/d)·y, the following expression (1b) equivalent to the expression (1a) is obtained:

$$Hg \text{:} y = \frac{dx + e}{{ax}^{2} + bx + c} = \frac{1}{{ax}^{2} + bx + c} \cdot ( dx + e ) , \qquad ( 1 b )$$

where ax²+bx+c≠0. Herein, x and y are elements of the finite ring Rp (i.e., Rp×Rp [symbol] (x,y)), and the curve parameters a, b, c, d and e are also elements of the finite ring Rp (i.e., Rp [symbol] a, b, c, d, e). A key for encryption process can be generated using elements of the finite commutative group Hg(Rp) constituted by the number-theoretical function given by the expression (1b) instead of the expression (1a).

The finite ring Rp is preferably a residue class ring Z/pZ made by all of residue classes of integers modulo an odd prime number p, no limitation thereto intended. The quadratic-hyperbolic curves Hc and Hg as defined over the residue class ring Z/pZ can be given by the following congruent expressions (2a) and (2b):

$$\begin{matrix}Hc \text{:} y ≡ \frac{x - b}{{x}^{2} + cx - a} ( mod p ) , & ( 2 a ) \\ Hg \text{:} y ≡ \frac{dx + e}{{ax}^{2} + bx + c} ( mod p ) . & ( 2 b )\end{matrix}$$

When x₁-x₂ is divisible by p for the integers x₁ and x₂, it is said that the integers x₁ and x₂ are congruent modulo p, and the congruent relation is expressed by “x₁≡x₂ (mod p)”. This congruent relation is equivalent to the relation such that the integers x₁ and x₂ have the same remainder on division by p. A set of the equivalence classes, which forms a ring, is typically denoted by Z/pZ. When an inverse element X₃ (=1/x₁) for the integer x₁ exists with respect to multiplication, x₁·x₃≡1 (mod p). For example, for two elements “3” and “4” of the residue class ring Z/11Z, 3·4=12≡1 (mod 11). Then, the elements “3” and “4” give inverse elements to each other. It is noted that the inverse element 1/x₁ for the element x₁ of the finite ring is an integer. For example, the element representing “½” is “6” that is the inverse element for “2”, and does not mean a positive rational number (=0.5) less than 1.

When p=11, a=7, b=2 and c=0, the quadratic-hyperbolic curve Hc defined over the residue class ring Z/pZ is given by the congruent expression: y≡(x−2)/(x²−7) (mod 11). A set of the points (x,y) satisfying this congruent expression includes the points: (5,2), (6,10), (9,5), (8,3), (3,6) and (2,0). For (x,y)=(5,2), x²−7 (mod 11)=7, and the inverse element for “7” is “8”. Also, x−2 (mod 11)=3, and 3·8=24≡2 (mod 11). Therefore, the point (x,y)=(5,2) satisfies the congruent expression: y≡(x−2)/(x²−7) (mod 11).

The inventor of the present invention has found that, for an appropriate addition operation defined on the points on the quadratic-hyperbolic curve Hc defined over the finite ring Rp, a set of points on the quadratic-hyperbolic curve Hc can be a finite commutative ring Hc(Rp) with respect to the addition operation. Similarly, the quadratic-hyperbolic curve Hg defined on the finite ring Rp can be a finite commutative group Hg(Rp) with respect to the addition operation. Hereinafter, the finite commutative group of this kind is called a “quadratic-hyperbolic curve group”. The structure of the quadratic-hyperbolic curve group will be described later.

The curve parameter setting part 12 as shown in FIG. 1 is capable of setting the curve parameters a, b and c of the quadratic-hyperbolic curve Hc to appropriate values, and storing, in a memory (not shown), setting data Pd indicating the combination {a, b, c} of the curve parameters as one of public keys. The setting data Pd is supplied to the key setting part 11 and the key generator 13.

The random number generator 10 can generate physical random numbers using a random natural phenomenon such as thermal noises or nuclear fission. Alternatively, the random number generator 10 can generate pseudo-random numbers based on the numerical value that is a seed in accordance with a predetermined mathematical algorithm. The key setting part 11 generates an integer value of a predetermined bit length, using the random number supplied by the random number generator 10, and sets the value of a secret key α for encryption process to the generated integer value.

The key setting part 11 is capable of selecting, as one of public keys (i.e., a first public key), a base point G on the quadratic-hyperbolic curve Hc specified by the curve parameters a, b and c. The key setting part 11 supplies the public key G and the secret key α to the key generator 13. The key generator 13 is capable of performing, on the public key G, an addition operation defined for the quadratic-hyperbolic curve group Hc (or Rp) specified by the curve parameters a, b, c, thereby to multiply the public key G by the secret key α of a scalar coefficient to generate one of the public keys (i.e., a second public key) Y. Let “+” be the symbol of the addition operation for the quadratic-hyperbolic curve group Hc (or Rp). Then, the following expression (3) is given with respect to the public keys G, Y and the secret key α of a scalar coefficient:

Y=αG=G+ . . . +G. (3)

According to the expression (3), a problem of finding a unique secret key α based on the public keys G and Y is a Discrete Logarithm Problem on the quadratic-hyperbolic curve Hc. It is very difficult to solve this Discrete Logarithm Problem under the condition that the curve parameters a, b and c are appropriately selected, like the Discrete Logarithm Problem on the elliptic curve. When an attacker tries to obtain the secret key α, it is required to perform the addition operation at least α times. On the other hand, a high-speed index calculation method, which is widely used in a modulo arithmetic operation, can be applied to computation of Y=αG to greatly reduce an amount of computational effort of the point Y. When the order k of the quadratic-hyperbolic curve group Hc (or Rp) can be expressed by using an expansion of a power series of 2, the secret key α can be given by an expansion of a power series of 2. In this case, the expression (3) can be changed into the following expression (3 a):

$$Y = α G = ( {\sum }_{i = 0}^{m - 1} {β}_{i } \cdot {2}^{i} ) G , \qquad ( 3 a )$$

where m is a positive integer, and βᵢ has a value of either 0 or 1. Since 2ⁱG=2·(2ⁱ⁻¹G), 2ⁱG can be computed by performing one addition operation using the computation result of 2ⁱ⁻¹G. Hence, in order to perform multiplication by scalars for the point Y, the addition operation can be performed 2·(m−1) times. Since 2^{m-1}<k<2^{m}, m is nearly equal to log₂k. When an attacker needs to perform the addition operation N times to obtain the secret key α and the secret key α is set to about half the value of the order k, m−1≅log₂k−1≅log₂(2N)−1=log₂N for N=α. Thus, in order to compute Y=αG, it is sufficient to perform the addition operation about 2·log₂N times. The ratio between amounts of the computational efforts is about (2·log₂N)/N. When α=234, it is sufficient to perform the addition operation log₂234≅15.7 times. Then, by using the high speed exponential operation method, an amount of the computational effort of the multiplication by scalars for the point Y can be reduced to about 1/7 of the amount in case that the high speed exponential operation method is not used. Also, when the secret key α of 100 bits is used, by using the high speed exponential operation method, an amount of the computational effort of the multiplication by scalars for the point Y can be reduced to about 1/10²⁸ of the amount in case that the high speed exponential operation method is not used.

In the addition operation defined for the quadratic-hyperbolic curve group Hc(Rp), two elements P(x₁,y₁) and Q(x₂,y₂) of the quadratic-hyperbolic curve group Hc(Rp) are adds in the following manner: When a third element S(x₁₂,y₁₂) other than the elements P(x₁,y₁) and Q(x₂,y₂) is determined as one of solutions of a set of two simultaneous equations represented by the quadratic-hyperbolic curve Hc and a linear function y=L_{PQ}(x) which has these elements P and Q as solutions of an equation of the linear function y=L_{PQ}(x), a fourth element R(x₃,y₃) other than the third element S and a predetermined fixed element O(x₀,y₀) of the quadratic-hyperbolic curve group Hc(Rp) is calculated as the addition result that is one of solutions of a set of two simultaneous equations represented by the quadratic-hyperbolic curve Hc and a linear function y=L_{SO}(x) which has the third element S and the predetermined fixed element O(x₀,y₀) as solutions of an equation of the linear function y=L_{SO}(x).

More specifically, when the linear function y=L_{PQ}(x) is represented by the form of y=a₁x+b₁, the parameters a₁ and b₁ are uniquely determined based on the given elements P(x₁,y₁) and Q(x₂,y₂) firstly, thus specifying the form of the linear function y=L_{PQ}(x). When the linear function y=L_{SO}(x) is represented by the form of y=a₂x+b₂, the parameters a₂ and b₂ are uniquely determined based on the two elements S and O, thus specifying the form of the linear function y=L_{SO}(x). The fourth element R(x₃,y₃) can be calculated by solving the simultaneous equations represented by the linear function y=L_{SO}(x) and the quadratic-hyperbolic curve Hc.

The above addition operation can be geometrically described in the following manner: In the case where two points P(x₁,y₁) and Q(x₂,y₂) having different coordinates on the quadratic-hyperbolic curve Hc are added, when the first intersection point S(x₁₂,y₁₂) of the straight line connecting the two points P and Q with the quadratic-hyperbolic curve Hc is determined, the second intersection point R(x₃,y₃) of the straight line connecting the first intersection point S(x₁₂,y₁₂) and the predetermined fixed point O (x₀, y₀) with the quadratic-hyperbolic curve Hc is given as the addition result. On the other hand, In the case where two points P(x₁,y₁) and Q(x₁,y₁) having the same coordinate on the quadratic-hyperbolic curve Hc, when the first intersection point S(x₁₂,y₁₂) of the tangential line at the two contact points P and Q with the quadratic-hyperbolic curve Hc is determined, the second intersection point R(x₃,y₃) of the straight line connecting the first intersection point S(x₁₂,y₁₂) and the predetermined fixed point O(x₀,y₀) with the quadratic-hyperbolic curve Hc is given as the addition result.

In addition, when the fixed point O(x₀,y₀) is added to any point P(x₁,y₁), the addition result becomes the point P(x₁,y₁) itself, because the linear function y=L_{PO}(x) is identical to the linear function y=L_{OP}(x). Accordingly, the fixed point O(x₀,y₀) is a unit element, namely, a zero element of the quadratic-hyperbolic curve group Hc(Rp).

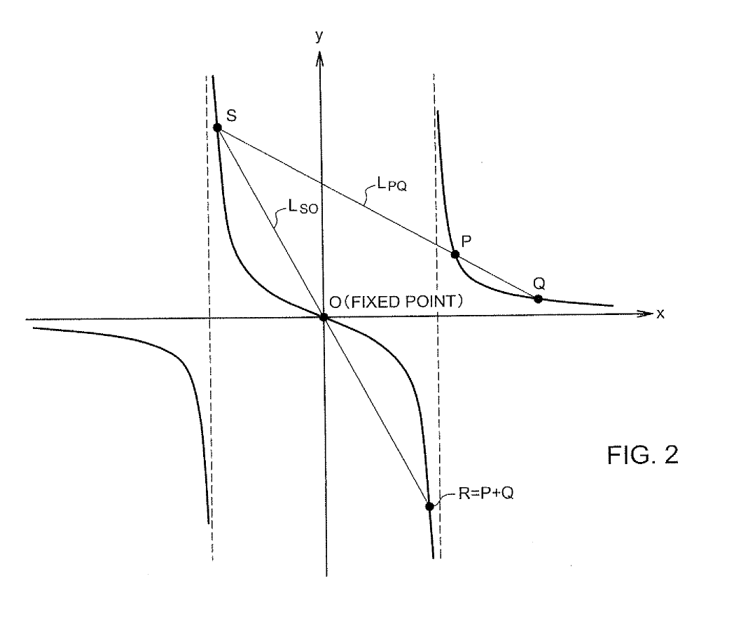

FIG. 2 is a graph schematically showing an example of the quadratic-hyperbolic curve Hc under the condition that c=0 and |b|²<a. When the two points P and Q (P≠Q) on the quadratic-hyperbolic curve Hc are given as shown in FIG. 2, the first intersection point S of the straight line L_{PQ} connecting these two points P and Q with the quadratic-hyperbolic curve Hc is determined. The second intersection point R(=P+Q) of the straight line L_{SO} connecting this first intersection point S and the fixed point O with the quadratic-hyperbolic curve Hc is calculated as the addition result. As will be apparent from the graph of FIG. 2, even if the points P and Q are exchanged, the point R representing the addition result of the two points P and Q is unchanged (i.e., R=P+Q=Q+P). Therefore, the two points P and Q are commutative with respect to the addition operation.

Assuming that the fixed point Q(x₀,y₀) is set to a point O(b,0) on the quadratic-hyperbolic curve Hc (where b is a curve parameter of the quadratic-hyperbolic curve Hc), when the two points P(x₁,y₁) and Q(x₂,y₂) having different coordinates on the quadratic-hyperbolic curve Hc are added, the coordinate value X₃ of the point R(x₃,y₃) representing the addition result is given by the following expression (4a):

$${x}_{3} = - ( b + c ) - \frac{( b ( b + c ) - a ) ( {x}_{1} + {x}_{2} + c )}{{x}_{1} {x}_{2} - b ( {x}_{1} + {x}_{2} + c ) + a} . \qquad ( 4 a )$$

The above expression (4a) is symmetrical with respect to the X-coordinate values x₁ and y₂ of the two points P and Q. In other words, when the values x₁ and y₂ are exchanged, the coordinate value x₃ of the point R is unchanged. Therefore, a commutative law for the addition operation is reduced, thus enabling the quadratic-hyperbolic curve groups Hc(Rp) and Hg(Rp) to be commutative groups.

When the two points P(x₁,y₁) and Q(x₁,y₁) having the same coordinate on the quadratic-hyperbolic curve are added, the coordinate value x₃ of the point R(x₃,y₃) representing the addition result is given by the following expression (4b):

$${x}_{3} = - ( b + c ) - \frac{( b ( b + c ) - a ) ( 2 {x}_{1} + c )}{{x}_{1}^{2} - b ( 2 {x}_{1} + c ) + a} . \qquad ( 4 b )$$

The expression (4b) is derived by substituting the coordinate value x₁ for the coordinate value x₂ of the expression (4a). As shown in the expressions (4a) and (4b), the coordinate value X₃ is calculated independently of the coordinate values y₁ and y₂. Thus, the key setting part 11 can set only the x-coordinate value of the public key G. The key generator 13 can perform the addition operation based on only the x-coordinate value. Hereinafter, the point on the quadratic-hyperbolic curve can be represented by use of only the x-coordinate value, such as P(x₁), as needed.

The unit element or zero element of the quadratic-hyperbolic curve group Hc(Rp) is the fixed point O(b,0). The x-coordinate value <x₁> of an inverse element T(<x₁>,<y₁>) for the point P (x₁,y₁) that is an element of the quadratic-hyperbolic curve group Hc(Rp) is given by the following expression (5):

$$< {x}_{1} >= \frac{{ex}_{1} + ( ec - a )}{{x}_{1} - e} , \\ where \\ {x}_{1} - e \neq 0 , e = \frac{{b}^{2} + a}{2 b + c} . \qquad ( 5 )$$

It is easily proven that the following equality is reduced by using the expression (4a):

P(x₁,y₁)+T(<x₁>,<y₁>)=O(b,0)

Let −P denote the inverse element T for the point P with respect to the addition operation by using the minus symbol “−”. Then, it is easily proven that the equality “O═—O” is established for the zero element O.

There is no inverse element for the point H obtained by forcing the right side of the expression (5) to be zero. The point H(x=e) is hereinafter referred to as a “prime element”. The prime element H can be excluded from the quadratic-hyperbolic curve group Hc (Rp). Like the zero element O, there is a point I(x=(2a−bc)/(2b+c)) such that the point I on the quadratic-hyperbolic curve Hc is identical to the inverse element for the point I. This point I is hereinafter referred to as an “even unit element”.

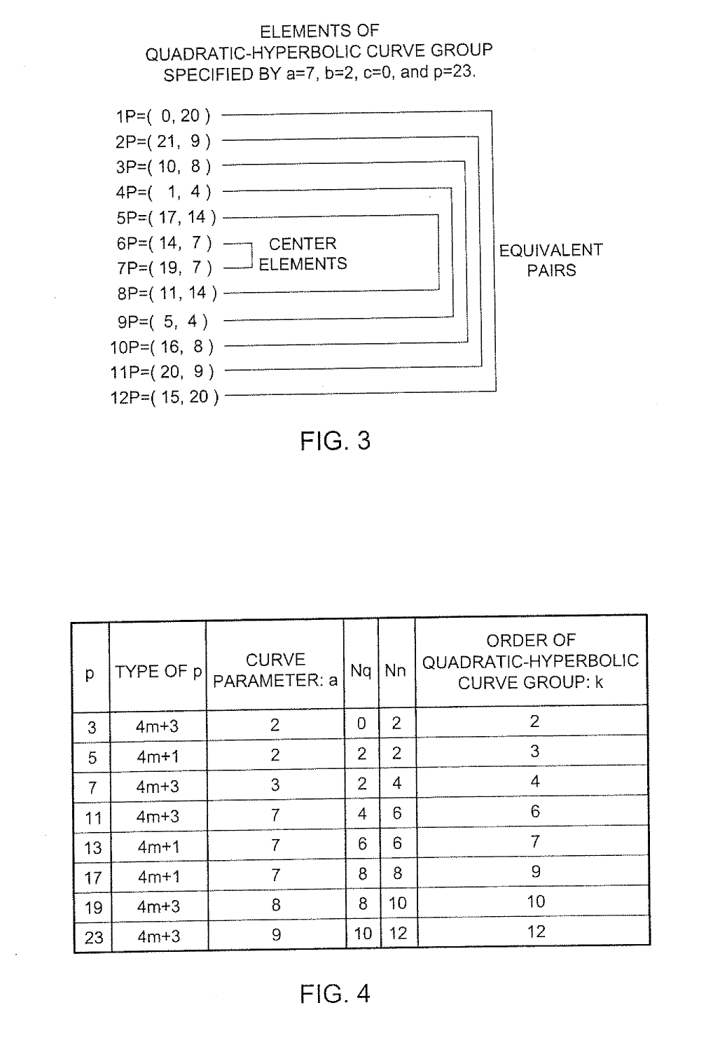

For example, when 1P=P(0,20) is selected as a base point of the quadratic-hyperbolic curve group Hc(Z/23Z) constructed from the quadratic-hyperbolic curve Hc (a=7, b=2,c=0) defined over the residue class ring Z/23Z, the points 2P(=P+P), 3P(=2P+P), . . . , and 12P(=11P+P) can be calculated as shown in FIG. 3. However, it is difficult to calculate the point 13P (=12P+P). The reason is that, since the y-coordinate value (=20) of the point P is equal to the y-coordinate value (=20) of the point 12P, the gradient of the straight line connecting the points P and 12P is zero, thereby causing a problem in which the addition operation cannot be performed (hereinafter referred to as a “problem of an equivalent pair”). As shown in FIG. 3, there is a pair of the points 6P=(14,7) and 7P=(19,7) which are center elements. Around the center elements, there are equivalent pairs such as a pair of points 5P and 8P, a pair of points 4P and 9P, a pair of points 3P and 10P, a pair of points 2P and 11P, and a pair of points P and 12P. These equivalent pairs appear to be propagated from a pair of the center elements 6P and 7P.

The problem of an equivalent pair may arise not only with generated groups of the quadratic-hyperbolic curve group Hc(Z/23Z), but also with generated groups of the quadratic-hyperbolic curve group Hc(Z/pZ) or Hg(Z/pZ). One method for avoiding the problem of an equivalent pair is to exclude one of two points constituting the equivalent pair from the elements of the generated group. As will be proven later, if elements of the generated group satisfies the condition that the denominator (x²+cx−a) or (ax²+bx+c) of the quadratic-hyperbolic curve Hc or Hg is a quadratic non-residue modulo p, the problem of an equivalent pair can be avoided. Assuming that the integers N and p are coprime (i.e., relatively prime), the integer N is called a “quadratic residue modulo p” if the congruent expression x²≡N (mod p) has a solution of the integer x. The integer N is called a “quadratic non-residue modulo p” if the congruent expression does not have a solution of the integer x.

The order k of the quadratic-hyperbolic curve group Hc(Z/pZ) satisfying the condition of the quadratic non-residue is given by the following expression (6) independently of the form of an odd prime number p:

$$k = \frac{p - 1}{2} + 1. \qquad ( 6 )$$

A proof of the expression (6) will be described later (see Theorem T9). A table of FIG. 4 shows computation results of the order k of the quadratic-hyperbolic curve group Hc(Z/pZ) satisfying the condition of the quadratic non-residue for the odd prime number p having the form of 4 m+n (where m and n are integers; b=2 and c=0). The table of FIG. 4 also shows the total number Nq of elements satisfying the condition of the quadratic residue as a part of the elements of the quadratic-hyperbolic curve group Hc(Z/pZ), and shows the total number Nn of elements satisfying the condition of the quadratic non-residue as a part of the elements of the quadratic-hyperbolic curve group Hc(Z/pZ). It is understood that the values of the order k as shown in the table of FIG. 4 satisfy the expression (6).

As described above, since the order k of the quadratic-hyperbolic curve group Hc(Z/pZ) according to this embodiment is explicitly represented independently of the curve parameters, the quadratic-hyperbolic curve cryptography according to this embodiment is easier to be treated than the conventional elliptic curve cryptography in which the order of the group can be varied when the curve parameter is changed. Accordingly, the order k of the quadratic-hyperbolic curve group Hc(Z/pZ) can be computed at sufficiently high speed. The secure quadratic-hyperbolic curve group can be constructed in a short time. Hence, even though an effective attack method against a currently used cryptographic system using the quadratic-hyperbolic curve group is found, the curve parameters can be changed to change the currently used cryptographic system to a new cryptographic system using the quadratic-hyperbolic curve group having a more secure structure.

In an encryption process, a predetermined element of the quadratic-hyperbolic curve group Hc(Z/pZ) is set as the base point. Further, points obtained by performing scalar-multiplication is associated with their corresponding sets of plain text data. In order to improve security and to enable the large number of bits of the plain text data to be encrypted, it is preferable that the base point is selected such that the order of the generated group obtained from the base point includes as large a prime factor as possible.

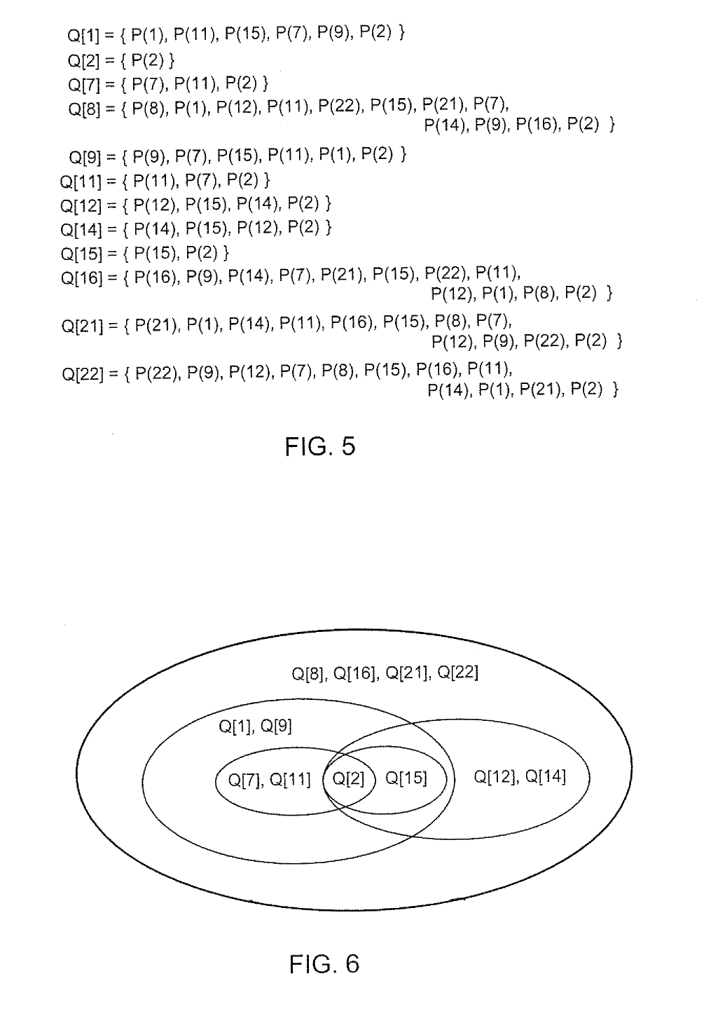

The security of the cryptographic system using the quadratic-hyperbolic curve group Hc(Z/pZ) is based on the order of a generated group to be generated from the base point. A simple example of generated groups of this kind will be now described. For simplicity explanation, it will be convenient to consider the quadratic-hyperbolic curve group Hc(Z/23Z) with p=23, a=7, b=2 and c=0 as an example. A set of elements satisfying the condition of the quadratic non-residue and of the quadratic-hyperbolic curve group Hc(Z/23Z) is comprised of the 12 points: P(21)=(21,9), P(1), P(14), P(11), P(16), P(15), P(8), P(7), P(12), P(9), P(22) and P(2). The points not satisfying the quadratic non-residue are P(0), P(3), P(4), P(5), P(6), P(10), P(13), P(17), P(18), P(19) and P(20). Let Q[x] denote a generated group obtained by using as a generator a point P(x) satisfying the condition of the quadratic non-residue. Then, the generated groups can be obtained as shown in FIG. 5.

FIG. 6 is a representation of an inclusion relation of the generated group Q[x] shown in FIG. 5. Let kₓ denote the order of the generated group Q[X]. Then, k₁=6, k₂=1, k₇=3, k₈=12, k₉=6, k₁₁=3, k₁₂=4, k₁₄=4, k₁₅=2, k₁₆=12, k₂₁=12 and k₂₂=12. Let φ(kₓ) denote the number of generated groups having the order kₓ (φ(kₓ): Euler's φ function). Then, φ(12)=4, φ(6)=2, φ(4)=2, φ(3)=2, φ(2)=1 and φ(1)=1. The above inclusion relation corresponds to one or more divisors of the order. As described above, the generated groups Q[8], Q[16], Q[21] and Q[22] are different only in the sequence in which elements as illustrated are arranged. These generated groups Q[8], Q[16], Q[21] and Q[22] are equivalent because they have the same order and consist of the same set of points. Hereinafter, such an equivalence relation is called “conjugate”. The generated groups Q[1] and Q[9] are conjugate to each other. The generated groups Q[12] and Q[14] are also conjugate to each other.

Assuming that the order k of the quadratic-hyperbolic curve group Hc(Z/pZ) is an odd prime number q, the generated group Q[x] constructed by using a point P(x) (εHc(Z/pZ)) other than the zero element as the base point has the order q (see Theorem T16), as will be described later. That is, since the order q of the generated group Q[x] is identical to the order k of the quadratic-hyperbolic curve group Hc(Z/pZ), the order k can be set to the odd prime number q, thus enabling the secure base point to be selected very easily.

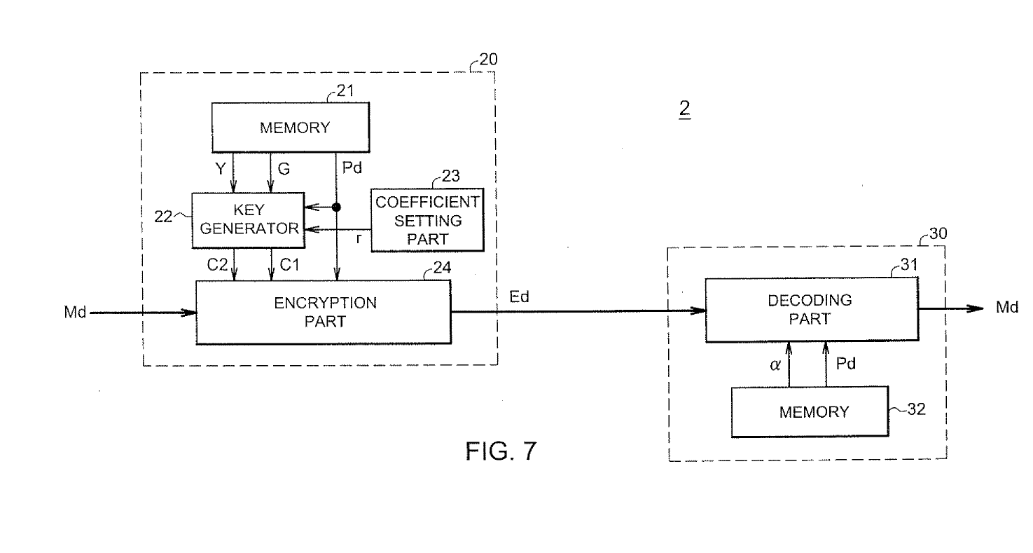

Next, a cryptographic system using the quadratic-hyperbolic curve group Hc(Rp) will now be described. FIG. 7 is a functional block diagram showing a schematic configuration of a cryptographic system 2. This cryptographic system 2 comprises: an encryption device 20 that is a key generation apparatus; and a decoding device 30. The encryption device 20 is capable of encrypting plain text data Md for each block of a predetermined bit length to generate cipher text data Ed. The decoding device 30 is capable of decoding the cipher text data Ed to reconstruct the plain text data Md.

All or part of the functions of the encryption device 20 and the decoding device 30 can be implemented by a circuit configuration of hardware, or a program or program code recorded on a recording medium such as a non-volatile memory or optical disk. Such program or program code causes a processor such as a CPU to perform all or part of the functions of the encryption device 20 and the decoding device 30.

As shown in FIG. 7, the encryption device 20 comprises a memory 21, a key generator 22, a coefficient setting part 23 and an encryption part 24. The memory 21 stores the public keys G and Y (=αG) generated by the key generation apparatus 1 of FIG. 1. The setting data Pd indicating parameters (i.e., curve parameters and the order p of the finite ring Rp) specifying the quadratic-hyperbolic curve Hc. The setting data Pd is supplied to the key generator 22 and the encryption part 24. The coefficient setting part 23 includes a random number generator (not shown) that generates a physical random number or pseudo-random number, and generates an integer value based on the generated physical random number or pseudo-random number. The coefficient setting part 23 sets the scalar coefficient r to the integer value (where 1<r<k; k is the order of the quadratic-hyperbolic curve group), and supplies the scalar coefficient r to the key generator 22.

The key generator 22 performs scalar multiplication of the public key Y by the scalar coefficient r by performing the addition operation defined for the quadratic-hyperbolic curve group Hc(Rp) on the public key G read from the memory 21, to generate a session key C1 (=rG). The key generator 22 further performs the scalar multiplication of the public key Y by the scalar coefficient r by performing the addition operation on the public key Y read from the memory 21, to generate a session key C2 (=rY). These session keys C1 and C2 are supplied to the encryption part 24. The key generator 22 can perform the addition operation by using the high-speed index calculation method described above.

The encryption part 24 divides the plain text data Md into blocks of the predetermined bit length, and associate each block with its corresponding point Pm that is an element of the quadratic-hyperbolic curve group Hc(Rp). The encryption part 24 generates the cipher text data Ed by performing the addition operation on the points Pm representing the plain text data Md by use of the session keys C1 and C2.

On the other hand, the decoding device 30 comprises a memory 32 and a decoding part 31. The memory 32 stores the secret key α generated by the key generation apparatus 1 of FIG. 1, and stores the data Pd which the memory 32 and the encryption device 20 have in common. The secret key α and the data Pd are supplied to the decoding part 31. The decoding part 31 converts the cipher text data Ed into the plain text data Md by performing the addition operation defined for the quadratic-hyperbolic curve group Hc(Rp) on the cipher text data Ed by use of the secret key α.

The security of a cryptographic algorithm used in the cryptographic system 2 can be based on the Discrete Logarithm Problem according to the above expression (3), no limitation thereto intended. In the case where the cryptographic system 2 employs ElGamal cryptographic algorithm, for example, the encryption part 24 generates pairs of two points (C2+Pm,C1) representing the cipher text data Ed. On reception of the cipher text data Ed, the decoding part 31 calculates a symmetric key Ys=αC1 using the secret key α. Then, the decoding part 31 calculates (C2+Pm)−Ys and provide the result as the decoded data Md. The session key C2 is used as the symmetric key. Since the session key C2 (=rY=(r·α)G) and the symmetric key Ys (=αC1=(r·α)G) are expected to indicate the same point, the equalities C2+(−Ys)=(−C2)+Ys=O are established (where O is the zero element of the quadratic-hyperbolic curve group). Hence, the equalities (C2+Pm)+(−Ys) (C2+(−Ys))+Pm=O+Pm=Pm holds.

Next, a digital signature system using the quadratic-hyperbolic curve group Hc(Rp) will now be described. In a transmission path of a digital communication network such as the Internet, a risk of falsification of transmit data exists. The digital signature system can be used as means for confirming the identification of a sender or the validity of received data. Only the apparatus having a secret key can generate a digital signature.

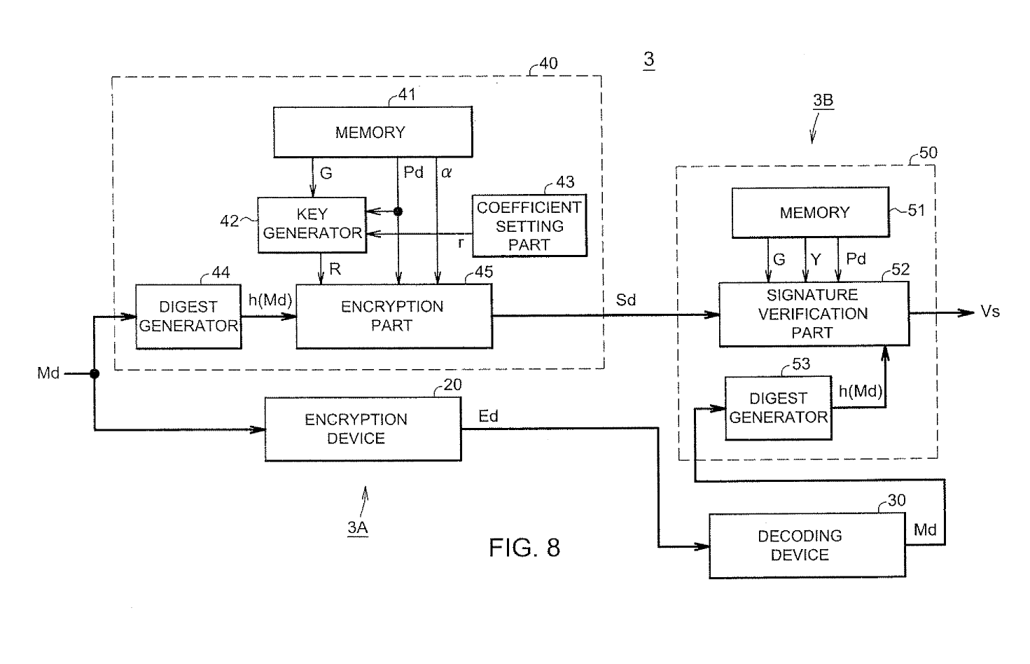

FIG. 8 is a block diagram showing a schematic configuration of a digital signature system 3. This digital signature system 3 comprises: a transmitting apparatus 3A that includes an encryption device 20 and a signature generation device 40 (i.e., a key generation apparatus); and a receiving apparatus 3B that includes a signature verification device 50 and a decoding device 30. The signature generation device 40 is capable of generating the digital signature data Sd by generating a bit sequence of a fixed bit length of about a few tens bytes as message digest data (hereinafter referred to as “digest data”) h(Md) on the basis of the plain text data Md, and encrypting the digest data h(Md) using the secret key α. The signature verification device 50 is capable of verifying the validity of the digital signature data Sd (i.e., whether or not the digital signature data Sd is generated for the plain text data Md using the valid secret key α) by use of the public key (i.e., a verification key) corresponding to the digital signature data Sd. If the digital signature data Sd or the plain text data Md is falsified on the transmission path, the signature verification device 50 can detect the falsification based on the verification result.

In this embodiment, the plain text data Md is encrypted by the encryption device 20 having the configuration as shown in FIG. 7, and then the encrypted data is sent via the transmission path to the decoding device 30. It will nevertheless be understood that the invention is not limited to the configuration as shown in FIG. 7. The plain text data Md can be encrypted by other cryptographic method, and then the encrypted data can be sent by the transmitting apparatus 3A to the receiver apparatus 3B. Alternatively, the plain text data Md can be sent to the receiver apparatus 3B without being encrypted. Further, the transmission path can be in a wide area network such as the Internet, or in a private communication line. The digital signature data Sd and the plain text data Md can be supplied to the receiving apparatus 3B via a recording medium without being transmitted via the transmission path.

As shown in FIG. 8, the signature generation device 40 comprises a memory 41, a key generator 42, a coefficient setting part 43, a digest generator 44 and an encryption part 45. The memory 41 stores the public key G generated by the key generation apparatus 1 of FIG. 1, the secret key α, and the setting data Pd indicating the parameters (i.e., curve parameters and the order p of the finite ring Rp) that specify the quadratic-hyperbolic curve Hc. The setting data Pd is supplied to the key generator 42 and the encryption part 45. The coefficient setting part 43, which includes a random number generator (not shown), generates an integer value based on a physical random number or pseudo-random number generated by the random number generator. The coefficient setting part 43 further sets a scalar coefficient r to the integer value (where 1<r<k; k is the order of the quadratic-hyperbolic curve group), and supplies the scalar coefficient r to the key generator 42.

The key generator 42 performs the scalar multiplication of the public key G by the scalar coefficient r by performing the addition operation defined for the quadratic-hyperbolic curve group Hc(Rp) on the public key G read from the memory 41, to generate a session key R (=rG). This session key R is provided to the encryption part 45.

The digest generator 44 generates digest data h(Md) based on the plain text data Md in accordance with a compression function that compresses the bit length of input data, and supplies the generated digest data h(Md) to the encryption part 45. The compression function is preferably a hash function that gives an output of fixed bit length for the plain text data Md input thereto.

The encryption part 45 encrypts the digest data h(Md) by performing the addition operation defined for the quadratic-hyperbolic curve group Hc(Rp) on the digest data h(Md) by use of the session key R and the secret key α to generate the digital signature data Sd. The security of the encryption algorithm used in the encryption part 45 can be based on the Discrete Logarithm Problem according to the expression (3), no limitation thereto intended. For example, the ElGamal cryptographic algorithm or its improved version can be employed.

In the case where the ElGamal cryptographic algorithm is employed, the encryption part 45 can generate, as the digital signature data Sd, a combination (R,s) consisting of the point R(=rG) on the quadratic-hyperbolic curve Hc and a scalar quantity s given by the following congruent expression:

s≡(h−α√[R]ₓ)·r⁻¹(mod q),

where h is the value of digest data h(Md), [R]ₓ is the x-coordinate value of the point R, and q is the order of the generated group Q[x] to be generated by the base point G(x).

On the other hand, the signature verification device 50 includes a memory 51 and a signature verification part 52. The memory 51 stores setting data Pd and public keys G and Y shared with the signature generation device 40. The setting data Pd is supplied to the key generator 42 and the encryption part 45. The digest generator 53 generates digest data h(Md) by compressing plain text data Md supplied from the decoding device 30 in accordance with the same compression function as used in the digest generator 44 of the signature generation device 40.

The signature verification part 52 performs the addition operation defined for the quadratic-hyperbolic curve group Hc(Rp) on the digital signature data Sd by use of the public keys G and Y read from the memory 51, to generate verification data. The signature verification part 52 further makes a determination as to whether or not the verification data is matched with the digest data (Md), and outputs determination data Vs indicating the determination result. If the value of the determination data Vs is “0”, it is determined that the plain text data Md or digital signature data Sd has not been falsified. If the value of the determination data Vs is “1”, it is determined that the plain text data Md or digital signature data Sd has been falsified.

In the case where the digital signature system 3 employs the ElGamal cryptographic algorithm, the signature verification part 52 generates a point Pv indicating the verification data in accordance with the following expression:

Pv=sR+[R]ₓY.

Further, the signature verification part 52 performs the addition operation on the public key G using the digest data H(Md) to generate a point Pn=h·G. Then, the signature verification part 52 makes a determination as to whether or not the point Pn is identical to the point Pv, and gives determination data Vs indicating the determination result or the verification result. If the plain data Md or the digital signature data Sd has not been falsified on the transmission path, the point Pn should be identical to the point Pv.

All or part of the functions of the signature generation device 40 and the signature verification device 50 can be implemented by a circuit configuration of hardware, or a program or program code recorded on a recording medium such as a non-volatile memory or optical disk. Such program or program code causes a processor such as a CPU to perform all or part of the functions of the signature generation device 40 and the signature verification device 50.

As described above, the use of the quadratic-hyperbolic curve group Hc(Rp) (or its equivalent group Hg(Rp)) enables the encryption of plain text data, decoding of cipher text data, generation of a digital signature, and verification for the validity of the digital signature. The cryptographic technology using the quadratic-hyperbolic curve group Hc(Rp) (or its equivalent group Hc(Rp)) enables the computational difficulty equivalent to that of breaking the elliptic curve cryptography. Additionally, the quadratic-hyperbolic curve group Hc(Rp) (or its equivalent group Hg(Rp)) can be applied to a key exchange algorithm such as Diffe-Hellman public key exchange algorithm.

Since the above expression (6) states that the order k of the quadratic-hyperbolic curve group Hc(Z/pZ) (or its equivalent group Hg(Z/pZ)) does not depend on the curve parameters, the order k can be calculated in an extremely short time even if the curve parameters are changed. When a new type of attack against cryptography using the quadratic-hyperbolic curve group Hc(Z/pZ) (or its equivalent group Hg(Z/pZ)) is found, a secure quadratic-hyperbolic curve group can be obtained in a short time by changing the curve parameters. Accordingly, a currently used cryptographic system can be rapidly changed to the secure cryptographic system.

Additionally, in a quantum-cryptographic communication system, the cryptographic system using the quadratic-hyperbolic curve group is capable of simply supplying a quantum key (i.e., a secret key) shared between the sending side and the receiving side.

2. Structure of the Quadratic-hyperbolic Curve Group

A rigorously mathematical explanation for the structure of the quadratic-hyperbolic curve group will now be provided. As described above, the quadratic-hyperbolic curve Hc defined over the residue class ring Z/pZ is represented by the following expression:

$$Hc \text{:} y ≡ \frac{1}{{x}^{2} + cx - a} \cdot ( x - b ) ( mod p ) . \qquad ( 2 a )$$

For satisfying the condition x²+cx−a≠0, it suffices that the discriminant D=c²+4a is a quadratic non-residue modulo p.

For any point (X,Y) on the straight line L_{PQ} connecting the two points P(x₁,y₁) and Q(x₂,y₂) that have different coordinates on the quadratic-hyperbolic curve Hc, the linear equation Y=m₁₂X+B₁₂ holds.

The gradient m₁₂ and the intercept B₁₂ are given by the following expressions (10a) and (10b):

$$\begin{matrix}{m}_{12} = ( - 1 ) \frac{{x}_{1} {x}_{2} - b ( {x}_{1} + {x}_{2} + c ) + a}{( {x}_{1}^{2} + {cx}_{1} - a ) ( {x}_{2}^{2} + {cx}_{2} - a )} , & ( 10 a ) \\ {B}_{12} = \frac{\begin{matrix}{x}_{1} {x}_{2} ( {x}_{1} + {x}_{2} ) - b ( {x}_{1 }^{2} + {x}_{2}^{2} + {x}_{1} {x}_{2} ) + \\ c ( {x}_{1} {x}_{2} - b ( {x}_{1} + {x}_{2} ) ) + ab\end{matrix}}{( {x}_{1}^{2} + {cx}_{1} - a ) ( {x}_{2}^{2} + {cx}_{2} - a )} . & ( 10 b )\end{matrix}$$

The coordinate value x₁₂ of an intersection point S(x₁₂,y₁₂) of the quadratic-hyperbolic curve Hc with the straight line L_{PQ} is given by the following expression (11):

$${x}_{12} = b + \frac{( b ( b + c ) - a ) ( {x}_{1} + {x}_{2} + c )}{{x}_{1} {x}_{2} - b ( {x}_{1} + {x}_{2} + c ) + a} . \qquad ( 11 )$$

When a fixed point O(b,0) is determined, the coordinate value x₃ of an intersection point R(x₃,y₃) of the quadratic-hyperbolic curve Hc with a straight line L_{SO} connecting the intersection point S and the fixed point O is given by the following expression (4) as described above:

$${x}_{3} = - ( b + c ) - \frac{( b ( b + c ) - a ) ( {x}_{1} + {x}_{2} + c )}{{x}_{1} {x}_{2} - b ( {x}_{1} + {x}_{2} + c ) + a} . \qquad ( 4 )$$

The above expression (4) holds in both the cases where P≠Q and P=Q. Let the symbol “+” denote the addition operation defined for the quadratic-hyperbolic curve group Hc(Z/pZ). Then, as a relationship among the three points P, Q and R, the following expression (12) holds:

R=P+Q=Q+P. (12)

Let S denote a point representing a scalar-multiplication of the point P on the quadratic-hyperbolic curve Hc by n (where n is a scalar coefficient of a positive integer). The point S is obtained by performing the addition operation on the point P as shown in the following expression (13):

S=P+ . . . +P=nP. (13)

According to the expression (4a) described above, the equality O(b,0)+P(x₁,y₁)=P(x₁,y₁) holds. When the equality P+Q=O (O: a fixed point) holds for the points P(x₁,y₁) and Q(x₂,y₂) on the quadratic-hyperbolic curve Hc, the coordinate value x₃ of the expression (4a) is equal to the value b (i.e., x₃=b). Thus, the x-coordinate value <x₁> of the point Q is given by the following expression (5):

$$< {x}_{1} >= \frac{{ex}_{1} + ( ec - a )}{{x}_{1} - e} , \\ where \\ {x}_{1} - e \neq 0 , e = \frac{{b}^{2 } + a}{2 b + c} . \qquad ( 5 )$$

Hence, the fixed point O(b,0) can be a zero element of the group constructed from the quadratic-hyperbolic curve Hc with respect to the addition operation. Further, the point Q having the x-coordinate value given by the above expression (5) is an inverse element −P for the point P. Thus, the equality P+(−P)=O holds.

In order to prepare for proving associative law regarding the addition operation, the following Theorem T1 will be proven.

### Theorem T1:

For any integer points P(x₁,y₁), Q(x₂,y₂) and R(x₃,y₃) on the quadratic-hyperbolic curve Hc, the following equality (14) holds with respect to the addition operation defined for the quadratic-hyperbolic curve group Hc(Z/pZ):

((−P)+Q)+(P+R)=Q+R. (14)

### (Proof of Theorem T1)

Suppose that [R]ₓ denotes the x-coordinate value of any integer point R on the quadratic-hyperbolic curve Hc. For the integer points P, Q and R, the following expressions (14a), (14b) and (14c) can be derived:

$$\begin{matrix}\begin{matrix}{X}_{1} := {[ ( - P ) + Q ]}_{x} = - \frac{( b + c ) < {x}_{1} > {x}_{2} - a ( < {x}_{1} > + {x}_{2} ) + ab}{< {x}_{1} > {x}_{2} - b ( < {x}_{1} > + {x}_{2} + c ) + a} \\ = - \frac{{bx}_{1} {x}_{2} + ( bc - a ) {x}_{2} + {ax}_{1} - ab}{- {x}_{1} {x}_{2} + {bx}_{2} - ( b + c ) {x}_{1} + a} ,\end{matrix} & ( 14 a ) \\ where < {x}_{1} >= \frac{{ex}_{1} + ( ec - a )}{{x}_{1} - e} , \\ and e = \frac{{b}^{2} + a}{2 b + c} , & ( 14 b ) \\ {X}_{2} := {[ P + R ]}_{x} = - \frac{( b + c ) {x}_{1} {x}_{3} - a ( {x}_{1} + {x}_{3} ) + ab}{{x}_{1} {x}_{3} - b ( {x}_{1} + {x}_{3} + c ) + a} . & ( 14 c )\end{matrix}$$

Then, the following expression (14d) can be derived:

$$\begin{matrix}W = {X}_{1} {X}_{2} - b ( {X}_{1} + {X}_{2} + c ) + a \\ = \frac{\{ b ( b + c ) - a \} \{ \begin{matrix}( {x}_{1}^{2} + {cx}_{1} - a ) \\ ( {x}_{2} {x}_{3} - b ( {x}_{2} + {x}_{3} + c ) + a )\end{matrix} \}}{( - {x}_{1} {x}_{2} + {bx}_{2} - ( b + c ) {x}_{1} + a ) ( {x}_{1} {x}_{3} - b ( {x}_{1} + {x}_{3} + c ) + a )} .\end{matrix} \qquad ( 14 d )$$

By using the expression (14d), the following expression (14e) can be derived:

$$\frac{{X}_{1} + {X}_{2} + c}{{X}_{1} {X}_{2} - b ( {X}_{1} + {X}_{2} + c ) + a} = \frac{{x}_{2} + {x}_{3} + c}{{x}_{2} {x}_{3} - b ( {x}_{2} + {x}_{3} + c ) + a} . \qquad ( 14 e )$$

By using the expression (4), the above equality (14) can be derived accordingly. (Q.E.D.)

Theorem T1 states that the equality (−P+Q)+P=Q holds when R=O (O: the zero element), and that the quadratic-hyperbolic curve group Hc(Z/pZ) is isomorphic to its normal subgroup. The use of Theorem T1 enables a proof of the following Theorem T2 (i.e., associative law).

### Theorem T2 (Associative Law):

For any integer points P, R and S on the quadratic-hyperbolic curve Hc, the following equality (15) holds in the addition operation defined for the quadratic-hyperbolic curve group Hc(Z/pZ):

S+(P+R)=(S+P)+R. (15)

### (Proof of Theorem T2)

According to Theorem T1, putting R=O (O: the zero element), one can rewrite the above expression (14) into the equality ((−P)+Q)+P=Q (hereinafter referred to as the expression (15a)). Putting S=(−P)+Q, one can convert the expression (15a) into the equalities S+P=((−P)+Q)+P=Q. When one adds the point R to both sides of the converted expression, the equality (S+P)+R=Q+R (hereinafter referred to as the expression (i5b)) can be derived. On the other hand, putting S=(−P)+Q, one can convert the expression (14) into the equality S+(P+R)=Q+R (hereinafter referred to as the expression (15c)). Since the right side of this expression (15c) is equal to the right side of the expression (15b), the equality S+(P+R)=(S+P)+R holds. Since the point S can be an independent integer point Q, the point S is also any integer point on the quadratic-hyperbolic curve Hc. The expression (15) holds accordingly. (Q.E.D.)

Next, the “problem of an equivalent pair” will now be described. When two points P(x₁,y₁) and Q(x₂,y₂) have the same y-coordinate value (i.e., y₁=y₂), the gradient of the straight line connecting these two points P and Q is zero. Then, since the gradient m₁₂ as indicated in the expression (10a) is zero, the following equality (16) holds, thus causing the denominator of the above fractional expression (4) to be zero:

x₁x₂−b(x₁+x₂+c)+α=0. (16)

Hence, the x-coordinate value x₃ of the point P+Q is indefinite when the following equality (17) holds:

x₁x₂−b(x₁+x₂+c)+α≡0 (mod p). (17)

In this case, since the inverse element for “0” does not exist in the residue class ring Z/pZ, the two points P(x₁,y₁) and Q(x₂,y₂) which have the same y-coordinate value can not be added in accordance with the addition operation defined for the quadratic-hyperbolic curve group Hc(Z/pZ). This is the problem of an equivalent pair. If the two points Q(x₂,y₂) and R (x₃, y₃) on the quadratic-hyperbolic curve Hc defined over the residue class ring (Z/pZ) constitute an equivalent pair, the following expression (17a) holds:

x₂x₃−b(x₂+x₃+c)+α≡0 (mod p). (17a)

Then, since the right side of the expression (14d) is zero, one can derive the following expression (17b) from the expression (14d):

X₁X₂−b(X₁+X₂+c)+α≡0 (mod p). (17b)

According to the Theorem T1, the expression (17b) states that the points (−P)+Q and P+R constitute an equivalent pair. Accordingly, the following Theorem T3 holds.

### Theorem T3:

For three points P, Q and R that are elements of the quadratic-hyperbolic curve group Hc(Z/pZ), if the two points Q and R constitute an equivalent pair, the points (−P)+Q and P+R constitute an equivalent pair. (End of Theorem T3)

Theorem T3 states that, if the two points Q and R constitute an equivalent pair, the points (−mP)+Q and mP+R obviously constitute an equivalent pair for any scalar coefficient m. Accordingly, a plurality of equivalent pairs as shown in FIG. 3 is generated around the center elements.

The use of Theorem T3 enables a proof of the following Theorem T4.

### Theorem T4:

The condition allowing the points R=P+Q and Q on the quadratic-hyperbolic curve Hc defined over the residue class ring Z/pZ to be an equivalent pair and center elements is that the following congruent expression (18) has an integer solution x for the point P(x₁,y₁):

x²≡x₁²+cx₁−α (mod p). (18)

Namely, the condition is that the right side of the congruent expression (18) is a quadratic residue modulo p.

### (Proof of Theorem T4)

If R(x₃,y₃)=P(x₁,y₁)+Q(x₂,y₂), like the relational expression (17a), the following expression (18a) holds between the coordinate value X₃ of the point R and the coordinate value x₂ of the point Q:

x₂x₃−b(x₂+x₃+c)+α≡0 (mod p). (18a)

By using the expression (18a), one can obtain the following expression (18b):

$${x}_{3} = \frac{{bx}_{2} + ( bc - a )}{{x}_{2} - b} . \qquad ( 18 b )$$

On the other hand, since the relational expression (4) holds with respect to the coordinate values x₃, x₂ and x₁ of the three points R, P and Q, one can obtain the following expression (18c) based on the expressions (4) and (18b):

$$\frac{{bx}_{2} + ( bc - a )}{{x}_{2} - b} = - \frac{( b + c ) {x}_{1} {x}_{2} - a ( {x}_{1} + {x}_{2} ) + ab}{{x}_{1} {x}_{2} - b ( {x}_{1} + {x}_{2} + c ) + a} . \qquad ( 18 c )$$

The x-coordinate value of the inverse element −P for the point P (x₁) is given by the expression (5). Let <x₁> denote the x-coordinate value of the inverse element −P. Then, one can rewrite the expression (18c) into the following quadratic equation (18d) with respect to x₂:

x₂²−2<x₁>x₂+((−c)<x₁>+α)=0. (18d)

Let D denote the discriminant of the quadratic equation (18d). In order that the quadratic equation (18d) has the integer solution x₂, it is required that D/4=<x₁>²+c<x₁>−a is a quadratic residue. Accordingly, the condition allowing the existence of an equivalent pair of the points Q and R constituting center elements is that D/4 is a quadratic residue. Conversely, if the discriminant D is a quadratic non-residue, the points Q and R does not constitute an equivalent pair. This condition also holds even if the coordinate values <x₁> and x₁ are interchanged with each other in the discriminant D, because the coordinate values <x₁> and x₁ are symmetric. Namely, the following expression (18e) holds:

$$D / 4 = < {x}_{1} {>}^{2} + c < {x}_{1} > - a = \frac{{( e - b )}^{2} ( {x}_{1}^{2} + {cx}_{1} - a )}{{( {x}_{1} - e )}^{2}} . \qquad ( 18 e )$$

Thus, the condition allowing the existence of an equivalent pair of the points Q and R constituting center elements is that x₁²+cx₁−a is a quadratic residue. Conversely, if x₁²+cx₁−a is a quadratic non-residue, the problem of an equivalent pair does not arise. (Q.E.D.)

### Theorem T5:

Let HC={P(x)|xεZ/pZ, x²+cx−a≠0 and (x²+cx−a) is a quadratic non-residue modulo p} be a set of points on the quadratic-hyperbolic curve Hc defined over the residue class ring Z/pZ. The set Hc is closed under the addition operation.

### (Proof of Theorem T5)

When the two points P(x₁) and Q(x₂) on the quadratic-hyperbolic curve Hc are added to obtain the point R(x₃), the expression (4) holds. Hence, the following expression (19) is derived using the expression (4):

$$\begin{matrix}{x}_{3}^{2} + {cx}_{3} - a = {( - \frac{( b + c ) {x}_{1} {x}_{2} - a ( {x}_{1} + {x}_{2} ) + ab}{{x}_{1} {x}_{2} - b ( {x}_{1} + {x}_{2} + c ) + a} )}^{2} + \\ ( - \frac{( b + c ) {x}_{1} {x}_{2} - a ( {x}_{1} + {x}_{2} ) + ab}{{x}_{1} {x}_{2} - b ( {x}_{1} + {x}_{2} + c ) + a} ) - a \\ = \frac{( b ( b + c ) - a ) ( {x}_{1}^{2} + {cx}_{1} - a ) ( {x}_{2}^{2} + {cx}_{2} - a )}{{( {x}_{1} {x}_{2} - b ( {x}_{1} + {x}_{2} + c ) + a )}^{2}} .\end{matrix} \qquad ( 19 )$$

As defined above, since the two factors (x₁²+cx₁−a) and (x₂²+cx₂−a) on the right side of the expression (19) are quadratic non-residues modulo p, the factor (b(b+c)−a) on the right side of the expression (19) must be a quadratic non-residue in order that the factor (x₃²+cx₃−a) on the left side of the expression (19) is a quadratic non-residue modulo p. On the other hand, the point P(x=b) is the zero element. Accordingly, the factor (b(b+c)−a) necessarily becomes a quadratic non-residue when the factors (x₁²+cx₁−a) and (x₂²+cx₂−a) are quadratic non-residues. (Q.E.D.)

As described above, the point for which the denominator on the right side of the expression (5) becomes zero. Namely, the inverse element for the prime element H does not exist. For the prime element H(x=e), it will be easily confirmed that x²+cx−a is a quadratic residue modulo p. Hence, the prime element H is not included in the quadratic-hyperbolic curve group Hc(Z/pZ) in accordance with Theorem T5.

Hereinafter, it is assumed that the quadratic-hyperbolic curve group Hc(Z/pZ) is the set HC defined by Theorem T5. First of all, several theorems will be proven prior to derivation of the order of the quadratic-hyperbolic curve group Hc(Z/pZ).

### Theorem T6:

The number of integers x (x≠0) that are quadratic non-residues modulo an odd prime number p is (p−1)/2.

### (Proof of Theorem T6)

The set A={1, 2, . . . , p−2, p−1} and the finite cyclic group B={t⁰, t¹, . . . , t^{p-2}} having the order of p−1 are introduced. The finite cyclic group B is a set of nonnegative powers of a generator t. We assume a one-to-one correspondence between the elements of the set A and the elements of the set B. Euler's criterion states that x^{(p-1)/2}≡−1 (mod p) for x being a quadratic non-residue, and that x^{(p-1)/2}≡+1 (mod p) for x being a quadratic residue

Putting x=t^{m} (t^{m}εB and xεA) for an even number m, one can derive the following expression (20a) by using Fermat's Little Theorem:

$${x}^{\frac{p - 1}{2}} = {( {t}^{m} )}^{\frac{p - 1}{2}} = {( {t}^{\frac{m}{2}} )}^{p - 1} ≡ ( mod p ) . \qquad ( 20 a )$$

Thus, the integers x are quadratic residues. On the other hand, putting x=t^{m} for the odd number m, one can derive the following expression (20b):

$${x}^{\frac{p - 1}{2}} = {( {t}^{m - 1 + 1} )}^{\frac{p - 1}{2}} = {( {t}^{\frac{m - 1}{2}} \cdot {t}^{\frac{1}{2}} )}^{p - 1} ≡ {t}^{\frac{p - 1}{2}} ( mod p ) . \qquad ( 20 b )$$

If it is assumed that t^{(p-1)/2}≡1 for the generator t, the order of the finite cyclic group B is (p−1), which contradicts the definition such that the order is p−1. Accordingly, t^{(p-1)/2}≡−1, and the integers x are quadratic non-residues if m is the odd number. As a result, the number of the integers x that are quadratic non-residues is (p−1)/2. The number of the integers x that are quadratic residues is also (p−1)/2. (Q.E.D.)

A proof of Euler's criterion based on the lecture on Number Theory given by Dirichlet is described on pages 70-71 of the document: Teiji Takagi, “Elementary Lectures on Number Theory (second edition)”, Kyoritsu Shuppan, ISBN: 4-320-01001-9. The following Theorem T7 can be derived based on the description.

### Theorem T7:

If an integer a is indivisible by p, for any integer r of the set A={1, 2, . . . , p−2, p−1}, there exists only one integer s satisfying rs≡a (mod p) as one element of the set A. The integer s is referred to as the “mate” of r. The mate of is r. There exists only one pair of mates comprised of the same numbers. Accordingly, there exist (p−1)/2 pairs of mates in principle. When the value “a” is a quadratic residue, there are two cases: 1) the mate s of r is equal to r; and 2) the mate s of p−r is equal to p−r. If these two cases are excluded as the exception, there exist (p−3)/2 pairs of mates.

### (Proof of Theorem T7)

We introduce the finite cyclic group B={t⁰, t¹, . . . , t^{p-2}} that is a set of the integer powers of a generator t. We assume a one-to-one correspondence between the elements of the set A and the elements of the set B. Putting a=t^{h} (t^{h}εB), one can derive a=t^{k}t^{h}t^{-k} (where k is an integer). Putting r=t^{k} and S=t^{h-k}, one can derive a≡rs (mod p). Then, since the equality r/s=t^{2k-h} holds, r=s if 2k−h=0. Accordingly, the mates r and s are equal to each other only if h is an even number. Conversely, the relation r≠s (mod p) always holds if h is an odd number. Then, the number of pairs of the mates r and s is (p−1)/2. This means that the number of pairs of the mates is (p−1)/2 if a is a quadratic non-residue.

If h is the even number, as described above, r=t^{h/2} and s=t^{h-h/2}=t^{h/2} since 2k−h=0. Then, r=s. Since the relation (t^{(p-1)/2}≡1 (mod p) holds for the generator t in accordance with Fermat's Little Theorem, putting r′=t^{(p-1)/2+h/2} and s′=t^{(p-1)/2+h/2}, one can derive r′=s′ and r′s′≡a (mod p). In the process of showing a proof of Theorem T6, t^{(p-1)/2}≡−1 (mod p) is demonstrated. Hence, for the mates r′ and s′, r′≡−r≡p−r and r′≡s′≡p−r. Accordingly, the (p−3)/2 mates can be configured for p−3 integers obtained by excluding two integers for which the values of mates are equal to each other. In this case, the relation r≠s (mod p) is satisfied. This means that, when the value “a” is a quadratic residue, the number of pairs of the mates is (p−3)/2 which is obtained by excluding two integers for which the values of mates are equal to each other. (Q.E.D.)

### Theorem T8:

Let the number of coordinate values x (hereinafter referred to as the “quadratic non-residue number”) satisfy the condition that “the factor x²+cx-a is a quadratic non-residue modulo p” for the quadratic-hyperbolic curve Hc. Then, the quadratic non-residue number is Nq=(p−1)/2 if the discriminant D=c²+4a (≠0) is a quadratic residue modulo p. The quadratic non-residue number is Nn=(p+1)/2 if the discriminant D is quadratic non-residue modulo p. These quadratic non-residue numbers Nn and Nq do not depend on the type of the odd prime number p.

### (Proof of Theorem T8)

If the factor x²+cx−a is a quadratic residue modulo p, there exists an integer solution z satisfying the congruent expression z²≡x²+cx−a (mod p). Then, the following expression (21a) can be derived:

$$( x + \frac{c}{2} - z ) ( x + \frac{c}{2} + z ) ≡ a + \frac{{c}^{2}}{4} = \frac{D}{4} ( mod p ) . \qquad ( 21 a )$$

Here, if x′ and a′ are set such that x′=x+c·2⁻¹ and a′=a+c²·4⁻¹=D·4⁻¹, the following expression (21b) can be derived based on the expression (21a):

(x′−z)(x′+z)≡α′ (mod p). (21b)

By Theorem T7, x′−z and x′+z can be mates of each other with respect to a′ (=D·4⁻¹). This is because they are different from each other, and in a one-to-one correspondence with each other. In accordance with Theorem T7, the number of pairs of the mates x′−z and x′+z is (p−1)/2. Only the value of x corresponding to pairs of the mates x′−z and x′+z satisfies the condition that the “factor x²+cx−a is a quadratic residue modulo p”.

Hence, the number of coordinate values x satisfying the condition that the “factor x²+cx−a is a quadratic residue modulo p” is Kn=(p−1)/2 if the discriminant D is quadratic non-residue, or Kq=(p+1)/2 if the discriminant D is a quadratic residue. Incidentally, if the discriminant D≡0 (mod p) even though the discriminant D is a quadratic residue, the condition that the “factor x²+cx−a is a quadratic residue modulo p” is satisfied for all x, as will be apparent from the property of the discriminant.

The number of coordinate values x can have p numbers under the residue modulo p. Therefore, the number of coordinate values x satisfying the condition that the “factor x²+cx−a is quadratic non-residue modulo p, viz., the quadratic non-residue number, is Nn=p−Kn=(p+1)/2 if the discriminant D is quadratic non-residue, or Nq=p−Kq=(p−1)/2 if the discriminant D is a quadratic residue. (Q.E.D.)

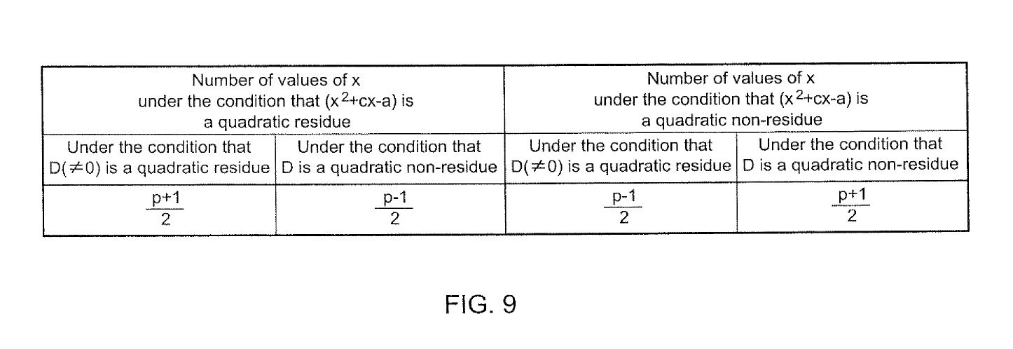

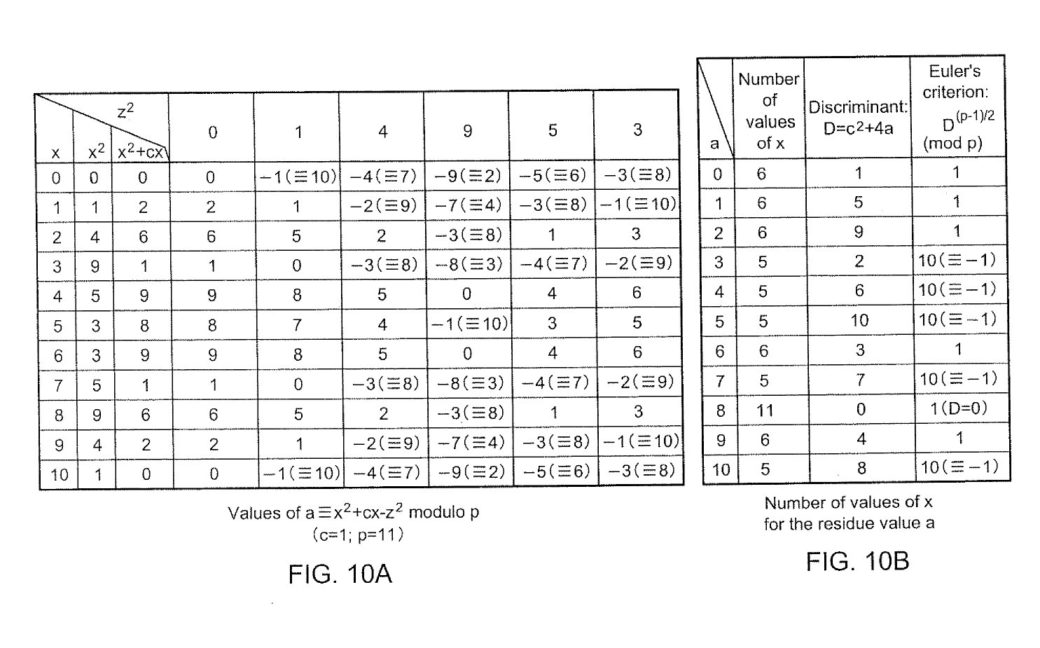

A table of FIG. 9 summarizes the proof results of the Theorem T8. FIGS. 10A and 10B show exemplary simple computation examples regarding Theorem T8. FIG. 10A shows the residue value a equal to x²+cx−z² (c=1) modulo p=11 (=4 m+3) for given coordinate values of x and z². FIG. 10B shows the numbers of the coordinate values x satisfying the condition that a≡x²+cx−z² (mod p) for given values of a. For example, the residue value for the point (x, z²)=(3,5) is a=7 as shown in FIG. 10A. As shown in FIG. 10B, when the value of a=7 corresponding to the point (3,5) is given, the residue value of the discriminant D is 7 and is a quadratic non-residue. Then, the number of values of x should be (11−1)/2=5 according to Theorem T8. Likewise, the residue value for the point (x, z²)=(8,4) is a=2 as shown in FIG. 10A. As shown in FIG. 10B, when the value of a=2 is given, the residue value of the discriminant D is 9 and is a quadratic residue. Then, the number of values of x should be (11+1)/2=6 according to Theorem T8.

FIG. 10B shows the computation result of residues of D^{(p-1)/2}. This computation result conforms to the Euler's criterion stating that the residue of D^{(p-1)/2} is “1” if the discriminant D is a quadratic residue, and that the residue of D^{(p-1)/2} is “−1” if the discriminant D is quadratic non-residue.

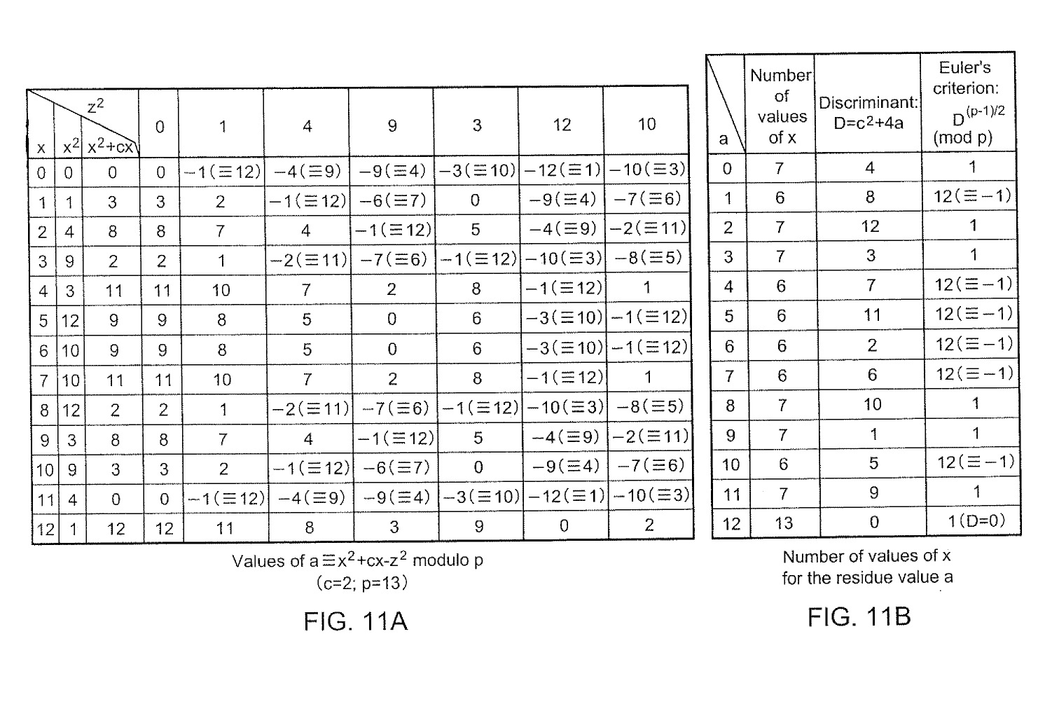

Furthermore, FIGS. 11A and 11B show another example of computation examples regarding Theorem T8. FIG. 11A shows the residue value a equal to x²+cx−z² (c=2) modulo p=13 (=4 m+1) for given coordinate values of x and z². FIG. 11B shows the number of the coordinate values x satisfying the condition that a≡x²+cx−z² (mod p) for given values of a.

In order to prepare for determining the order k of the quadratic-hyperbolic curve group Hc(Z/pZ), the following lemma L1 is given.

### Lemma L1:

Let the factor x₁²+cx₁−a be a quadratic residue module p for a point P(x₁) on the quadratic-hyperbolic curve Hc. Then, the factor x₂²+cx₂−a is a quadratic non-residue module p for a point Q(x₂) constituting an equivalent pair with the point P(x₁).

### (Proof of Lemma L1)

When the congruent expression (17) holds, the two points P and Q on the quadratic-hyperbolic curve Hc constitute an equivalent pair. By using the expression (17), The following expression (22) can be derived:

$${x}_{2}^{2} + {cx}_{2} - a ≡ \frac{( b ( b + c ) - a ) ( {x}_{1}^{2} + {cx}_{1} - a )}{{( {x}_{1} - b )}^{2}} ( mod p ) . \qquad ( 22 )$$

The point of x=b on the quadratic-hyperbolic curve Hc is the zero element. The factor (b(b+c)−a) on the right side of the expression (22) is always a quadratic non-residue modulo p. Accordingly, when the factor x₁²+cx₁−a is a quadratic residue, the factor x₂²+cx₂−a is a quadratic non-residue, and vice versa. (Q.E.D.)

### Theorem T9:

The order k of the quadratic-hyperbolic curve group Hc(Z/pZ) does not depend on the type of the odd prime number p, and the order k is given by the following expression (6):

$$k = \frac{p - 1}{2} + 1. \qquad ( 6 )$$

### (Proof of Theorem T9)

According to Theorem T8, the number of coordinate values x satisfying the condition that the factor x²+cx−a is a quadratic non-residue is (p−1)/2 if the discriminant D=c²+4a (≠0) is a quadratic residue, or (p+1)/2 if the discriminant D is a quadratic non-residue. Here, the condition “the factor x²+cx−a is quadratic non-residue” does not directly restrict values of the parameters a and c. Nonetheless, if the discriminant D for x²+cx−a=(x+c/2)²−D/4 is a quadratic non-residue, x²+cx−a≠0 (mod p). Thus, the condition “the discriminant D is a quadratic non-residue” is included in the condition “the factor x²+cx−a is a quadratic non-residue”. Owing to the form of D/4≠(x+c/2)², the discriminant D does not become a quadratic residue for any x value. Accordingly, the condition “the discriminant D is a quadratic residue” is not satisfied. The condition “the discriminant D is a quadratic non-residue” is only satisfied. Thus, the number of different integer points x on the quadratic-hyperbolic curve group Hc(Z/pZ) is k=(p+1)/2=(p−1)/2+1.

For y=f(x) at points (x,y) on the quadratic-hyperbolic curve Hc, it is easily proven that f(x₁)−f(x₂) is proportional to Δ=x₁x₂−b(x₁+x₂+c)+a for two different points P(x1) and Q(x2) on the quadratic-hyperbolic curve Hc. Hence, when x₁≠x₂, f(x₁)=f(x₂) holds only if Δ=0. This is the case where the two points P and Q constitute an equivalent pair. According to property of a quadratic function, only one equivalent pair exists. Three or more different x-coordinate values do not exist for one function value of f(x). By Lemma L1, one point of an equivalent pair is excluded from the quadratic hyperbolic curve group Hc(Z/pZ). Therefore, the two points P(x₁) and Q(x₂) that are elements of the quadratic-hyperbolic curve group Hc(Z/pZ) have different x-coordinate values, when x₁≠x₂. Accordingly, the quadratic-hyperbolic curve group Hc(Z/pZ) have k elements. (Q.E.D.)

According to Theorem T9, the order k of the quadratic-hyperbolic curve group Hc(Z/pZ) according to the present invention can be explicitly expressed independently of the parameters of the quadratic-hyperbolic curve Hc, and can be easily treated. Therefore, the order k can be calculated quite easily even if the curve parameters are changed. It is most practical to set the order k to a prime number q in the cryptographic system that uses the quadratic-hyperbolic curve Hc, as will be described later. In this case, it is important that there are an enormous number of combinations (p,q) of prime numbers satisfying the expression (6), and especially that, when the prime number p is a large number, the combinations can be freely selected. This is because the quadratic-hyperbolic curve group Hc(Rp) would have a low utility value if the number of such combinations was small. However, since many combinations of prime numbers satisfying the expression (6) can be found in already existing tables of prime numbers, it is expected that there are sufficiently many combinations of (p,q) satisfying the expression (6) when the prime number p is a large number.

As described above, the set HC of points P(x) on the quadratic-hyperbolic curve Hc defined over the residue class ring Z/pZ holds if the factor (x²+cx−a) is a quadratic non-residue modulo p. On the other hand, the point set HCn={P(x)|xεZ/pZ, x²+cx−a≠0, and (x²+cx−a) is a quadratic residue modulo p} will be described. Since the point P(x) belonging to the set HCn satisfies the condition such that the factor x²+cx−a≠0, the expression (4) defining a group operation and the expression (14) regarding the associative law directly hold for the points P(x) belonging to the set Hcn. Nonetheless, with respect to the expression (19) indicating that the group operation is closed, the group operation is closed only if the factors (x₁²+cx₁−a) and (x₂²+cx₂−a) are quadratic residues, and further if the factor (b(b+c)−a) corresponding to the zero element is a quadratic residue. Then, regarding a zero element, the group structure is different between the set HC and the set HCn. Since the common factor (b(b+c)−a) relating to both the set HC and the set HCn can be determined to be either a quadratic residue or a quadratic non-residue, the group structure is different between the sets even if using the same computational expressions.

Regarding the order of the set HCn, since the discriminant D of the quadratic equation is not a quadratic residue for any x value by Theorem T8, x²+cx−a≠0 (mod p) and the form of D/4≠(x+c/2)², the set HCn has Kn=(p−1)/2 different x values. Nonetheless, this fact does not unconditionally show the order of the set HCn, because a one-to-one correspondence between the x values and P(x) is not confirmed.

In reconsidering the “problem of an equivalent pair”, when the factor (b(b+c)−a) in the expression (22) is a quadratic residue, both elements of an equivalent pair can belong to the set HCn. Then, the “problem of an equivalent pair” remains, so that the defined group operation cannot be performed in some cases. Accordingly, the set HCn cannot satisfy the requirement of a mathematical group under the group operation.

Further, the prime element H will be described. The following expression (5a) can be derived based on the expression (5a):

$${e}^{2} + ce - a = {( \frac{b ( b + c ) - a}{2 b + c} )}^{2} . \qquad ( 5 a )$$

Accordingly, when x=e, the prime element H is also an element of the set HCn. Nonetheless, the prime element H does not have an inverse element. The set HCn does not satisfy the requirement of a mathematical group in this respect.

As described above, the quadratic-hyperbolic curve group Hc(Z/pZ) satisfies the associative law and the commutative law with respect to the addition operation. The quadratic-hyperbolic curve group Hc(Z/pZ) is therefore an Abelian group (i.e., a commutative group). The quadratic-hyperbolic curve group Hc(Z/pZ) satisfies the following Theorem T10 (i.e., distributive law) under the addition operation and the scalar-multiplication.

### Theorem T10 (Distributive Law):

Let P and Q be elements of the quadratic-hyperbolic curve group Hc(Z/pZ), and let m be an integer. When the order k of the quadratic-hyperbolic curve group Hc(Z/pZ) is a prime number q, the following equality holds:

m(P+Q)=mP+mQ.

### (Proof of Theorem T10)

The distributive law will be proven by a mathematical induction method using the associative law and the commutative law. For m=1, the above equality is true. If the above equality is true for any natural number m, the following equalities hold:

$$\begin{matrix}( m + 1 ) ( P + Q ) = m ( P + Q ) + ( P + Q ) = ( mP + mQ ) + ( P + Q ) \\ = ( ( mP + mQ ) + P ) + Q = ( P + ( mP + mQ ) ) + Q \\ = ( ( P + mP ) + mQ ) + Q = ( ( 1 + m ) P + mQ ) + Q \\ = ( m + 1 ) P + ( mQ + Q ) = ( m + 1 ) P + ( m + 1 ) Q .\end{matrix}$$

Hence, the above equality is true for m+1.

When the order k is a composite number, It is not clear whether the assumption that “the above equality is true for any natural number m”. This is because, when the order k is the composite number, P and Q can be elements of generated groups having the orders that are different divisors of the order k in a case. When the order k is the prime number q, such a case does not occur. Clearly, the above equality also holds when m is a negative integer value. Further, it is to be considered that the above equality holds when m=0. In this case, mP=0P=O. The above equality holds for the integers m accordingly. (Q.E.D.)

Since the representation of the scalar-multiplication simplifies the addition operation denoted by the one or more symbols “+” for the group, it should be noted that the representation of the scalar-multiplication does not mean the product (e.g., P×Q) of elements of the quadratic-hyperbolic curve group Hc(Z/pZ), and the inverse element for an element of the group. The unit element for the scalar-multiplication is denoted by the coefficient “1”. Here, for the order k and the point P that is any element of the quadratic-hyperbolic curve group Hc(Z/pZ), the equality kP=O, viz., P+(k−1)P=O holds (where O is the zero element). Since the order k is a fixed value (=(p−1)/2+1) independently of the curve parameters, the point (k−1)P=((p−1)/2)P always exists as the inverse element for the point P.

In an encryption process, a predetermined generator G is determined as a base point, and the point obtained by performing the scalar-multiplication on the base point is associated with plain text data. Hence, the structure of groups to be generated based on the generator G is important. The structure of the generated group will be described below.

Let P(x) be a base-point G that is an element of the quadratic-hyperbolic curve group Hc(Z/pZ), and let Q[x]={mP(x)|P(x)εHc(Z/pZ), mεZ/kₓZ, and kₓ is the least positive number satisfying kₓP=O} be defined as a generated group obtained based on the point P (x). The generated group Q[x] can be a group under the scalar-multiplication and the addition operation. In fact, for positive integers m and n, the equality (n+m)P(x)=nP(x)+mP(x)εHc(Z/pZ) holds. Then, the set Q[x] is closed with respect to the scalar-multiplication and the addition operation. Further, since the equality 0P=O (where O is the zero element) for the scalar coefficient “0” holds, the inverse element for the point P is (−1)P=−P.

Furthermore, the generated group Q[x] can be a “ring” with respect to a scalar product operation. This is because the generated group Q[x] and the residue class ring Z/qZ have the same remainder modulo the order q for scalar coefficients, and then Q[x] is isomorphic to Z/qZ. The scalar product operation means a product between scalar coefficients m and n. Let the symbol “•” denote the scalar product operation. Since the equality (m·n)P=n(mP)εHc(Z/pZ) holds, the set Q[x] is closed with respect to the scalar product operation. For the scalar coefficient “1”, the equality 1P=P holds.

As described above, when two generated groups Q[x₁] and Q[x₂] are generated based on mutually different generators P(x₁) and P(x₂), have the same order q, and are sets comprised of the same points, these two generated groups are conjugate to each other. If the equality P(x₂)=(−1)P(x₁) holds (viz., P(x₂) is the inverse element for P(x₁)), the equalities (q−m)P(x₂)=(q−m) ((−1)P(x₁))=mP(x₁) hold. Then, the generated groups Q[x₂] and Q[x₁], such as Q[1] and Q[9] shown in FIG. 5, consist of their respective point sets that have their respective sequences in which the elements of Q[x₁] are arranged in an inverse order compared to the elements of Q[x₂], and vice versa.

With respect to the generated group Q[x], Theorems T11 to T17 hold as described below.

### Theorem T11:

Let Q[x] be a group generated based on the point P(x) that is an element of the quadratic-hyperbolic curve group Hc(Z/pZ), and let Q[y] be a group generated based on the point P(y)=mP(x) (where mεZ/kₓZ, m≠1) that is an element of the generated group Q[x]. Then, for the order kₓ of the generated group Q[x] and the order k_{y} of the generated group Q[y], the relation k_{y}≦kₓ holds.

### (Proof of Theorem T11)

As any element of the generated group Q[y], there exists a point P(z) satisfying the equality P(z)=nP(y). Since P(z)=(n·m)P(x) is derived based on this equality, the point P (z) can be generated based on the point P (x). Since P (z) is any element of the generated group Q[y], all the elements of the generated group Q[y] are included in the generated group Q[x]. Namely, the relation Q[x]⊃Q[y] holds. The relation k_{y}≦kₓ always holds accordingly. (Q.E.D.)

### Theorem T12:

Let Q[x] be a group generated based on the point P(x) that is an element of the quadratic-hyperbolic curve group Hc(Z/pZ), and let Q[y] be a group generated based on a point P(y)=mP(x) that is any element of the generated group Q[x]. Then, for the order kₓ of the generated group Q[x] and the order k_{y} of the generated group Q[y], m·k_{y} is a multiple of the order kₓ.

### (Proof of Theorem T12)

Since the equality k_{y}P(y)=O (O: the zero element) holds, the equality (m·k_{y})P(x)=O holds. At least, m·k_{y} is a multiple of the order kₓ accordingly. (Q.E.D.)

### Theorem T13:

Let Q[x] be a group generated based on the point P(x) that is an element of the quadratic-hyperbolic curve group Hc(Z/pZ), and let Q[y] be a group generated based on the point P(y)=mP(x) that is any element of the generated group Q[x]. Then, if the scalar coefficient m and the order kₓ are coprime (i.e., GCD(m,kₓ)=1), the order k_{y} of the generated group Q[y] is equal to the order kₓ of the generated group Q[x], where GCD(m,kₓ) means the greatest common divisor of m and kₓ.

### (Proof of Theorem T13)

By Theorem T12, the expression m·k_{y}=n·kₓ holds. Because GCD(m,kₓ)=1, all the prime factors of the scalar coefficient m exist in the scalar coefficient n. Then, n is divisible by m. Hence, there exists a coefficient n′ such that k_{y}=n′·kₓ. Since k_{y}≦kₓ by Theorem T11, n′=1. On the other hand, because GCD(m,kₓ)=1, all the prime factors of the order kₓ exist in the order k_{y}. Then, k_{y} is divisible by kₓ. Hence, k_{y}=n′·kₓ. Since k_{y}≦kₓ by Theorem T11, n′=1. Accordingly, the order k_{y} of the generated group Q[y] is equal to the order kₓ of the generated group Q[x]. (Q.E.D.)

Actually, for the quadratic-hyperbolic curve group Hc(Z/23Z) (where a=7, b=2, and c=0), the point P(8) (=1P(8)), P(16) (=11P(8)), P(21) (=7P(8)) and P(22) (=5P(8)) correspond to the position of m=1, 11, 7 and 5. These points P(8), P(16), P(21) and P(22) satisfy GCD(m,k₈)=1. The orders k₈, k₁₆, k₂₁ and k₂₂ of the generated groups Q[8], Q[16], Q[21] and Q[22] based on these points have a value of 12, as shown in FIG. 5.

### Theorem T14:

Let Q[x] be a group generated based on the point P(x) that is an element of the quadratic-hyperbolic curve group Hc(Z/pZ), and let Q[y] be a group generated based on the point P(y)=mP(x) that is any element of the generated group Q[x]. Then, the generated groups Q[x] and Q[y] are conjugate to each other if the scalar coefficient m and the order kₓ are coprime (i.e., GCD(m,kₓ)=1). The number of generated groups being conjugate to each other is φ(kₓ). Here, φ(kₓ) is defined as the number of the positive integers that are selected from among the positive integers from 1 to kₓ to be coprime with kₓ. φ(kₓ) is called Euler's φ function or Euler's Phi function.

### (Proof of Theorem T14)

A proof that the generated groups Q[x] and Q[y] are sets of the same points will be described. By Theorem T13, the order k_{y} of the generated group Q[y] is equal to the order kₓ of the generated group Q[x] (i.e., k_{y}=kₓ). It is assumed that the point P(z₁)=n₁P(y) and the point P(z₂)=n₂P(y) (where n₁≠n₂ modulo kₓ) exist as elements of Q[y]. Since GCD(m,kₓ)=1 holds as a precondition, there exist the positive integers m₁ and m₂ satisfying the relations: m₁≡m·n₁ (mod kₓ), m₂≡m·n₂ (mod kₓ) and m₁≠m₂. Hence, there are two points m₁P(x) and m₂P(x) as elements of the generated group Q[x], and m₁P(x)≠m₂P(x) holds. Accordingly, if there exit two different points P(z₁) and P(z₂) that are elements of the generated group Q[y], then, two points m₁P(x) and m₂P(x) that are elements of the generated group Q[x] are different. Hence, there is a one-to-one correspondence between elements of the generated group Q[y] and elements of the generated group Q[x]. Further, the point P(y)=mP(x) that is any element of the generated group Q[y] is included in the generated group Q[x]. Accordingly, the generated groups Q[x] and Q[y] are conjugate to each other. Additionally, the number of integers m that are less than or equal to the value of kₓ satisfying GCD(m,kₓ)=1 is φ(kₓ) by the definition of the Euler's φ function. (Q.E.D.)

### Theorem T15:

Let Q[x] be a group generated based on the point P(x) that is the element of the quadratic-hyperbolic curve group Hc(Z/pZ), and let Q[y] be a group generated based on the point P(y)=mP(x) that is any element of the generated group Q[x]. Then, the order k_{y} of the generated group Q[y] is a divisor of the order kₓ of the generated group Q[x]. Especially, the relation kₓ=g·k_{y} holds if GCD(m,kₓ)=g.

### (Proof of Theorem T15)

By Theorem T12, the expression m·k_{y}=n·kₓ holds. If GCD(m,kₓ)=g, there exist m′ and kₓ′ such that g·m′=m and g·kₓ′=kₓ. Hence, m′·k_{y}=n·kₓ′ and GCD(m′,kₓ′)=1.

With respect to the order k_{z} of the generated group Q[z] generated based on P(z)=gP(x), the following equalities hold:

kₓP(x)=(g·kₓ′)P(x)=kₓ′(gP(x))=kₓ′P(z).

Since kₓP(x)=O (O: the zero element), kₓ′P(z)=O. Accordingly, kₓ′ is a multiple of the order k_{z}, and k_{z}≦kₓ′.

Nonetheless, since the equalities P(y)=m′ (gP(x))=m′P(z) hold and Q[y] is generated based on the point P(z) that is an element of Q[z], the relation k_{y}≦kₓ′ holds by Theorem T11. At least, the relation k_{y}≦kₓ′ holds by the relation k_{z}≦kₓ′.

From the above discussions, Theorem T13 can be applied to the point P(z)=gP(x) that is an element of the generated group Q[x]. Namely, if n is divisible by m′ for the relations m′k_{y}=n·kₓ′ and GCD(m′, kₓ′)=1, then k_{y}=n′·kₓ′ and n′=1. Hence, kₓ=g·k_{y}. Conversely, if k_{y} is divisible by kₓ′, then k_{y}=n′·kₓ′ and n′=1. Hence, kₓ=g·k_{y}. (Q.E.D.)

In practice, for the quadratic-hyperbolic curve group Hc(Z/23Z) (where a=7, b=2, and c=O), the order k₈ of the generated group Q[8] generated based on the point P(8) is k₈=12. As shown in FIG. 5, elements of Q[8] are P(8) (=1P(8)), P(1) (=2P(8)), P(12) (=3P(8)), P(11) (=4P(8)), P(22) (=5P(8)), P(15) (=6P(8)), P(21) (=7P(8)), P(7) (=8P(8)), P(14) (=9P(8)), P (9) (=10P (8)), P (16) (=11P (8)), and P (2) (=12P (8)). The values of gₘ=GCD(m,k₈=12) are as follows: g₁=1, g₂=2, g₃=3, g₄=4, g₅=1, g₆=6, g₇=1, g₈=4, g₉=3, g₁₀=2, g₁₁=1 and g₁₂=12. On the other hand, as shown in FIG. 5, the orders k_{y} of the generated group Q[y] generated based on P(y)=mP(8) (mεZ/12Z, m≠1) are as follows: k₁=6, k₁₂=4, k₁₁=3, k₂₂=12, k₁₅=2, k₂₁=12, k₇=3, k₁₄=4, k₉=6, k₁₆=12 and k₂=1. Accordingly, the relation k₈=gₘ·k_{y} holds.

There is a fact that the quadratic-hyperbolic curve group Hc(Z/pZ) is conclusively different from the residue class ring Z/mZ. This is the fact that φ(m) represents simply the “order” of an irreducible residue class (Z/mZ)* of its group in the residue class ring Z/mZ, while φ(kₓ) represents the “number of generated groups” having the order kₓ for a divisor kₓ of the order k in the quadratic-hyperbolic curve group Hc(Z/pZ). This fact indicates a difference between the residue class ring Z/mZ simply having an addition operation for integer residues, and the quadratic-hyperbolic curve group Hc(Z/pZ) having the addition operation based on the Discrete Logarithm Problem according to the expression (3) and having the scalar-multiplication defined thereover. The numbers φ(kₓ) of generated groups for the quadratic-hyperbolic curve group Hc(Z/pZ) are in a one-to-one correspondence with the orders φ(kₓ) of the residue class rings Z/kxZ.

As described above, in order to improve security and to increase the number of bits of the plain text data to be encrypted, it is preferable that the order of the generated group obtained based on the base point is selected to include as large a prime factor as possible. When the order k of the quadratic-hyperbolic curve group Hc(Z/pZ) is an odd prime number q, the following Theorem T16 holds.

### Theorem T16:

Let the order k of the quadratic-hyperbolic curve group Hc(Z/pZ) be an odd prime number q, and let Q[x] be groups generated by using points P(x) as base points that are any elements other than the zero element of the quadratic-hyperbolic curve group Hc(Z/pZ). Then, the generated groups Q[x] have the order q, and the generated groups are conjugate to each other.

### (Proof of Theorem T16)

By Theorem T15, the order k_{y} of Q[y] is a divisor of the order kₓ of Q[x] for a group Q[y] generated based on the point P(y)=mP(x) that is any element of the generated group Q[x]. If GCD(m,kₓ)=g, then kₓ=g·k_{y}. When the order k=kₓ is the odd prime number q, g has a value of 1 or q. Then, the order k_{y} of the generated group Q[y] must have a value of q or 1. Hence, the number of generated groups Q[x] with the order q is φ(q)=q−1, and thereby one zero element exists.

Further, since GCD(m,q)=1 holds for the positive integers m less than or equal to q by Theorem T14, the group Q[y] generated based on the generator of P(y) (=mP(x)) that is an element of the generated group Q[x] is conjugate to the generated group Q[x] in any case. Accordingly, the q−1 generated groups are conjugate to each other. (Q.E.D.)

The Theorem T16 provides a simple method of selecting the order k to be a prime number q for selection of a base point. For example, the order in the case of p=541 is k=271 by the expression (6). Here, p and k are odd prime numbers. Furthermore, the following Theorem T16-2 holds.

### Theorem T16-2:

Let the order k of the quadratic-hyperbolic curve group Hc(Z/pZ) be an odd prime number q, let P(x) be any element other than the zero element of the quadratic-hyperbolic curve group Hc(Z/pZ), and let P(y) be any element of the quadratic-hyperbolic curve group Hc(Z/pZ). Then, the point P(y) can be obtained in accordance with the form: P(y)=mP(x) (where m is an integer).

### (Proof of Theorem T16-2)

We assume that the point P(y) does not satisfy the relation P (y)=mP (x) (where m is an integer). Then, the point P(y) is not included in the generated group Q[x] that is based on the point P (x). However, By Theorem T16, since the order k of the quadratic-hyperbolic curve group Hc(Z/pZ) is the odd prime number q, the generated group Q[y] based on the point P(y) and the generated group Q[x] based on the point P(x) are conjugate to each other, except for the zero element. Accordingly, the assumption such that the point P(y) is not included in the generated group Q[x] is contradictory. If m=0, then the zero element has the form of P(y)=mP(x). (Q.E.D.)

The Theorem T16-2 states that, when the order k of the quadratic-hyperbolic curve group Hc(Z/pZ) is the prime odd number q, it is difficult to distinguish which of generated groups includes the points having the form of mP(x) which occur in performing the high speed exponential operation to compute the session key Y in accordance with the expression (3a). Accordingly, even when the points having the form of mP(x) which occur in the computation is used for another purpose, it causes little problem in connection with the point P(x).

When the order k of the quadratic-hyperbolic curve group Hc(Z/pZ) is the prime odd number q, p=2(q−1)+1 holds because q=(p−1)/2+1 holds by the expression (6). Hence, the odd prime number p must be the prime number having the type of p=4 m+1 (where m is a positive integer). Further, when the order k of the quadratic-hyperbolic curve group Hc(Z/pZ) is the prime odd number q, the quadratic-hyperbolic curve group Hc(Z/pZ) does not include the even unit element I as any element. This is because kR=O holds for any element R of the quadratic-hyperbolic curve group Hc(Z/pZ), whereas kI=n(2I)+I=I holds for k=2n+1 (where n is a positive integer), which is contradictory.

As described above, when the order k is the odd prime number q, the order kₓ of the generated group Q[x] is determined independently of the parameters by Theorem T16. Thus, the base point can be easily selected. The key generation apparatus 1 (as shown in FIG. 1), the cryptographic system 2 (as shown in FIG. 7) and the digital signature system 3 (as shown in FIG. 8) perform processing using elements of the generated group which are generated by using the public key G that is an element of the quadratic-hyperbolic curve group Hc(Rp) as a base point. According to Theorem T16, a secure public key can be easily selected. On the other hand, when the order k is a composite number, the order of the generated group can be varied depending on the parameters, thus causing the base point to be selected by trial and error using Theorems T11 to T15. As means for searching a secure generated group having the maximum value of the order, the following Theorem T17 can be employed.

### Theorem T17:

Define that generated groups Q[x] and Q[y] are coprime (or relatively prime) if the generated groups Q[x] and Q[y] have no common element except for the zero element, that is, Q[x]∩Q[y]=O (O: the zero element). When the generator P(x₁) of the generated group Q[x₁] and the generator P(x₂) of the generated group Q[x₂] are coprime, P(x₃)=P(x₁)+P(x₂) is not included in both the generated groups Q[x] and Q[y]. Namely, when Q[x₁]∩Q[x₂]=O for P(x₁)εQ[x₁] and P(x₂)εQ(x₂), P(x₃) is not included in Q[x₁]∪Q[x₂].

### (Proof of Theorem T17)

There exists the generated group Q[x] having the maximum integer of the order and generated using a point P(x) as a generator. By Theorem T11, there are integers m and n satisfying P(x₁)=mP(x) and P(x₂)=nP(x). Then, the following equalities hold:

$$\begin{matrix}P ( {x}_{3} ) = P ( {x}_{1} ) + P ( {x}_{2} ) \\ = ( mP ( x ) ) + ( nP ( x ) ) \\ = ( m + n ) P ( x ) ∈ Q [ x ] .\end{matrix}$$

If P(x₃)εQ[x₁] and P(x₃)=hP(x₁) hold, then P(x₃)=hP(x₁)=(h·m)P(x). Since P(x₃)=(m+n)P(x) holds, m+n≡h·m (mod kₓ). Hence, P(x₂)=nP(x)=(h·m−m)P(x)=(h−1)P(x₁)εQ[x₁]. This contradicts the precondition that Q[x₁] and Q[x₂] are coprime (i.e., Q[x₁]∩Q[x₂]=O). Accordingly, P(x₃) is not included in Q[x₁]. Likewise, P(x₃)εQ[x₂], and the assumption that P(x₃)=h′P(x₂) holds contradicts the precondition that Q[x₁] and Q[x₂] are coprime. Accordingly, P(x₃) is not included in Q[x₂]. (Q.E.D.)

By Theorem T17, when the sets Q[x₁] and Q[x₂] are coprime, an element that is not included in the sets Q[x₁] and Q[x₂] can be generated by adding an element of Q[x₁] and an element of Q[x₂]. Referring to the generated groups shown in FIG. 5 as an example, Q[7] and Q[15] are coprime (i.e., Q[7]∩Q[15]=O=P(2)). In this case, P(7)+P(15)=P(1). The point P(1) is not included in both Q[7] and Q[15].

### 3. Second Embodiment

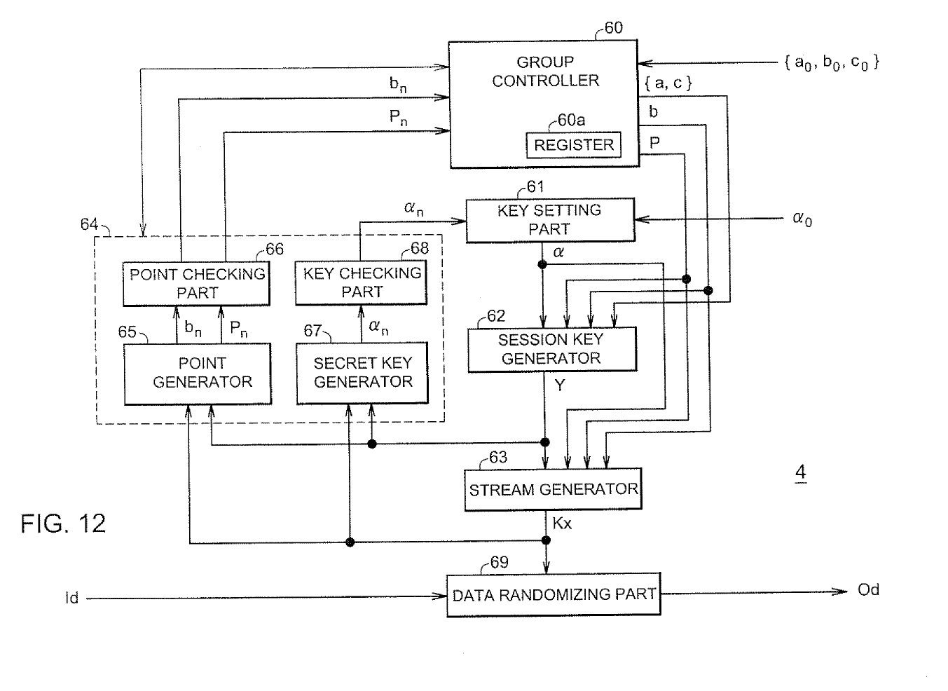

A second embodiment of the present invention will now be described. FIG. 12 is a functional block diagram showing a schematic configuration of a key stream generation apparatus 4 according to the second embodiment. The key stream generation apparatus 4 comprises a group controller 60, a key setting part 61, a session key generator 62, a stream generator 63 and a data randomizing part 69.

The group controller 60 sets the curve parameters {a, b, c} specifying the form of the quadratic-hyperbolic curve Hc defined over the residue class ring Z/pZ, and stores the set curve parameters in a register 60a. When the key stream generation apparatus 4 is started or rebooted, the group controller 60 sets the curve parameters {a, b, c} to the initial values {a₀, b₀, c₀} supplied from an outside source, as data stored in the register 60a. The group controller 60 further is capable of setting a base point to one of the elements of the quadratic-hyperbolic curve group Hc(Z/pZ), and storing the value indicating the set base point P(x) in the register 60a. In this embodiment, the key stream generation apparatus 4 generates a key stream using elements of the quadratic-hyperbolic curve group Hc(Z/pZ), no limitation there to intended. Alternatively, the key stream generation apparatus 4 can generate a key stream using elements of the quadratic-hyperbolic curve group Hc(Rp) defined over the finite ring Rp.

The key setting part 61 is capable of setting a secret key α that is a scalar coefficient. When the key stream generation apparatus 4 is started or rebooted, the key setting part 61 sets the secret key α to an initial value α₀ supplied from an outside source. The session key generator 62 is capable of generating a session key Y (=αP(x)) by performing the scalar-multiplication of the base point P(x) by the secret key α, by use of the base point P(x) and the curve parameters {a, b, c} supplied from the group controller 60.

The session key Y and the base point P(x) that is an element of the quadratic-hyperbolic curve group Hc(Z/pZ) are specified by the points (x,y) each representing a pair of a dependent variable y and an independent variable x. Nonetheless, as described above, the addition operation defined for the quadratic-hyperbolic curve group Hc(Z/pZ) can be performed using only x-coordinate values. Therefore, it suffices that only the x-coordinate values are generated as the values indicating the base point P(x) and the session key Y.

The stream generator 63 generates a key stream Kx comprised of a series of pseudo-random numbers, on the basis of at least the session key Y selected from among a curve parameter b, a base point P(x), the secret key α and the session key Y. More specifically, the stream generator 63 is capable of providing, as the key stream Kx, an output of a predetermined randomizing function ST(b,P,α,Y) that is represented by the curve parameter b, the base point P(x), the secret key α and the session key Y as independent variables. The session key Y can give the computational difficulty of breaking cryptography, based on the Discrete Logarithm Problem on the quadratic-hyperbolic curve group.

The randomizing function ST(b,P,α,Y) has a function of generating the key stream Kx from state variables of the session key Y, the curve parameter b, the base point P(x) and the secret key α, and has a function of lowering or breaking down correlations among these state variables. For example, the session key Y (=αP(x)) is computed based on the secret key α and the base point P(x) through the group operation (i.e., the addition operation) using the curve parameters {a,b,c}. In this case, the randomizing function ST lowers or breaks down the correlations among the base point P(x), the secret key α and the session key Y.

The randomizing function ST can be a nonlinear transform function such as a one-way function. For example, the nonlinear transform function can be configured by using one or more S boxes, or a transposition function. The S box is a transformation table of n rows and m columns (where n, m are positive integers of 2 or more) that is employed in DES (Data Encryption Standard). Alternatively, the nonlinear transform function can be configured by using a hash function according to well-known RC4 (ARCFOUR) or SHA (Secure Hash Algorithm). Such randomizing function ST has a function of making the session key Y secret. This is intended to break down the dependency relations among the state variables thereby to reduce the risk of allowing the secret key α to be revealed when the session key Y having a short bit length is known. If the dependency relations are clarified, the number of effective bits of the state variables to be targeted for attack in the key stream is decreased. Further, the randomizing function ST has a function of severing the correlation between a newly generated base point Pₙ and an old base point. To exercise this function, it is preferable that the structure of the randomizing function ST is not known to a third party or person.

When the key stream generation apparatus 4 operates as a stream cipher generating device, the data randomizing part 69 receives a series of the plain text data as an input data series ID, and performs a logical exclusive-OR operation between the input data series Id and a series of pseudo-random numbers that is the key stream Kx, thereby to generate in real-time an output data series Od that is an encrypted data series. When the key stream generation apparatus 4A operates as a decoding device, the data randomizing part 69 receives an encrypted data series as an input data series ID, and performs a logical exclusive-OR operation between the input data series Id and a series of pseudo-random numbers that is the key stream Kx, thereby to generate in real-time an output data series Od that is a decoded data series.

The key stream generation apparatus 4 further comprises a group parameter generator 64 which is supplied with the session key Y and the key stream Kx from the session key generator 62 and the stream generator 63, respectively. The group parameter generator 64 is capable of newly generating at least one of a curve parameter bₙ, a base point Pₙ and a secret key αₙ at every specified time (or at every round), on the basis of at least one of the session key Y and the key stream Kx. The group controller 60 replaces the base point P(x) currently set therein with the newly generated base point Pₙ, and replaces the curve parameter b currently set therein with the newly generated curve parameter bₙ. The key setting part 61 replaces the secret key α currently set therein with the newly generated secrete key αₙ. As a result, the state variable representing at least one of the curve parameter b, the base point P(x) and the secret key α is updated at every specified time (or at every round).

Accordingly, the key stream generation apparatus 4 is regarded as a state machine which has the curve parameter b, the base point P(x) and the secret key α as state variables. When the key stream generation apparatus 4 is regarded as the state machine, an internal state of the key stream generation apparatus 4 is specified when the curve parameters {a,b,c} are determined and the secret key α is given. The value indicating the session key Y is a function value obtained when the secret key α and the base point P(x) are provided as input variables. In consideration of the computational difficulty based on the Discrete Logarithm Problem, the value indicating the session key Y can be treated as a variable for specifying one of internal states. Then, the key stream generation apparatus 4 can be regarded as a state machine which has the curve parameter b, the base point P(x), the secret key α and the session key Y as state variables. In this manner, the key stream generation apparatus 4 according to the second embodiment is capable of changing the group structure by changing the curve parameter b, and therefore provides a new type of cryptography which should be called “Hyper-Curve Fluctuational Operator Cryptography” or “Hyper-Curve Fluctuational Parameter Cryptography”. The cryptography according to this embodiment provides many state variables, thus enabling the number of bits of each state variable to be lowered, as compared to conventional stream cryptography. This enables the security of stream cryptography to be improved with high-speed key computation. In this embodiment, one session key Y is used, no limitation thereto intended. Two or more session keys can be used. In this case, the number of session keys (e.g., a first session key Y₁, a second session key Y₂, . . . , a N-th session key Y_{N}) can be increased, thus enabling the number of apparent bits of state variables to be increased while causing the security of stream cryptography to be slightly decreased.

As described above, the problem with conventional elliptic curve cryptography is that the order of the group constructed from the conventional elliptic curve can be varied depending on curve parameters, thus causing the running time of computing the order to increase. Therefore, it is difficult to generate a secure key stream in real-time by using the group constructed from the conventional elliptic curve. On the other hand, the order k of the quadratic-hyperbolic curve group Hc(Z/pZ) used in the second embodiment can be explicitly represented independently of the curve parameters as shown in the expression (6). Therefore, even when the one or more curve parameters or a base point is varied while the order p of the residue class ring Z/pZ is maintained constant, the group operation can be performed while maintaining the secure order k. According to Theorem T16, if the order k of the quadratic-hyperbolic curve group Hc(Z/pZ) is the odd prime number q, then, the generated group Q[x], which is generated based on a base point P(x) that is any element other than the zero element of the quadratic-hyperbolic curve group Hc(Z/pZ), has the order q. Hence, as long as the order k of the quadratic-hyperbolic curve group Hc(Z/pZ) is selected as a secure odd prime number q, the group operation can be performed while maintaining the order of the generated group Q[x] at the secure order q even if the base point P(x) is updated. Therefore, it is understood that the stream cryptographic process using elements of the quadratic-hyperbolic curve group Hc(Z/pZ) can be efficiently performed.

As shown in FIG. 12, the group parameter generator 64 includes a point generator 65 and a point checking part 66. The point generator 65 newly generates a base point Pₙ and a curve parameter bₙ at every specified time, based on at least one of the session key Y and the key stream Kx. The newly generated base point Pₙ and curve parameter bₙ are supplied to the group controller 60 through the point checking part 66. Here, the curve parameter bₙ has a value indicating the x-coordinate value of the unit element (i.e., the zero element) to be used in the addition operation defined for the quadratic-hyperbolic curve group Hc(Z/pZ), as described above.

The point checking part 66 checks whether or not the newly generated base point Pₙ is identical to the zero element O, and supplies the check result to the group controller 60. More specifically, the point checking part 66 can determine whether or not the x-coordinate value of the newly generated base point Pₙ is identical to the x-coordinate value bₙ of the zero element O, and supplies the determination result as the check result. When the base point Pₙ is determined to be identical to the zero element O based on the check result, the group controller 60 does not replace the base point P(x) currently set therein with Pₙ, and does not replace the curve parameter b currently set therein with bₙ.

When the base point Pₙ is determined to be identical to the zero element O, the point generator 65 can repeatedly generate a base point Pₙ and a curve parameter bₙ until the point checking part 66 determines that the base point Pₙ is not identical to the zero element O. Alternatively, the point generator 65 can repeatedly output a previously generated base point Pₙ and a previously generated curve parameter bₙ.

In this embodiment, a base point Pₙ and a curve parameter bₙ are generated simultaneously at every specified time, no limitation thereto intended. A base point Pₙ can be generated at every specified time different from that at which a curve parameter bₙ is generated. When the point generator 65 generates only a base point Pₙ at a certain specified time, the point checking part 66 can check whether or not the x-coordinate value of the newly generated base point Pₙ is identical to the curve parameter b currently set therein. When the point generator 65 generates only a curve parameter bₙ at a certain specified time, the point checking part 66 can check whether or not the x-coordinate value of the base point P(x) currently set therein is identical to the newly generated curve parameter bₙ.

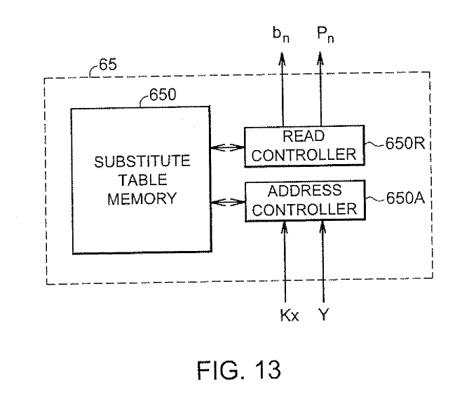

FIG. 13 is a block diagram schematically showing an exemplary configuration of the point generator 65. The point generator 65 includes a substitute table memory 650, a read controller 650R and an address controller 650A. The substitute table memory 650 stores the x-coordinate values (scalar values) indicating several elements of the quadratic-hyperbolic curve group Hc(Z/pZ). The values z stored in the substitute table memory 650 is selected to satisfy the condition that (z²+cz−a) is a quadratic non-residue modulo p.

The read controller 650R addresses a storage area of the substitute table memory 650 in accordance with at least one of the session key Y and the key stream Kx. The read controller 650R outputs the stored value z read from the addressed storage area as the newly generated base point Pₙ or curve parameter bₙ. The read controller 650R can have a function of checking whether or not the currently read value of z is identical to the value of z that is read one cycle before prior to the current state. When the currently read value of z is identical to the value of z read one cycle prior to the current state, the read controller 650R can supply to the group controller 60 an interrupt signal causing the storage contents of the substitute table to be rearranged.

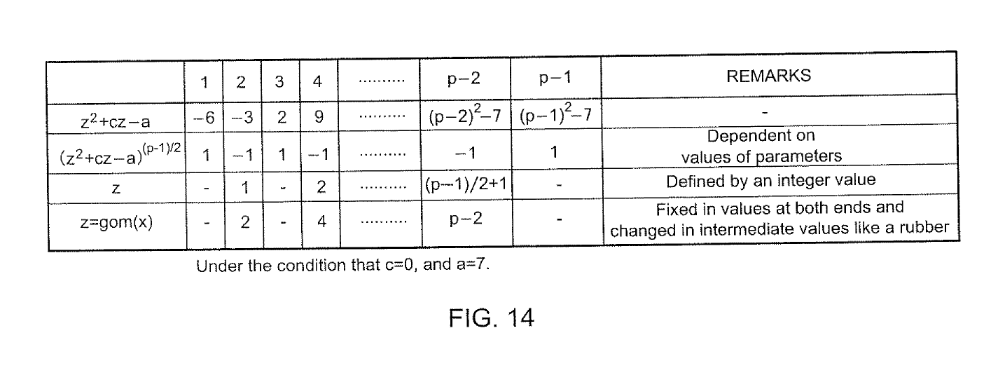

The values z stored in the substitute table memory 650 can be given in accordance with a rubber function z=gom(x) where variables x correspond to their respective address values of the substitute table memory 650. A table of FIG. 14 exemplarily illustrates a relation between an independent variable x and a dependent variable z of the rubber function z=gom(x) in the case of c=0 and a=7. The function value (dependent variable) z of the rubber function defines a domain of the quadratic-hyperbolic curve group Hc(Z/pZ). The function value z always satisfies the condition that (z²+cz−a) is a quadratic non-residue modulo p. This rubber function z=gom(x) is a function such that, for each integer in a range of z from 1 to p−1, positive integers of z satisfying the condition that (z²+cz−a) is a quadratic non-residue are found one-by-one, and are associated with their respective variables x. Hence, the relation 1≦z≦(p−1) holds for 1≦x≦(p−1)/2+1. The reason why gom(x) is called a “rubber function” is that the function values at both ends (z=1 and z=(p−1)) are fixed and intermediate values can be varied depending on the curve parameters. To correctly calculate z=gom(x) for a specified value of x, the value of (z²+cz−a) must be computed in an ascending order starting from 1 in accordance with Euler's criterion. This computation requires a huge amount of computation. If the values satisfying the condition of a quadratic non-residue are distributed uniformly in a range from 1 to (p−1), then, the center value of z=gom(x) is z≅2x. Because of an economical or physical limitation on the capacity of the substitute table memory 650, it is necessary to store a part of the z values that can be computed in accordance with the rubber function gom(x), in the substitute table memory 650 having a memory capacity.

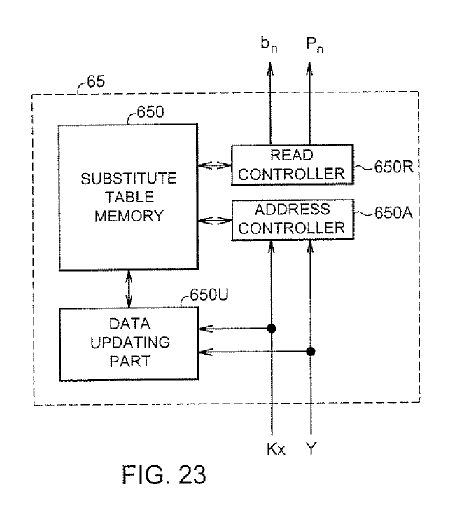

The function of the substitute table memory 650 is apparently similar to that of a cache memory, which, however, is not true. The cache memory uses a replacement policy such that a recently accessed data set of the stored data sets is not replaced prior to a previously accessed or non-accessed data set of the stored data sets (e.g., LRU: Least Recently Used). On the other hand, it is preferable that the substitute table memory 650 accesses a data set representing a base point or a curve parameter that is different from a recently accessed data set as much as possible, to improve secrecy. Accordingly, it is preferable that the address controller 650A of FIG. 23 selects data sets stored in the substitute table memory 650 as randomly as possible.

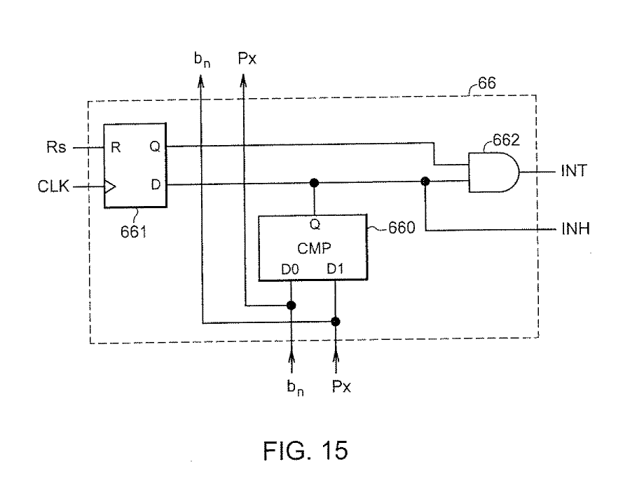

FIG. 15 is a circuit diagram showing an example of a schematic configuration of the point checking part 66. The point checking part 66 includes a comparator 660, a flag register 661 and a logical product gate 662. The curve parameter bₙ is fed to a terminal D0 of the comparator 660. The x-coordinate value Px=[Pₙ]ₓ of the base point Pₙ is fed to a terminal D1.

The comparator 660 outputs a coincidence signal of a high level corresponding to the logical value “1” from an output terminal Q, when the x-coordinate value Px of the base point Pₙ is identical to the curve parameter bₙ. The coincidence signal is supplied as a write protect signal INH to the group controller 60. When supplied with the write protect signal INH from the point checking part 66, the group controller 60 uses current values of the base point P(x) and the curve parameter b currently set therein without replacing them. On the other hand, when the x-coordinate value Px of the base point Pₙ is not identical to the curve parameter bₙ, the comparator 660 outputs a signal having a low level corresponding to the logical value “0” from the terminal Q. The output from the terminal Q of the comparator 660 is supplied to both the input terminal D of the flag register 661 and one of input terminals of the logical product gate 662.

The flag register 661 operates in synchronization with a clock CLK supplied from a timing generator (not shown), and latches a signal supplied to the input terminal D as a flag signal in response to a pulse edge (i.e., a rising edge or falling edge) of the clock CLK. The flag signal is supplied from the output terminal Q to the other of input terminals of the logical product gate 662. On receipt of a reset pulse Rs at the terminal R, the flag register 661 is reset and outputs a low-level signal from the output terminal Q.

The logical product gate 662 performs a logical product operation between an output (i.e., a flag signal) of the flag register 661 and an output of the comparator 660, thereby to supply an interrupt signal INT having a high level to the group controller 60 only if the two outputs are high-level signals. When at lease one of the two outputs is a low-level signal, the interrupt signal INT of the logical product gate 662 is not supplied to the group controller 60. One of terminals of the logical product gate 662 is supplied with a currently output signal of the comparator 660. The other of terminals of the logical product gate 662 is supplied with a flag signal from the flag register 661. The flag signal was outputted from the comparator 660 one clock period before prior to the current state. Accordingly, the logical product gate 662 outputs an interrupt signal INT only when the comparator 660 outputs the coincidence signals consecutively over two clock periods, in other words, only when the curve parameter bₙ and the x-coordinate value Px of the newly generated base point Pₙ are identical to each other twice in a row. When receiving the interrupt signal INT as an input, the group controller 60 performs an interrupt routine for determination of the cause of an error or rearrangement of the storage contents of the substitute table memory 650, for example.

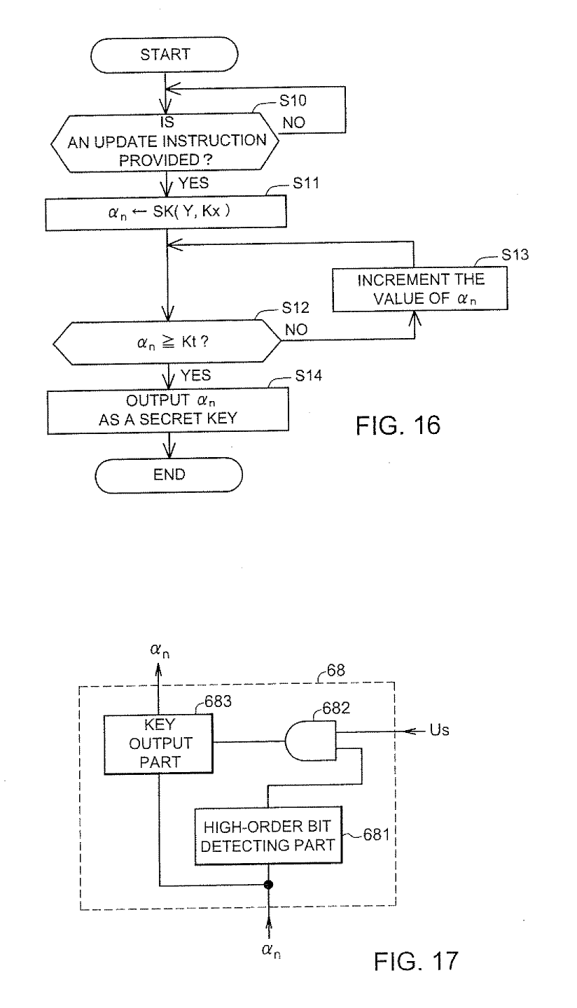

With reference to a flowchart of FIG. 16, an example of a procedure of generating the secret key αₙ will be described. When an update instruction is provided by the group controller 60 (step S10), the secret key generator 67 of FIG. 12 newly generates a key αₙ in accordance with a key function SK(Y,Kx) having the session key Y and the key stream Kx as independent variables (step S11). Here, the value of the key αₙ is selected to be an element of the residue class ring Z/qZ (where q is the order of a generated group generated based on the base point). The key function SK(Y,Kx) can be a function that outputs the key αₙ based on a pseudo-random number, or a one-way function such as a hash function.

Subsequently, the key checking part 68 of FIG. 12 checks whether or not the value of the generated key αₙ is greater than or equal to a threshold Kt (step S12). When the value of the key αₙ is greater than or equal to the predetermined threshold Kt, the key checking part 68 judges that the key αₙ has a secure effective bit length as a secret key, and outputs the key αₙ as the secret key (step S14). On the other hand, when the value of the key αₙ is less than the threshold Kt, the key checking part 68 judges that the key αₙ as a secret key does not have a secure effective bit length. Then, the key checking part 68 increases the effective bit length of the key αₙ to increment the value of the key αₙ (step S13). Thereafter, the procedure after step S12 is performed. The threshold Kt preferably has about half the value of the order k of the quadratic-hyperbolic curve group Hc(Z/pZ).

FIG. 17 is a block diagram schematically showing an exemplary configuration of the key checking part 68. This key checking part 68 includes a high-order bit detecting part (or an upper bit detecting part) 681, a logical product gate 682 and a key output part 683. The high-order bit detecting part 681 is supplied with the key αₙ from the secret key generator 67. The high-order bit detecting part 681 determines whether or not the value of upper n bits of the key αₙ is “0” (where n is an integer of 2 or more) thereby to determine whether or not the value of the key αₙ is greater than or equal to the threshold Kt, and supplies a determination signal indicating the determination result to one of terminals of the logical product gate 682. Here, when the value of upper n bits of the key αₙ is “0”, the determination signal can be a high-level signal. When the value of upper n bits of the key αₙ is not “0”, the determination signal can be a low-level signal.

When the update instruction for the key αₙ is provided, a high-level update signal Us is supplied from the group controller 60 to the other of terminals of the logical product gate 682. Hence, only when the update signal Us is supplied, a determination signal having a high-level is outputted from the high-order bit detecting part 681, and is supplied to the key output part 683 through the logical product gate 682. When the high-level signal is supplied from the logical product gate 682, the key output part 683 increases the effective bit length of the key αₙ by replacing all or part of the upper n bits of the key αₙ with predetermined bits. As a result, the key αₙ having a secure effective bit length can be supplied to the key setting part 61. In consideration of the case where the value (k−αₙ) is less than the threshold Kt for the order k, a method of replacing all or part of the upper bits can be employed in this case.

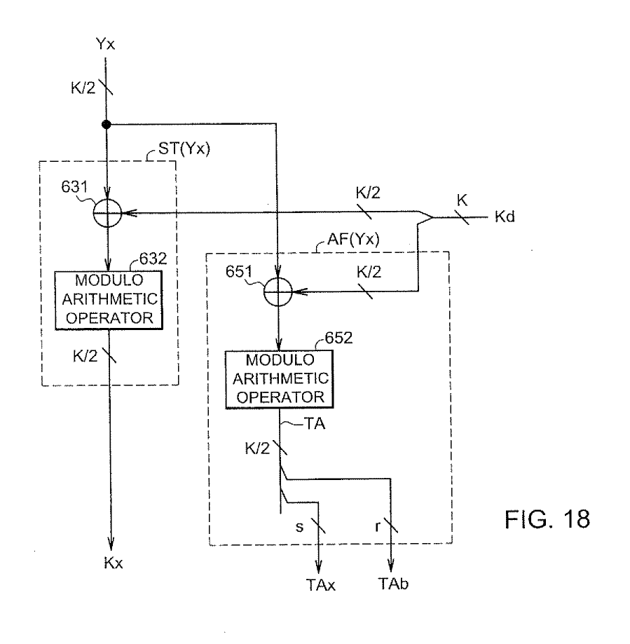

As described above, the stream generator 63 (FIG. 12) is capable of generating the key stream Kx using a randomizing function ST(b,Y). The address controller 650A (FIG. 13) is capable of generating addresses for addressing the storage area of the substitute table memory 650 using an address generation function AF(b,Y). FIG. 18 is a diagram showing exemplary simple configurations of the randomizing function ST(Yx) and the address generation function AF(Yx). The independent variables Yx of the randomizing function ST(Yx) and the address generation function AF(Yx) denote the x-coordinate value of the session key Y.

As shown in FIG. 18, the randomizing function ST(Yx) has an exclusive-OR operator 631 and a modulo arithmetic operator 632. The exclusive OR operator 631 performs a logical exclusive-OR operation between the lower K/2 bits of the key Kd having the K bit length and the x-coordinate value Yx of the session key (where K is an even integer of 2 or more, for example, 64 bits). The modulo arithmetic operator 632 performs the residue operation modulo p on an output of the exclusive OR operator 631 to calculate the residue value. This residue value is outputted as a value representing the key stream Kx.

On the other hand, the address generation function AF(Yx) has an exclusive OR operator 651 and a modulo arithmetic operator 652. The exclusive OR operator 651 performs a logical exclusive-OR operation between the upper K/2 bits of the key Kd having a K-bit length and the key stream Yx. The modulo arithmetic operator 652 performs the residue operation modulo p on an output of the exclusive OR operator 651 to calculate the residue value TA. The s-bits (where s is a positive integer) in the residue value TA is extracted as a first address TAx for a base point, and the r bits (where r is a positive integer) in the residue value TA is extracted as a second address TAb for a zero element. The first address TAx can be comprised of s bits from the least significant bit (i.e., the first bit) to the s-th bit of the residue value TA, for example. The second address TAb can be comprised of r bits from the (s+1)-th bit to the (s+r)-th bit of the residue value TA, for example.

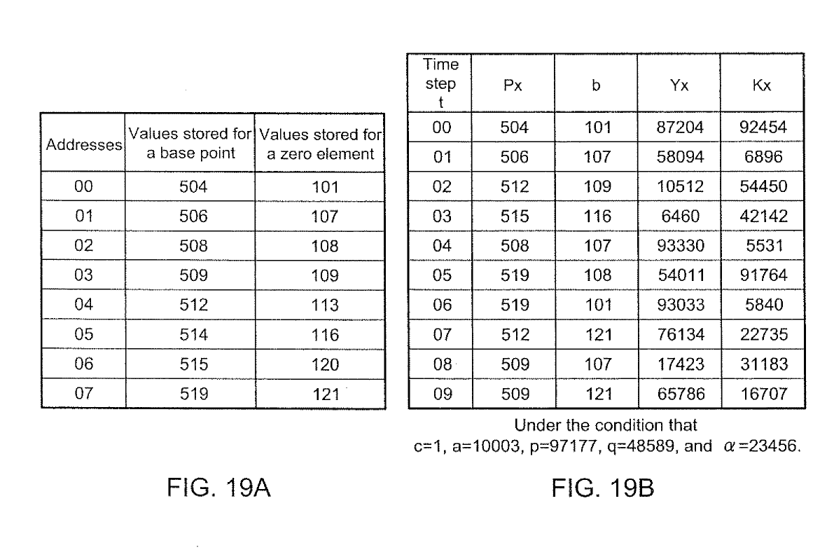

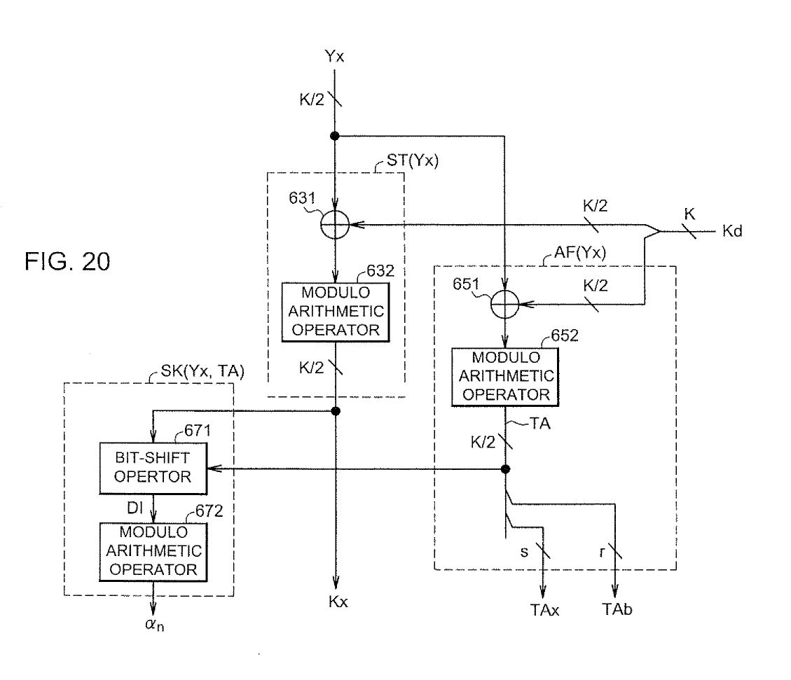

Exemplary numerical values calculated using the functions shown in FIG. 18 will be described. FIG. 19A illustrates exemplary simple numerical values of the substitute table stored in the substitute table memory 650. This substitute table shows a relationship between addresses and their corresponding values stored for a base point, and shows a relationship between addresses and their corresponding values stored for the zero element. FIG. 19B illustrates values of Px, b, Yx, and Kx calculated at each specified time by using the substitute table of FIG. 19A, where Px denotes the x-coordinate value of the base point, b denotes the x-coordinate value of the zero element (or denotes a curve parameter), Yx denotes the x-coordinate value of the session key Y, and Kx denotes the key stream. The first address TAx and the second address TAb as illustrated have values computed using the address generation function AF(Yx) of FIG. 18, and the key stream Kx as illustrated has values computed using the randomizing function ST(Yx) of FIG. 18. The key Kd is the DES key representing a fixed value (=0x133457799bbcdff1; “0x” is a prefix symbol for indicating hexadecimal notation). The first address TAx is the lower three bits from the least significant bit (i.e., the first bit) to the third bit of the residue value TA. The second bit TAb is three bits from the fourth bit to the sixth bit of the residue value TA.

Referring to FIG. 19B, at time step t=00, the initial value “504” of the x-coordinate value Px of the base point and the initial value “101” of the curve parameter b are predetermined. A secret key α, a modulus p, and curve parameters a and c are constant, and have values shown in FIG. 19B. An integer q denotes the order of a generated group generated based on the base point. The session key generator 62 calculates the x-coordinate value Yx (=“87204”) of the session key Y. The stream generator 63 calculates the key stream Kx (=“92454”) using the randomizing function ST(Yx) of FIG. 18, based on the calculated value “87204” of Yx. On the other hand, the address controller 650A of FIG. 13 calculates the first address TAx (=“01”) and the second address TAb (=“01”) using the address generation function AF(Yx) of FIG. 18, based on the calculated value “87204” of Yx. In response to the value “01” of the first address TAx, its corresponding value “506” stored for a base point as shown in FIG. 19A is read from the substitute table memory 650, and, at the next time step t=01, the value Px is replaced with the value “506”. Also, in response to the value “01” of the second address TAb, its corresponding value “107” stored for a zero element as shown in FIG. 19A is read from the substitute table memory 650, and, at the next time step t=01, the value b is replaced with the value “107”.

At the next time step t=01, the session key generator 62 calculates the x-coordinate value Yx (=“58094”) of the session key Y based on the values of Px and b. The stream generator 63 calculates the key stream Kx (=“6896”), using the randomizing function ST(Yx) of FIG. 18, based on the calculated value “58094” of Yx. On the other hand, the address controller 650A of FIG. 13 calculates the first address TAx (=“04”) and the second address TAb (=“03”) based on the calculated value “6896” of Kx, in accordance with the address generation function AF(Yx) of FIG. 18. In response to the value “04” of the first address TAx, its corresponding value “512” stored for a base point as shown in FIG. 19A is read from the substitute table memory 650, and, at the next time step t=02, the value Px is replaced with the value “512”. Also, in response to the value “03” of the second address TAb, its corresponding value “109” stored for a zero element as shown in FIG. 19A is read from the substitute table memory 650, and, at the time step t=02, the value b is replaced with the value “109”. At each of time steps t=02 to 09, a procedure is performed in the same manner as the above.

FIG. 20 illustrates an exemplary configuration of a key function SK(Yx,TA). This key function SK(Yx,TA) is used together with the randomizing function ST(Yx) and the address generation function AF(Yx) shown in FIG. 18. As shown in FIG. 20, the key function SK(Yx,TA) includes a bit shift operator 671, a key generator 672 and a modulo arithmetic operator 673. The bit shift operator 671 shifts the bits in the key stream Kx by the bits representing the value of lower m bits in the residue value TA to generate a value DI (where, m is an integer of 2 or more). The module arithmetic operator 672 performs the module q operation (q is the order) on the value DI to generate the secret key αₙ.

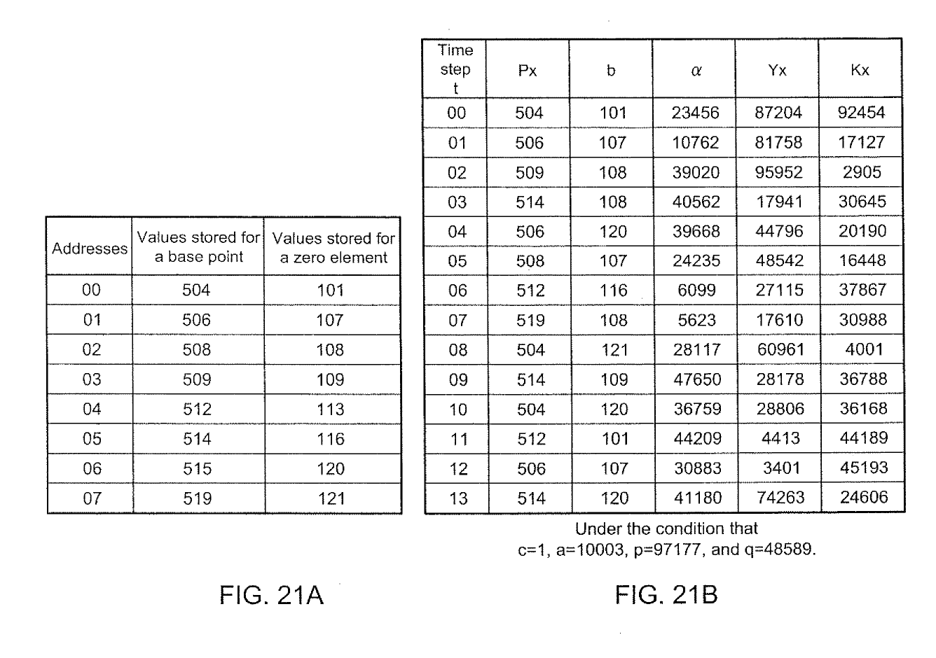

A numerical example calculated using the functions of FIG. 20 will be described below. FIG. 21B illustrates the values of Px, b, α, Yx and Kx that are calculated at every specified time, using the substitute table of FIG. 21A. The substitute table of FIG. 21A is the same as the substitute table shown in FIG. 18A. Here, the first address TAx and the second address TAb as illustrated have values computed using the address generation function AF(Yx) of FIG. 20. The key stream Kx as illustrated has values computed using the randomizing function ST(Yx) of FIG. 20. The secret key α as illustrated has values computed using the key function SK(Yx,TA) of FIG. 20. The key Kd is the DES key representing a fixed value (=0x133457799bbcdff1). The first address TAx is the lower three bits from the least significant bit (i.e., the first bit) to the third bit of the residue value TA. The second bit TAb is three bits from the fourth bit to the sixth bit of the residue value TA. Further, the bit shift operator 671 shifts the bits in the key stream Kx by the bits representing the value of lower 6 bits of the residue value TA to generate a value DI.

Referring to FIG. 21A, at time step t=00, the initial value “504” of the x-coordinate value Px of the base point, the initial value “101” of the curve parameter b and the initial value “23456” of the secret key α are predetermined. A modulus p, and curve parameters a and c are constant, and have the values shown in FIG. 21B. An integer q denotes the order of the generated group generated based on the base point. The session key generator 62 calculates the x-coordinate value Yx (=“87204”) of the session key Y. The stream generator 63 calculates the key stream Kx (=“92454”) based on the calculated value “87204” of Yx, using the randomizing function ST(Yx) of FIG. 20. On the other hand, the address controller 650A of FIG. 13 calculates the first address TAx (=“04”) and the second address TAb (=“04”) based on the calculated value “87204” of Yx, using the address generation function AF(Yx) of FIG. 20. In response to the value “04” of the first address TAx, its corresponding value “512” stored for a base point as shown in FIG. 21A is read from the substitute table memory 650, and, at the next time step t=01, the value Px is replaced with the value “512”. Also, in response to the value “04” of the second address TAb, its corresponding value “113” stored for a zero element as shown in FIG. 21A is read from the substitute table memory 650, and, at the time step t=01, the value b is replaced with the value “113”. The secret key generator 67 of FIG. 12 calculates the key αₙ (=“20542”) using the key function SK(Yx,TA) of FIG. 20. At the next time step t=01, the secret key α is replaced with the key αₙ. Further, the secret key generator 67 of FIG. 12 calculates the key αₙ (=“10762”) using the key function SK(Yx,TA) of FIG. 20. At the next time step t=01, the secret key α is replaced with the key αₙ.

At the next time step t=01, the session key generator 62 calculates the x-coordinate value Yx (=“81758”) of the session key Y based on the values of Px, b and α. The stream generator 63 calculates the key stream Kx (=“17127”) based on the calculated value “81758” of Yx, using the randomizing function ST(Yx) of FIG. 20. On the other hand, the address controller 650A of FIG. 13 calculates the first address TAx (=“03”) and the second address TAb (=“02”) based on the calculated value “17127” of Yx, using the address generation function AF(Yx) of FIG. 20. In response to the value “03” of the first address TAx, its corresponding value “509” stored for a base point as shown in FIG. 21A is read from the substitute table memory 650, and, at the next time step t=02, the value Px is replaced with the value “509”. Also, in response to the value “02” of the second address TAb, its corresponding value “108” stored for a zero element as shown in FIG. 21A is read from the substitute table memory 650, and, at the next time step t=02, the value b is replaced with the value “108”. At each of time steps t=02 to 13, a procedure is performed in the same manner as the above.

Since the secret key α of FIG. 21B is varied at every specified time, there is a probability that the value of the secret key α or the value of (q−α) may be small. If these values are smaller than the threshold Kt, there might be a high possibility that the session key Y is easily computed. The key checking part 68 of FIG. 12 is used to minimize such possibility.

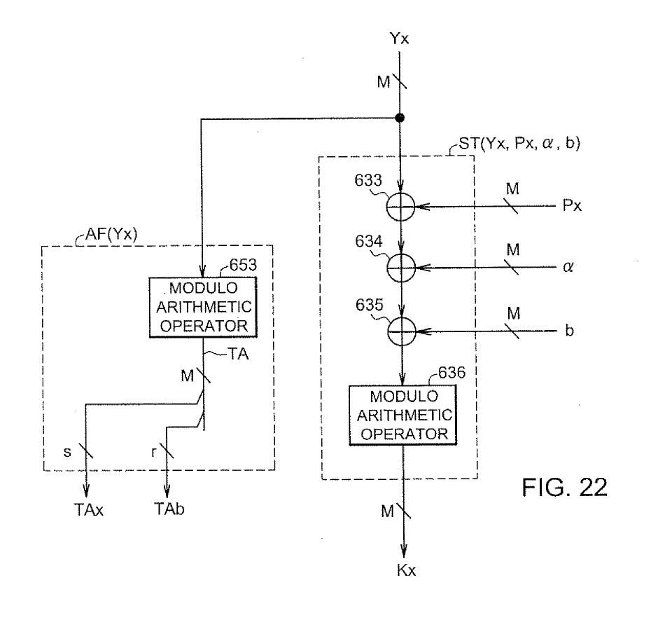

FIG. 22 illustrates another example of a configuration comprised of a randomizing function ST(Yx,Px,α,b) and an address generation function AF(Yx). The randomizing function ST(Yx,Px,α,b) has an exclusive-OR operators 633, 634 and 635 and a modulo arithmetic operator 636 which are connected in series. As shown in FIG. 22, the operator 633 performs a logical exclusive-OR operation between the base point Px having the M bit length and the x-coordinate value Yx of the session key. The operator 634 performs a logical exclusive-OR operation between an output of the operator 633 and the secret key α. The operator 635 performs a logical exclusive-OR operation between an output of the operator 634 and the curve parameter b. The modulo arithmetic operator 636 performs a modulo p operation on an output of the operator 635 to generate the key stream Kx.

On the other hand, the address generation function AF(Yx) of FIG. 22 includes a modulo arithmetic operator 653 which performs a modulo p operation on the x-coordinate value Yx of the session key Y to calculate the residue value TA. The s bits (where s is a positive integer) in the residue value TA are extracted as the first address TAx for a base point, and the r bits (where r is a positive integer) in the residue value TA are extracted as the second address TAb for a zero element. The first address TAx can be composed of s bits from the least significant bit (i.e., the first bit) to the s-th bit of the residue value TA, for example. Also, the second address TAb can be composed of r bits from the (s+1)-th bit to the (s+r)-th bit of the residue value TA, for example.

FIG. 23 is a block diagram schematically showing another example of a configuration of the point generator 65. As shown in FIG. 23, the point generator 65 is characterized by including a data updating part 650U in addition to the configuration shown in FIG. 13. The data updating part 650U is capable of generating elements of the quadratic-hyperbolic curve group Hc(Z/pZ) based on at least one of the session key Y and the key stream Kx, and of updating the storage contents (i.e., a substitute table) of the substitute table memory 650 with the generated elements.

If the storage contents of the substitute table memory 650 are fixed, there is a possibility that the same combination of the curve parameter bₙ and the base point Pₙ occurs repeatedly. In this case, if the secret key α is constant, there is a possibility that the session key Y having the same value occurs repeatedly, which can be a weakness exploited by an attacker. The data updating part 650U is capable of reducing such a possibility.

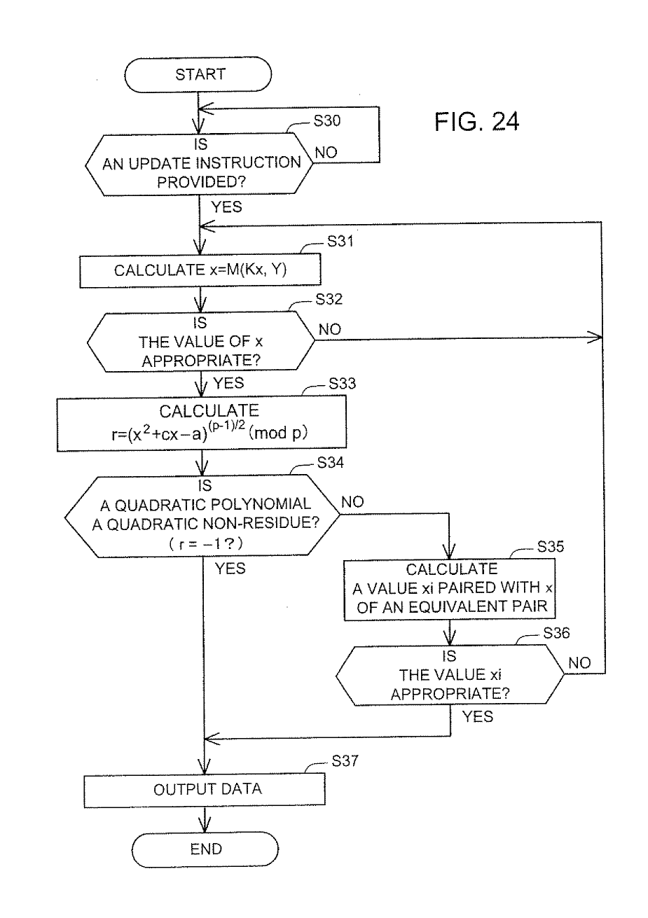

With reference to a flowchart of FIG. 24, an exemplary procedure of generating data performed by the data updating part 650U will be described below. First of all, the data updating part 650U receives an update instruction provided by the group controller 60 (step S30), and generates the value of x in accordance with a function M(Kx,Y) using the session key Y and the key stream Kx as input variables (step S31). At the next step S32, the data updating part 650U determines whether or not the generated value of x is appropriate. More specifically, the data updating part 650U can determine whether or not the value of x is identical to the x-coordinate value b of the zero element O set at the current time. The data updating part 650U can determine that the value of x is not appropriate when the value of x is identical to the x-coordinate value b of the zero element O set at the current time. The data updating part 650U can further determine that the value of x is not appropriate when identical to the x-coordinate value of the “prime element H” or “even unit element I” described above. When the value of x is determined not to be appropriate, the procedure returns to step S31. When the value of x is determined to be appropriate, the procedure goes to step S33.

At step S33, the data updating part 650U calculates a determination value r in accordance with the Euler's criterion. The data updating part 650U further determines whether or not the quadratic polynomial (=x²+cx−a) of the denominator of the quadratic-hyperbolic function Hc is a quadratic non-residue modulo p, based on the determination value r (step S34). When the determination value r is “−1”, the quadratic polynomial is determined to be a quadratic non-residue. When the determination value r is not “−1”, the quadratic polynomial is determined to be a quadratic residue. When the determination value r is “−1”, the data updating part 650U outputs the value of x (step S37).

When the determination value r is determined not to be “−1” at step S34, the data updating part 650U calculates a value xi paired with the value x of an equivalent pair (step S35). According to Lemma L1 described above, if the quadratic polynomial (=x²+cx−a) is a quadratic residue for the value x, then the quadratic polynomial (=xi²+cxi−a) for the value xi is necessarily a quadratic non-residue. Further, the data updating part 650U determines whether or not the value xi of the equivalent pair is appropriate, in the same manner as the step S23 (step S36). When the value xi is determined not to be appropriate, the procedure returns to step S31. On the other hand, when the value xi is determined to be appropriate, the procedure goes to step S37 in which the value xi is outputted (step S37).

It is preferable that the procedure of steps S31 to S36 is performed in parallel to the computation of the session key Y to generate the key stream at high speed. To implement this parallel computation, the key stream generation apparatus 4 can comprise a dedicated processor for numerical computation or a dual-processor.

As described above, the data updating part 650U itself is capable of generating the values to be stored in the substitute table memory 650. In addition to the processing performed by the data updating part 650U, the values occurring in the computation process of the session key Y in the session key generator 62 can be used as values to be stored in the substitute table memory 650. For example, the high-speed index calculation method can be applied to the computation of Y=αP as described above in connection with the expression (3a). According to the high-speed index calculation method, the values indicating elements of the quadratic-hyperbolic curve group Hc(Z/pZ) are calculated before the computation of the session key Y is entirely completed. The calculated values can be used as values to be stored in the substitute table memory 650. All the values occurring in the computation process of the session key Y satisfy the condition that the quadratic polynomial of the denominator of the quadratic-hyperbolic function Ec is a quadratic non-residue modulo p, thus enabling the procedure of steps S33 and S34 in the flowchart of FIG. 24 to be unnecessary thereby to obtain the advantage of reduction of computational effort.

It is preferable that, during initialization which occurs immediately after the key stream generation apparatus 4 is started or rebooted, the data updating part 650U generates a predetermined number (or more) of values to be stored in the substitute table memory 650, and additionally stores the generated values in the substitute table memory 650, or replaces initial values stored in the substitute table memory 650 with the generated values. This is because as the number of values stored in the substitute table memory 650 is greater, the computational difficulty of discovering the key stream Kx is higher. In order to enhance the secrecy of the secret key α, it is further preferable that, during the initialization, the key stream generation apparatus 4 does not output the key stream Kx until a cycle of operations is performed a predetermined number (or more) of times. Such operations performed during the initialization are important to provide a secure key stream Kx when the number of stored values in the substitute table memory 650 is small.

Next, methods of updating the substitute table stored in the substitute table memory 650 will be described below. The update methods include: (1) an LUE (Latest Used Exchange) method and (2) an LUAE (Limited Use And Exchange) method, as described below.

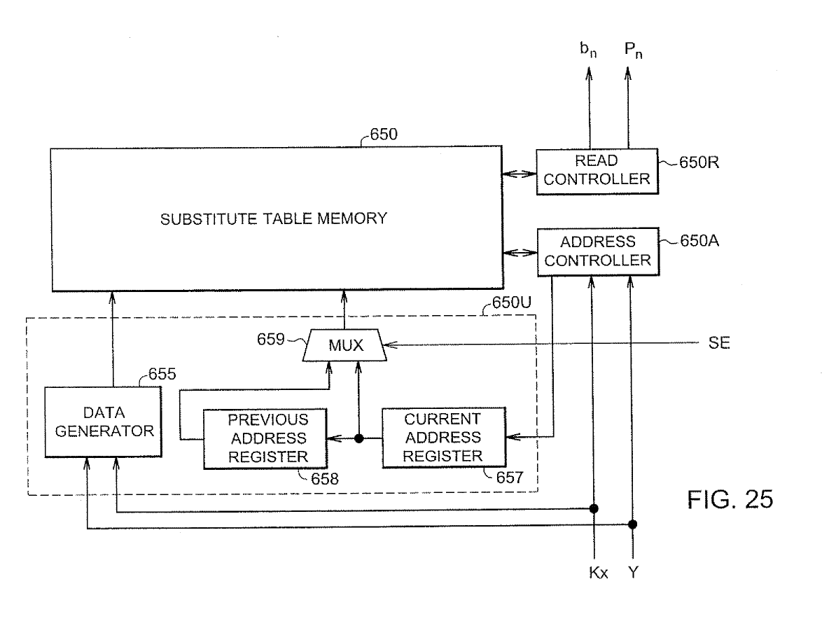

(1) LUE (Latest Used Exchange) method: The LUE method is a method of replacing a most recently accessed and read value of the stored values in the substitute table memory 650 prior to replacing other ones of the stored values. The use of the LUE method prevents data sets representing the same address from being repeatedly read, thereby enabling the computational difficulty of discovering the key stream Kx to be enhanced even when the amount of the data sets stored in the substitute table memory 650 is small. FIG. 25 is a block diagram schematically showing a configuration using the LUE method. The data updating part 650U as shown in FIG. 25 includes a data generator 655, a current address register 657, a previous address register 658 and a selector (i.e., multiplexer: MUX) 659. The data generator 655 is capable of generating data sets to be stored in the substitute table memory 650, based on at least one of the session key Y and the key stream Kx.

The current address register 657 and the previous address register 658 are connected in series so as to substantially constitute a shift register. The current address register 657 stores a read address (i.e., current address) supplied from the address controller 650A. The substitute table memory 650 reads a data set in the storage area specified by the read address. The read controller 650R outputs the read data set representing bₙ or Pₙ. The previous address register 658 stores the read address (i.e., previous address) that was supplied from the current address register 657 one or more cycles before prior to the current state. The selector 659 selects either an output (i.e., current address) of the current address register 657 or an output (i.e., previous address) of the previous address register 658, in accordance with a selection control signal SE supplied from the group controller 60. The selector 659 supplies the selected address as a write address to the substitute table memory 650. The substitute table memory 650 writes a data set supplied from the data generator 655 into the storage area specified by the write address supplied from the selector 659. When the selector 659 selects an output of the current address register 657, a most recently read data set of the stored data sets in substitute table memory 650 can be replaced. When the selector 659 selects an output of the previous address register 658, a less recently read data set than the most recently read data set in substitute table memory 650 can be replaced.

(2) LUAE (Latest Use And Exchange) method: The LUAE method is a method of replacing one or more data sets that are read and used repeatedly more than a predetermined number of times, prior to replacing other ones of the stored data sets in the substitute table memory 650. More specifically, the data updating part 650U is capable of updating the frequency or number of times that each stored value is read out, on the basis of the read address supplied from the address controller 650A. The data updating part 650U is capable of replacing, with a new data set, the fastest data set that is used repeatedly the predetermined number of times or at a predetermined frequency prior to replacing other ones of the stored data sets.

It is preferable that the data updating part 650U updates the contents of the substitute table in accordance with the LUE or LUAE method, while periodically changing addresses corresponding to their respective stored values in the substitute table memory 650 in accordance with a prescribed rule to change an arrangement of the stored values. This improves the secrecy of the contents of the substitute table thereby to enable the computational difficulty of discovering the key stream Kx to be enhanced.

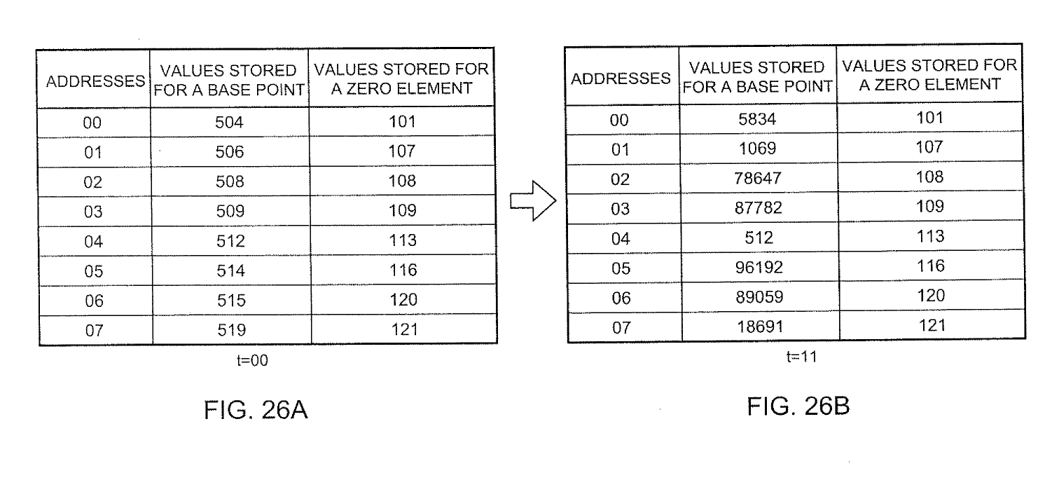

A numerical example calculated in accordance with the LUE method will be described below. FIGS. 26A and 26B illustrate a situation when the substitute table is updated in accordance with the LUE method. The substitute table of FIG. 26A shows storage contents at time step t=00 immediately after the initialization. The substitute table of FIG. 26B shows storage contents of the substitute table memory 650 at time step t=11 after the passage of 11 cycles. As shown in FIGS. 26A and 26B, some values stored for a base point are updated several times, and some values (e.g., the value “512” corresponding to the first address TAx=“04”) are not used at all. It is found that the distribution of values appearing as the first address TAx is slightly localized, because the number of stored values in the substitute table is small.

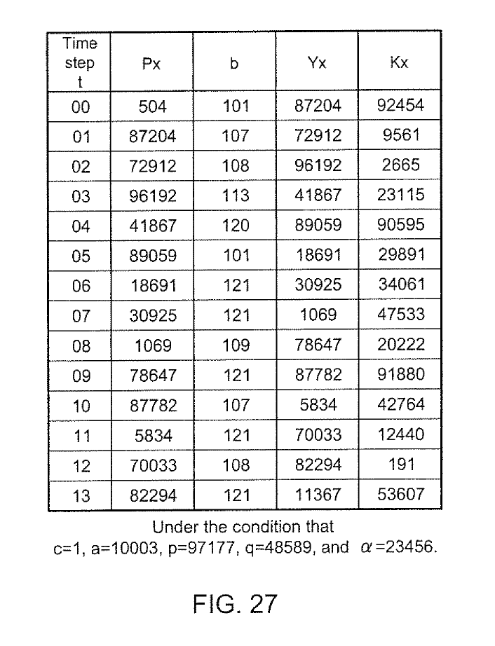

FIG. 27 illustrates the values of Px, b, Yx and Kx calculated at every specified time by using the substitute table which is updated in the storage contents as shown in FIGS. 26A and 26B. These values of Px, b, Yx and Kx are calculated using the functions shown in FIG. 18. The first address TAx and the second address TAb as illustrated have values computed using the address generation function AF(Yx) of FIG. 18. The key stream Kx as illustrated has values computed using the randomizing function ST(Yx) of FIG. 18. The key Kd is the DES key representing a fixed value (=0x133457799bbcdff1). The first address TAx is the lower three bits from the least significant bit (i.e., the first bit) to the third bit of the residue value TA. The second address TAb is three bits from the fourth bit to the sixth bit of the residue value TA. As shown in FIG. 27, at time step t=00, the initial value “504” of the x-coordinate value Px of the base point and the initial value “101” of the curve parameter b are predetermined. A secret key α, a modulus p, and curve parameters a and c are constant, and have the values shown in FIG. 27. The key stream Kx is supplied to the data randomizing part 69 of FIG. 12. The output data series Od is generated in real-time from the input data series Id.

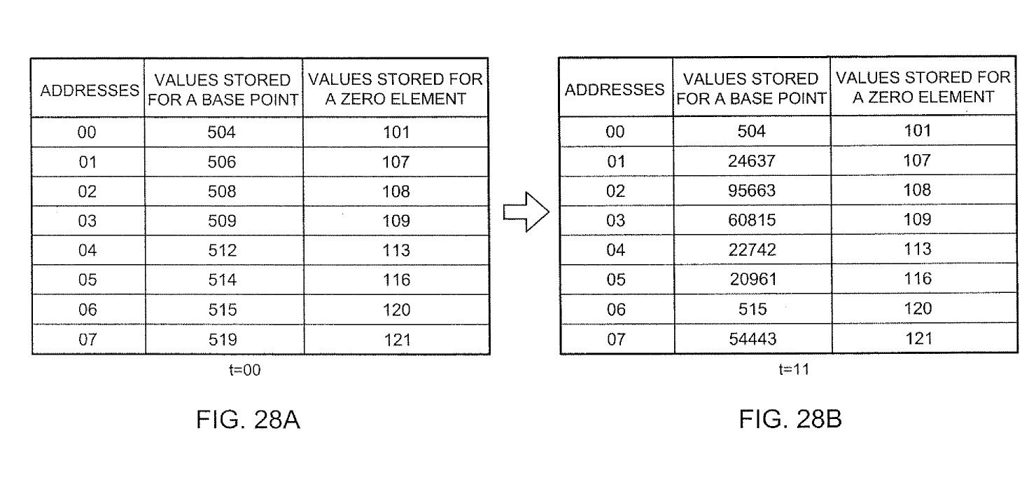

FIGS. 28A and 28B illustrate a situation when the substitute table is updated in accordance with the LUE method. The substitute table of FIG. 28A shows the storage contents at time step t=00 immediately after the initialization. The substitute table of FIG. 28B shows the storage contents at time step t=11 after the passage of 11 cycles. As shown in FIG. 28B, some values stored for a base point are updated several times. Some values (e.g., the value “504” corresponding to the first address TAx=“00” and the value “515” corresponding to the first address TAx=“06”) are not used at all. In this situation, it is also found that the distribution of values appearing as the first address TAx is slightly localized, because the number of stored values in the substitute table is small.

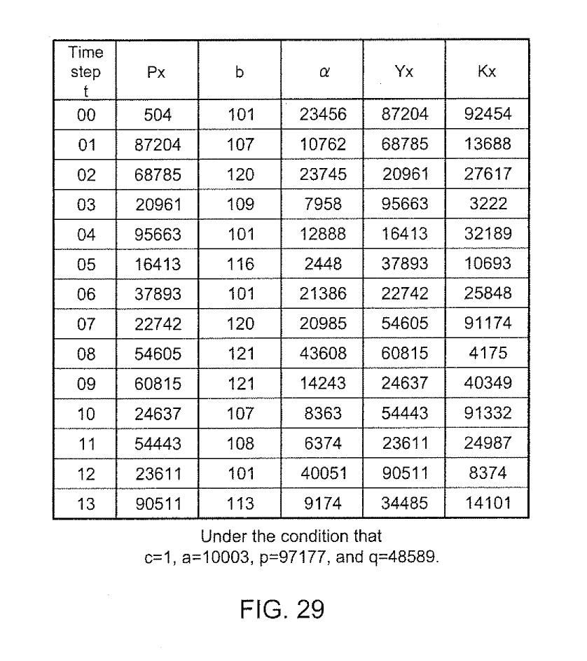

FIG. 29 illustrates the values of Px, b, α, Yx and Kx calculated at every specified time by using the substitute table which is updated in the storage contents as shown in FIGS. 28A and 28B. These values of Px, b, α, Yx and Kx are calculated using the functions shown in FIG. 20. The first address TAx and the second address TAb as illustrated have values computed using the address generation function AF(Yx) of FIG. 20. The key stream Kx as illustrated has values computed using the randomizing function ST(Yx) of FIG. 20. The secret key α as illustrated has values computed using the key function SK(Yx,TA) of FIG. 20. The key Kd is the DES key representing a fixed value (=0x133457799bbcdff1). The first address TAx is the lower three bits from the least significant bit (i.e., the first bit) to the third bit of the residue value TA, and the second address TAb is three bits from the fourth bit to the sixth bit of the residue value TA.

Further, the bit shift operator 671 shifts the bits in the key stream Kx by the bits representing the value of lower six bits of the residue value TA to generate a value DI. As shown in FIG. 29, at time step t=00, the initial value “504” of the x-coordinate value Px of the base point and the initial value “101” of the curve parameter b are predetermined. A modulus p, and curve parameters a and c are constant, and have the values as shown in FIG. 29. An integer q denotes the order of the generated group generated from the base point. The key stream Kx is supplied to the data randomizing part 69 of FIG. 12. The output data series Od is generated in real-time from the input data series Id.

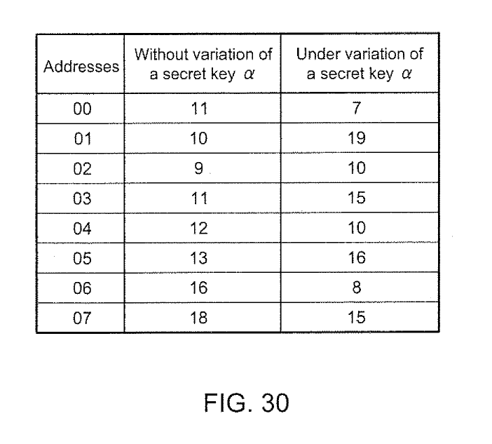

FIG. 30 illustrates a situation when the substitute table is accessed. FIG. 30 shows the status of use of stored values in the storage area specified by respective addresses when a constant secret key α is not varied as shown in FIG. 27, and the status of use when a secret key α is varied as shown in FIG. 29. A table of FIG. 30 represents the number of uses of each first address TAx at time step t=100. According to this table, it is found that the distribution of the numbers of uses is slightly localized when a secret key α is varied, as compared to when a secret key α is not varied. Nonetheless, it is found that each value of the substitute table is used about 10 times when a secret key α is not varied as well as when a secret key α is varied. Thus, it is understood that the substitute table is evenly used. Accordingly, even when the size of the substitute table is limited, the values of the substitute table are randomized relative rapidly, thereby enabling generation of the key stream having a property close to pseudo-random numbers. Therefore, it is preferable that, during the initialization, the key stream generation apparatus 4 does not outputs the key stream Kx until a cycle of operations is performed a predetermined number (or more) of times, thereby to improve the secrecy of the secret key α.

What is claimed is:

1. A key generation method for generating a key for cryptographic process, comprising:
(a) setting a secret key representing a scalar coefficient, and selecting, as a first public key, an element of a finite commutative group that is a set of pairs (x, y) of a dependent variable y of a number-theoretical function defined over a finite ring and an independent variable x of said number-theoretical function, said number-theoretical function being a quadratic-hyperbolic function having both a denominator of a quadratic polynomial defined over said finite ring and a numerator of a linear polynomial defined over said finite ring; and
(b) performing an addition operation defined for said finite commutative group on said first public key one or more times thereby to multiply said first public key by said secret key representing a scalar coefficient to generate a second public key, said addition operation being performed to add first and second elements of said finite commutative group by:
when a third element other than said first and second elements is determined as one of solutions of a set of two simultaneous equations represented by said quadratic-hyperbolic function and a first linear function which has said first and second elements as solutions of an equation of said first linear function,
calculating, as the addition result other than said third element and a predetermined fixed element of said finite commutative group, a fourth element which is one of solutions of a set of two simultaneous equations represented by said quadratic-hyperbolic function and a second linear function which has said third element and said predetermined fixed element as solutions of an equation of said second linear function.

2. The key generation method according to claim 1, wherein said predetermined fixed element is a unit element with respect to said addition operation.

3. The key generation method according to claim 1, wherein an element of said finite commutative group satisfies a condition that the quadratic polynomial of said number-theoretical function is a quadratic non-residue modulo an order p of said finite ring.

4. The key generation method according to claim 3, wherein an order of said finite commutative group is an odd prime number.

5. The key generation method according to claim 3, wherein an order of said finite commutative group is a composite number containing an odd prime number as a factor.

6. The key generation method according to claim 1, wherein said finite ring is a residue class ring Z/pZ made by all of residue classes for integers modulo an odd prime number of p.

7. The key generation method according to claim 1, wherein said quadratic-hyperbolic function is given by the following expression:
y=(x−b)/(x²+cx−a),
for integers a, b and c that are elements of said finite ring.

8. The key generation method according to claim 1, wherein said quadratic-hyperbolic function is given by the following expression:
y=(dx+e)/(ax²+bx+ca),
for integers a, b, c, d and e that are elements of said finite ring.

9. A key generation method for encrypting plain text data, comprising:
(a) reading, from a memory, first and second public keys which are elements of a finite commutative group being a set of pairs (x, y) of a dependent variable y of a number-theoretical function defined over a finite ring and an independent variable x of said number-theoretical function, said number-theoretical function being a quadratic-hyperbolic function having both a denominator of a quadratic polynomial defined over said finite ring and a numerator of a linear polynomial defined over said finite ring, and said second public key being generated by performing an addition operation defined for said finite commutative group on said first public key one or more times thereby to multiply said first public key by a secret key representing a scalar coefficient; and
(b) performing an addition operation defined for said finite commutative group on said plain text data by use of the read first and second public keys thereby to encrypt said plain text data, said addition operation being performed to add first and second elements of said finite commutative group by:
when a third element other than said first and second elements is determined as one of solutions of a set of two simultaneous equations represented by said quadratic-hyperbolic function and a first linear function which has said first and second elements as solutions of an equation of said first linear function,
calculating, as the addition result other than said third element and a predetermined fixed element of said finite commutative group, a fourth element which is one of solutions of a set of two simultaneous equations represented by said quadratic-hyperbolic function and a second linear function which has said third element and said predetermined fixed element as solutions of an equation of said second linear function.

10. The key generation method according to claim 9, further comprising:
(c) generating digest data based on said plain text data; and
(d) performing said addition operation defined for said finite commutative group one or more times on said digest data by use of the secret key and public key read from said memory in said step (a), thereby to encrypt said digest data to generate digital signature data.
